(19) United States
(12) Patent Application Publication
(10) Pub. No.: US 2026/0197586 A1
(43) Pub. Date: Jul. 9, 2026

(54) EARPHONE CONTROL METHOD AND WEARABLE DEVICE

(71) Applicant: HUAWEI TECHNOLOGIES CO., LTD., Shenzhen (CN)

(72) Inventors: Xianchun Zhang, Dongguan (CN); Hantian Yang, Shenzhen (CN); Haifeng Yu, Dongguan (CN); Yan Hu, Shenzhen (CN); Guangxing Zhang, Dongguan (CN)

(73) Assignee: HUAWEI TECHNOLOGIES CO., LTD., Shenzhen (CN)

(21) Appl. No.: 19/554,301

(22) Filed: Mar. 2, 2026

Related U.S. Application Data
(63) Continuation of application No. PCT/CN2024/116141, filed on Aug. 30, 2024.

(30) Foreign Application Priority Data
Sep. 1, 2023 (CN) 202311136305.0

(51) Int. Cl. H04R 5/04; H04R 1/10; H04R 3/00; H04R 5/033

(52) U.S. Cl. CPC H04R 5/04; H04R 1/1041; H04R 3/005; H04R 5/0335; H04R 2201/107

(57) ABSTRACT

A first earbud obtains first gravity data collected by a first inertial detector; and when the first gravity data meets a first condition, the first earbud identifies that the first earbud is worn on a left ear, and executes a control event corresponding to a left earbud attribute; or when the first gravity data meets a second condition, the first earbud identifies that the first earbud is worn on a right ear, and executes a control event corresponding to a right earbud attribute. According to the method, the wearable device may identify that the wearable device is worn on the left ear or the right ear, and execute different control events based on that the wearable device is worn on the left ear or the right ear.

### CROSS-REFERENCE TO RELATED APPLICATIONS

The present disclosure is a continuation application of International Application No. PCT/CN2024/116141, filed on Aug. 30, 2024, which claims priority to Chinese Patent Application No. 202311136305.0, filed on Sep. 1, 2023. The disclosures of the aforementioned applications are hereby incorporated by reference in their entireties.

### TECHNICAL FIELD

The present disclosure relates to the earphone field, and in particular, to an earphone control method and a wearable device.

### BACKGROUND

A true wireless stereo (TWS) earphone is favored by consumers due to its advantages such as a true wireless structure, a small size, and portability. However, almost all true wireless stereo earphones in the current market are in-ear and half-in-ear devices, which intrude into an ear canal of a user and cause oppression. As a result, the user cannot wear the earphone for a long time, and even a health problem of the consumer is caused.

A clip-on earphone may be clipped in a cavity of concha of the user, and does not go deep into the ear canal of the user, so that wearing comfort can be improved. When the clip-on earphone is worn, there is no need to distinguish between a left ear and a right ear. However, the clip-on earphone needs to identify that the clip-on earphone is worn on the left ear or the right ear, so that a control event corresponding to a left-ear attribute is executed when the earphone is worn on the left ear, or a control event corresponding to a right-ear attribute is executed when the earphone is worn on the right ear. How to identify that the clip-on earphone is worn on the left ear or the right ear is to be further studied.

### SUMMARY

The present disclosure provides an earphone control method and a wearable device. The wearable device may identify that the wearable device is worn on a left ear or a right ear, and execute different control events based on that the wearable device is worn on the left ear or the right ear, thereby improving flexibility of using the wearable device by a user, and improving use experience of wearing the wearable device by the user.

According to a first aspect, the present disclosure provides an earphone control method, where the method is applied to a wearable device, the wearable device includes a first earbud, and the first earbud includes a first inertial detector. The method includes: The first earbud obtains first gravity data collected by the first inertial detector; and when the first gravity data meets a first condition, the first earbud identifies that the first earbud is worn on a left ear, and executes a control event corresponding to a left earbud attribute; or when the first gravity data meets a second condition, the first earbud identifies that the first earbud is worn on a right ear, and executes a control event corresponding to a right earbud attribute.

When the first earbud provided in the present disclosure is being worn, there is no need to distinguish between the left ear and the right ear. The first earbud may be worn on the left ear of a user, or the first earbud may be worn on the right ear of the user. In this way, portability of using the earbud is improved.

However, after the first earbud is worn, the first earbud needs to identify whether the first earbud is worn on the left ear or the right ear and executes different control events based on that the first earbud is worn on the left ear or the right ear.

In some embodiments of the present disclosure, the first earbud may determine, based on the gravity data collected by the preset first inertial detector, whether the first earbud is worn on the left ear or the right ear. This improves flexibility of using the wearable device by the user and improves use experience of wearing the wearable device by the user.

With reference to the first aspect, in a possible implementation, the wearable device further includes a second earbud, the second earbud includes a second inertial detector, and the method further includes: The second earbud obtains second gravity data collected by the second inertial detector; and when the second gravity data meets the first condition, the second earbud identifies that the second earbud is worn on a left ear, and executes a control event corresponding to a left earbud attribute; or when the second gravity data meets the second condition, the second earbud identifies that the second earbud is worn on a right ear, and executes a control event corresponding to a right earbud attribute.

The wearable device may include two earbuds, that is, the first earbud and the second earbud. Similar to the first earbud, when the second earbud is being worn, there is no need to distinguish between the left ear and the right ear. The second earbud may be worn on the left ear of a user, or the second earbud may be worn on the right ear of the user. In this way, portability of using the earbud is improved.

However, after the second earbud is worn, the second earbud needs to identify whether the second earbud is worn on the left ear or the right ear, and executes different control events based on that the second earbud is worn on the left ear or the right ear. This improves flexibility of using the wearable device by the user, and improves use experience of wearing the wearable device by the user.

Only one of the first earbud and the second earbud may be in a worn state, or both the first earbud and the second earbud may be in a worn state.

With reference to the first aspect, in a possible implementation, the first earbud includes a first earbud body, a cantilever arm, and a second earbud body, the cantilever arm is connected between the first earbud body and the second earbud body, and the first earbud body and the second earbud body are disposed opposite to each other and have an initial distance; the cantilever arm is deformable, deformation of the cantilever arm can adjust the initial distance between the first earbud body and the second earbud body to an adjustment distance, a connection line between a geometric center of the second earbud body and a geometric center of the first earbud body is defined as a Z axis, and a direction in which the geometric center of the second earbud body points to the geometric center of the first earbud body is defined as a positive direction of the Z axis; a straight line that passes through a geometric center of an end face on which the cantilever arm is connected to the second earbud body and that is perpendicular to the end face is defined as a Y axis, and a direction in which the geometric center of the end face points to the cantilever arm is defined as a positive direction of the Y axis; and a straight line perpendicular to both the Z axis and the Y axis is defined as an X axis, where when the first earbud is worn on the left ear, a positive direction of the X axis points to the ground; and when a user is standing or sitting, the first condition includes: a gravity component of the gravity data in the positive direction of the X axis is a positive value; or when a user is standing or sitting, the second condition includes: a gravity component of the gravity data in the positive direction of the X axis is a negative value.

In another embodiment, the first condition may further include any one or more of the following: an acceleration component of a gravity acceleration G on the Z axis is close to a minimum value, and an acceleration component of the gravity acceleration G on the Y axis is close to a minimum value.

In another embodiment, the second condition may further include any one or more of the following: an acceleration component of a gravity acceleration G on the Z axis is close to a minimum value, and an acceleration component of the gravity acceleration G on the Y axis is close to a minimum value.

In some embodiments, the first earbud or the second earbud may further identify whether the first earbud or the second earbud is worn properly. After the first earbud or the second earbud is worn properly, accuracy for identifying whether the first earbud or the second earbud is worn on the left ear or the right ear can be improved. When the first earbud or the second earbud is not worn properly, the first earbud or the second earbud may prompt the user to wear the earbud in a proper posture until the first earbud or the second earbud is worn properly.

In some embodiments, after the first earbud or the second earbud is taken out from a charging case, and after the first earbud or the second earbud detects that the first earbud or the second earbud is worn, the first earbud or the second earbud may output an alert tone, where the alert tone is used to prompt the user to wear the earbud properly, to avoid inaccuracy for identifying whether the first earbud or the second earbud is worn on the left ear or the right ear because the user does not wear the earbud properly.

In some embodiments, after the first earbud or the second earbud is taken out from the charging case, and after the first earbud or the second earbud detects that the first earbud or the second earbud is worn, the first earbud or the second earbud may output an alert tone, where the alert tone is used to prompt the user to wear the earbud properly. After the user wears the first earbud or the second earbud, the first earbud or the second earbud may further identify whether the first earbud or the second earbud is worn properly. When the first earbud or the second earbud is not worn properly, the first earbud or the second earbud may prompt the user to wear the earbud in a proper posture until the first earbud or the second earbud is worn properly.

According to the foregoing manner, accuracy for identifying whether the first earbud or the second earbud is worn on the left ear or the right ear can be improved.

With reference to the first aspect, in a possible implementation, when the user is left-side lying, the first condition includes: a gravity component of the gravity data on the Y axis is a positive value; or when the user is left-side lying, the second condition includes: a gravity component of the gravity data in the positive direction of the Y axis is a negative value.

In another embodiment, the first condition may further include: a gravity acceleration component of the gravity acceleration G on the X axis is a minimum value. The second condition may further include: a gravity acceleration component of the gravity acceleration G on the X axis is a minimum value.

With reference to the first aspect, in a possible implementation, when the user is right-side lying, the first condition includes: a gravity component of the gravity data in the positive direction of the Y axis is a negative value; or when the user is right-side lying, the second condition includes: a gravity component of the gravity data in the positive direction of the Y axis is a positive value.

In another embodiment, the first condition may further include: a gravity acceleration component of the gravity acceleration G on the X axis is a minimum value. The second condition may further include: a gravity acceleration component of the gravity acceleration G on the X axis is a minimum value.

With reference to the first aspect, in a possible implementation, the first earbud body includes a first capacitive sensor, and the second earbud body includes a second capacitive sensor; and before the first earbud obtains the gravity data collected by the inertial detector, the method further includes: The first earbud obtains a first capacitance value collected by the first capacitive sensor and a second capacitance value collected by the second capacitive sensor; and when the first capacitance value is greater than a first threshold and the second capacitance value is greater than a second threshold, the first earbud determines that the first earbud is in a worn state.

In some embodiments, for people with different ear shapes and different wearing angles, a scenario in which the second earbud body is not attached to an ear or the first earbud body is not attached to an ear may occur. To improve accuracy of wearing identification, the earphone may identify, via the first capacitive sensor and the second capacitive sensor, whether the user wears the earphone.

When the user wears the earphone, the capacitive sensor can be closely attached to an auricle of the user, and form a specific capacitance difference due to applied pressure, to determine that the user is wearing the earphone. When the user does not wear the earphone, the capacitive sensor is not pressed. In this case, the capacitance difference is stable, and it may be determined that the user does not wear the earphone.

In some embodiments, the first earbud may alternatively determine, based on only the first capacitance value collected by the first capacitive sensor or the second capacitance value collected by the second capacitive sensor, whether the user is wearing the earbud.

With reference to the first aspect, in a possible implementation, that the first earbud obtains the first gravity data collected by the first inertial detector specifically includes: when the first earbud determines that the first earbud is in the worn state, the first earbud obtains the first gravity data collected by the first inertial detector.

Only when identifying that the first earbud is in the worn state, the first earbud determines, based on the first gravity data collected by the first inertial detector, whether the first earbud is worn on the left ear or the right ear. When identifying that the first earbud is in an unworn state, the first earbud does not perform determining based on the first gravity data collected by the first inertial detector, so that power consumption of the first earbud can be reduced.

With reference to the first aspect, in a possible implementation, that the first earbud determines that the first earbud is in the worn state specifically includes: The first earbud obtains a first capacitance error value corresponding to a first ambient temperature; the first earbud obtains a first target capacitance value based on the first capacitance value and the first capacitance error value, and obtains a second target capacitance value based on the second capacitance value and the first capacitance error value; and when the first target capacitance value is greater than the first threshold and the second target capacitance value is greater than the second threshold, the first earbud determines that the first earbud is in the worn state.

It should be noted that different ambient temperatures correspond to different capacitance error values.

In some embodiments, the capacitance value collected by the capacitive sensor is easily affected by a temperature, and different temperatures have different impact on the capacitance value collected by the capacitive sensor. To improve accuracy for identifying a wearing status, the earphone identifies, based on both the capacitance difference and temperature compensation, whether the earphone is in the worn state or the unworn state.

With reference to the first aspect, in a possible implementation, the method includes: when the first earbud identifies that the first earbud is worn on a left ear of a first user, the first earbud executes a control event corresponding to a left earbud attribute; and when the second earbud identifies that the first earbud is worn on a right ear of the first user, the second earbud executes a control event corresponding to a right earbud attribute.

In this way, the first earbud and the second earbud may be worn on a left ear and a right ear of a same user at the same time.

With reference to the first aspect, in a possible implementation, the method includes: when the first earbud identifies that the first earbud is worn on a left ear of a first user, the first earbud executes a control event corresponding to a left earbud attribute; and when the second earbud identifies that the first earbud is worn on a right ear of a second user, the second earbud executes a control event corresponding to a right earbud attribute.

In this way, the first earbud and the second earbud may be worn on a left ear and a right ear of different users at the same time.

With reference to the first aspect, in a possible implementation, the method includes: when the first earbud identifies that the first earbud is worn on a left ear of a first user, the first earbud executes a control event corresponding to a left earbud attribute; and when the second earbud identifies that the first earbud is worn on a left ear of a second user, the second earbud executes a control event corresponding to a left earbud attribute.

In this way, the first earbud and the second earbud may be worn on left ears of different users at the same time.

With reference to the first aspect, in a possible implementation, the method includes: when the first earbud identifies that the first earbud is worn on a right ear of a first user, the first earbud executes a control event corresponding to a right earbud attribute; and when the second earbud identifies that the first earbud is worn on a right ear of a second user, the second earbud executes a control event corresponding to a right earbud attribute.

In this way, the first earbud and the second earbud may be worn on right ears of different users at the same time.

With reference to the first aspect, in a possible implementation, the first earbud includes a first microphone and a second microphone, and the first microphone and the second microphone are disposed opposite to each other in the first earbud; and that when the first gravity data meets the first condition, the first earbud identifies that the first earbud is worn on the left ear, and executes the control event corresponding to the left earbud attribute specifically includes: when the first gravity data meets the first condition, the first earbud identifies that the first earbud is worn on the left ear, where the first microphone is located above the second microphone, and the first earbud enables the first microphone, and picks up an audio via the first microphone; or that when the first gravity data meets the second condition, the first earbud identifies that the first earbud is worn on the right ear, and executes the control event corresponding to the right earbud attribute specifically includes: when the first gravity data meets the second condition, the first earbud identifies that the first earbud is worn on the right ear, where the first microphone is located below the second microphone, and the first earbud enables the second microphone, and picks up an audio via the second microphone.

That the first microphone is located above the second microphone may mean that the first microphone is located at an end away from the ground, and the second microphone is located at an end close to the ground.

That the second microphone is located above the first microphone may mean that the second microphone is located at an end away from the ground, and the first microphone is located at an end close to the ground.

In this way, the first earbud may choose to enable different microphones based on that the first earbud is worn on the left ear or the right ear, so that not only quality of the audio collected by the microphone can be improved, but also power consumption of the first earbud can be reduced.

With reference to the first aspect, in a possible implementation, that when the first gravity data meets the first condition, the first earbud identifies that the first earbud is worn on the left ear, and executes the control event corresponding to the left earbud attribute specifically includes: when the first gravity data meets the first condition, the first earbud identifies that the first earbud is worn on the left ear, and plays a left channel audio; or that when the first gravity data meets the second condition, the first earbud identifies that the first earbud is worn on the right ear, and executes the control event corresponding to the right earbud attribute specifically includes: when the first gravity data meets the second condition, the first earbud identifies that the first earbud is worn on the right ear, and plays a right channel audio.

In this way, the first earbud may automatically switch between a left audio channel and a right audio channel based on that the first earbud identifies that the first earbud is worn on the left ear or the right ear, to improve audio playing effect.

With reference to the first aspect, in a possible implementation, that when the first gravity data meets the first condition, the first earbud identifies that the first earbud is worn on the left ear, and executes the control event corresponding to the left earbud attribute specifically includes: when the first gravity data meets the first condition, the first earbud identifies that the first earbud is worn on the left ear, and detects and responds to a first operation performed on a first area, to perform first control, where the first area includes an area on the ear on which the first earbud is worn or an area on the first earbud; or that when the first gravity data meets the second condition, the first earbud identifies that the first earbud is worn on the right ear, and executes the control event corresponding to the right earbud attribute specifically includes: when the first gravity data meets the second condition, the first earbud identifies that the first earbud is worn on the right ear, and detects and responds to a first operation performed on a second area, to perform second control, where the second area includes an area on the ear on which the first earbud is worn or an area on the first earbud, where the first control is the same as or different from the second control, and the first control or the second control includes any one of the following: pausing audio playing, continuing audio playing, switching audio playing, adjusting volume, answering a call, and ending a call.

In this way, the first earbud may automatically adapt to different gesture control based on that the first earbud identifies that the first earbud is worn on the left ear or the right ear, so that intelligence of operating the earbud by the user based on the gesture can be improved.

According to a second aspect, the present disclosure provides a wearable device, where the wearable device includes a first earbud, and the first earbud includes a first inertial detector and a first processor; the first inertial detector is configured to collect first gravity data; the first processor is configured to obtain the first gravity data collected by the first inertial detector; and the first processor is further configured to: when the first gravity data meets a first condition, identify that the first earbud is worn on a left ear, and execute a control event corresponding to a left earbud attribute; or when the first gravity data meets a second condition, identify that the first earbud is worn on a right ear, and execute a control event corresponding to a right earbud attribute.

With reference to the second aspect, in a possible implementation, the wearable device includes a second earbud, and the second earbud includes a second inertial detector and a second processor; the second inertial detector is configured to collect second gravity data; the second processor is configured to obtain the second gravity data collected by the second inertial detector; and the second processor is further configured to: when the second gravity data meets the first condition, identify that the second earbud is worn on a left ear, and execute a control event corresponding to a left earbud attribute; or when the second gravity data meets the second condition, identify that the second earbud is worn on a right ear, and execute a control event corresponding to a right earbud attribute.

With reference to the second aspect, in a possible implementation, the second earbud includes a first earbud body, a cantilever arm, and a second earbud body, the cantilever arm is connected between the first earbud body and the second earbud body, and the first earbud body and the second earbud body are disposed opposite to each other and have an initial distance; the cantilever arm is deformable, deformation of the cantilever arm can adjust the initial distance between the first earbud body and the second earbud body to an adjustment distance, a connection line between a geometric center of the second earbud body and a geometric center of the first earbud body is defined as a Z axis, and a direction in which the geometric center of the second earbud body points to the geometric center of the first earbud body is defined as a positive direction of the Z axis; a straight line that passes through a geometric center of an end face on which the cantilever arm is connected to the second earbud body and that is perpendicular to the end face is defined as a Y axis, and a direction in which the geometric center of the end face points to the cantilever arm is defined as a positive direction of the Y axis; and a straight line perpendicular to both the Z axis and the Y axis is defined as an X axis, where when the first earbud is worn on the left ear, a positive direction of the X axis points to the ground; and when a user is standing or sitting, the first condition includes: a gravity component of the gravity data in the positive direction of the X axis is a positive value; or when a user is standing or sitting, the second condition includes: a gravity component of the gravity data in the positive direction of the X axis is a negative value.

With reference to the second aspect, in a possible implementation, when the user is left-side lying, the first condition includes: a gravity component of the gravity data in the positive direction of the Y axis is a positive value; or when the user is left-side lying, the second condition includes: a gravity component of the gravity data in the positive direction of the Y axis is a negative value.

With reference to the second aspect, in a possible implementation, when the user is right-side lying, the first condition includes: a gravity component of the gravity data in the positive direction of the Y axis is a negative value; or when the user is right-side lying, the second condition includes: a gravity component of the gravity data in the positive direction of the Y axis is a positive value.

With reference to the second aspect, in a possible implementation, the first earbud body includes a first capacitive sensor, and the second earbud body includes a second capacitive sensor; and the first processor is further configured to: obtain a first capacitance value collected by the first capacitive sensor and a second capacitance value collected by the second capacitive sensor; and when the first capacitance value is greater than a first threshold and the second capacitance value is greater than a second threshold, the first earbud determines that the first earbud is in a worn state.

With reference to the second aspect, in a possible implementation, the first processor is configured to: when determining that the first earbud is in the worn state, obtain the first gravity data collected by the first inertial detector. References to a processor being configured to complete a functions are references to the processor executing instructions to perform the function as a person of skill in the part would know.

With reference to the second aspect, in a possible implementation, the first earbud further includes a temperature sensor, and the temperature sensor is configured to collect a first ambient temperature; and the first processor is configured to: obtain a first capacitance error value based on the first ambient temperature; obtain a first target capacitance value based on the first capacitance value and the first capacitance error value, and obtain a second target capacitance value based on the second capacitance value and the first capacitance error value; and when the first target capacitance value is greater than the first threshold and the second target capacitance value is greater than the second threshold, determine that the first earbud is in the worn state.

With reference to the second aspect, in a possible implementation, the first processor is configured to: when identifying that the first earbud is worn on a left ear of a first user, execute a control event corresponding to a left earbud attribute; and the second processor is configured to: when identifying that the second earbud is worn on a right ear of the first user, execute a control event corresponding to a right earbud attribute.

With reference to the second aspect, in a possible implementation, the first processor is configured to: when identifying that the first earbud is worn on a left ear of a first user, execute a control event corresponding to a left earbud attribute; and the second processor is configured to: when identifying that the second earbud is worn on a right ear of a second user, execute a control event corresponding to a right earbud attribute.

With reference to the second aspect, in a possible implementation, the first processor is configured to: when identifying that the first earbud is worn on a left ear of a first user, execute a control event corresponding to a left earbud attribute; and the second processor is configured to: when identifying that the second earbud is worn on a left ear of a second user, execute a control event corresponding to a left earbud attribute.

With reference to the second aspect, in a possible implementation, the first processor is configured to: when identifying that the first earbud is worn on a right ear of a first user, execute a control event corresponding to a right earbud attribute; and the second processor is configured to: when identifying that the second earbud is worn on a right ear of a second user, execute a control event corresponding to a right earbud attribute.

With reference to the second aspect, in a possible implementation, the first earbud includes a first microphone and a second microphone, and the first microphone and the second microphone are disposed opposite to each other in the first earbud; and the first processor is configured to: when the first gravity data meets the first condition, identify that the first earbud is worn on the left ear, where the first microphone is located above the second microphone, enable the first microphone, and pick up an audio via the first microphone; or the first processor is configured to: when the first gravity data meets the second condition, identify that the first earbud is worn on the right ear, where the first microphone is located below the second microphone, enable the second microphone, and pick up an audio via the second microphone.

With reference to the second aspect, in a possible implementation, the first processor is configured to: when the first gravity data meets the first condition, identify that the first earbud is worn on the left ear, and play a left channel audio; or the first processor is configured to: when the first gravity data meets the second condition, identify that the first earbud is worn on the right ear, and play a right channel audio.

With reference to the second aspect, in a possible implementation, the first earbud further includes a touch controller, and the touch controller is configured to: when the first gravity data meets the first condition, identify that the first earbud is worn on the left ear, detect and respond to a first operation performed on a first area, and send a first message to the first processor; and the first processor is further configured to perform first control in response to the first message, where the first area includes an area on the ear on which the first earbud is worn or an area on the first earbud; or the touch-control unit is configured to: when the first gravity data meets the second condition, identify that the first earbud is worn on the right ear, detect and respond to a first operation performed on a second area, and send a second message to the first processor; and the first processor is further configured to perform second control in response to the second message, where the second area includes an area on the ear on which the first earbud is worn or an area on the first earbud, where the first control is the same as or different from the second control, and the first control or the second control includes any one of the following: pausing audio playing, continuing audio playing, switching audio playing, adjusting volume, answering a call, and ending a call.

According to a third aspect, the present disclosure provides an earphone, being a first earbud, where the first earbud includes a first inertial detection unit and a first processing unit; the first inertial detection unit is configured to collect first gravity data; the first processing unit is configured to obtain the first gravity data collected by the first inertial detection unit; and the first processing unit is further configured to: when the first gravity data meets a first condition, identify that the first earbud is worn on a left ear, and execute a control event corresponding to a left earbud attribute; or when the first gravity data meets a second condition, identify that the first earbud is worn on a right ear, and execute a control event corresponding to a right earbud attribute.

With reference to the third aspect, in a possible implementation, the first earbud further includes a first capacitive collection unit and a second capacitive collection unit; and the first processing unit is further configured to: obtain a first capacitance value collected by the first capacitive collection unit and a second capacitance value collected by the second capacitive collection unit; and when the first capacitance value is greater than a first threshold and the second capacitance value is greater than a second threshold, the first earbud determines that the first earbud is in a worn state.

With reference to the third aspect, in a possible implementation, the first processing unit is configured to: when determining that the first earbud is in the worn state, obtain the first gravity data collected by the first inertial detection unit.

With reference to the third aspect, in a possible implementation, the first earbud further includes a temperature collection unit, and the temperature collection unit is configured to collect a first ambient temperature; the first processing unit is configured to: obtain a first capacitance error value based on the first ambient temperature; obtain a first target capacitance value based on the first capacitance value and the first capacitance error value, and obtain a second target capacitance value based on the second capacitance value and the first capacitance error value; and when the first target capacitance value is greater than the first threshold and the second target capacitance value is greater than the second threshold, determine that the first earbud is in the worn state.

With reference to the third aspect, in a possible implementation, the first earbud further includes a first audio collection unit and a second audio collection unit, and the first audio collection unit and the first audio collection unit are disposed opposite to each other; and the first processing unit is configured to: when the first gravity data meets the first condition, identify that the first earbud is worn on the left ear, where the first audio collection unit is located above the second audio collection unit, enable the first audio collection unit, and pick up an audio via the first audio collection unit; or the first processing unit is configured to: when the first gravity data meets the second condition, identify that the first earbud is worn on the right ear, where the first audio collection unit is located below the second audio collection unit, enable the second audio collection unit, and pick up an audio via the second audio collection unit.

With reference to the third aspect, in a possible implementation, the first processing unit is configured to: when the first gravity data meets the first condition, identify that the first earbud is worn on the left ear, and play a left channel audio; or the first processing unit is configured to: when the first gravity data meets the second condition, identify that the first earbud is worn on the right ear, and play a right channel audio.

With reference to the third aspect, in a possible implementation, the first earbud further includes a touch-control unit, and the touch-control unit is configured to: when the first gravity data meets the first condition, identify that the first earbud is worn on the left ear, detect and respond to a first operation performed on a first area, and send a first message to the first processing unit; and the first processing unit is further configured to perform first control in response to the first message, where the first area includes an area on the ear on which the first earbud is worn or an area on the first earbud; or the touch-control unit is configured to: when the first gravity data meets the second condition, identify that the first earbud is worn on the right ear, detect and respond to a first operation performed on a second area, and send a second message to the first processing unit; and the first processing unit is further configured to perform second control in response to the second message, where the second area includes an area on the ear on which the first earbud is worn or an area on the first earbud, where the first control is the same as or different from the second control, and the first control or the second control includes any one of the following: pausing audio playing, continuing audio playing, switching audio playing, adjusting volume, answering a call, and ending a call.

According to a fourth aspect, the present disclosure provides a wearable device, where the wearable device includes an inertial detector, a memory, and a processor, the inertial detector, the memory, and the processor are coupled, the memory is configured to store a computer program, and when the processor executes and invokes the computer program, the wearable device is enabled to perform the earphone control method provided in any possible implementation of any one of the foregoing aspects.

According to a fifth aspect, the present disclosure provides a computer-readable storage medium, including instructions. When the instructions are run on a wearable device, the wearable device is enabled to perform the earphone control method provided in any possible implementation of any one of the foregoing aspects.

According to a sixth aspect, the present disclosure provides a chip system, where the chip system includes one or more processors, and the processor is configured to invoke computer instructions, to perform the earphone control method provided in any possible implementation of any one of the foregoing aspects.

According to a seventh aspect, the present disclosure provides a computer program product including instructions. When the computer program product runs on a wearable device, the wearable device is enabled to perform the earphone control method provided in any possible implementation of any one of the foregoing aspects.

For descriptions of beneficial effect in the second aspect to the seventh aspect, refer to descriptions of beneficial effect in the first aspect.

### BRIEF DESCRIPTION OF DRAWINGS

FIG. 1 is a state diagram in which an earphone 1000 is respectively worn on a left ear and a right ear according to the present disclosure;

FIG. 2 is a diagram of a structure of an earphone 1000 according to the present disclosure;

FIG. 3 is a state diagram in which a user wears a single earbud on a right ear according to the present disclosure;

FIG. 4 is a diagram of a structure of an implementation of a first earbud body 100 according to the present disclosure;

FIG. 5 is a diagram of a structure of an implementation of a second earbud body 200 according to the present disclosure;

FIG. 6 is a diagram of a structure of an implementation of a third housing 210 according to the present disclosure;

FIG. 7 is a diagram of a structure of an earphone 1000 at another angle according to the present disclosure;

FIG. 8 is a diagram of a structure of a charging case 200 according to the present disclosure;

FIG. 9 is a diagram of a capacitance change curve according to the present disclosure;

FIG. 10 and FIG. 11 are diagrams in which a user wears an earphone 1000 when standing according to the present disclosure;

FIG. 12 and FIG. 13 are diagrams of gravity acceleration components on three axes when a user wears an earphone 1000 when standing according to the present disclosure;

FIG. 14A and FIG. 14B are diagrams in which a user wears an earphone 1000 when sitting;

FIG. 15A and FIG. 15B are diagrams in which a user wears an earphone 1000 when flat lying;

FIG. 15C is a diagram of gravity acceleration components on three axes when a user wears an earphone 1000 when flat lying according to the present disclosure;

FIG. 16A and FIG. 16B are diagrams in which a user wears an earphone during right-side lying;

FIG. 16C is a diagram of gravity acceleration components on three axes when a user wears an earphone 1000 during right-side lying according to the present disclosure;

FIG. 16D is a diagram of gravity acceleration components on three axes when a user wears an earphone 1000 during left-side lying according to the present disclosure;

FIG. 17A and FIG. 17B are diagrams of switching between a left channel audio and a right channel audio;

FIG. 18A and FIG. 18B are other diagrams of switching between a left channel audio and a right channel audio;

FIG. 19A to FIG. 19I are diagrams in which a user views and sets an earphone touch-control gesture and views battery levels of a left earbud and a right earbud in a Health application of an electronic device;

FIG. 20A to FIG. 20K are diagrams in which a user views and sets an earphone touch-control gesture on an electronic device;

FIG. 20L shows an example of a flowchart of a method for training a gesture recognition model;

FIG. 20M shows an example of a flowchart of a method for providing a touch-control function by an earphone 1000;

FIG. 21A to FIG. 21P are diagrams of determining a primary mic by an earphone;

FIG. 22 is a schematic flowchart of an earphone control method according to the present disclosure;

FIG. 23 is a diagram of a structure of a wearable device according to the present disclosure; and

FIG. 24 is an apparatus diagram of a first earbud according to the present disclosure.

### DESCRIPTION OF EMBODIMENTS

The technical solutions according to embodiments of the present disclosure are clearly and completely described in the following with reference to the accompanying drawings. In descriptions of embodiments of the present disclosure, “/” indicates or, unless otherwise specified. For example, A/B may indicate A or B. In this specification, “and/or” describes only an association relationship between associated objects, and indicates that three relationships may exist. For example, A and/or B may indicate the following three cases: Only A exists, both A and B exist, and only B exists. In addition, in descriptions of embodiments of the present disclosure, “a plurality of” means two or more than two.

In the following, the terms “first” and “second” are merely intended for the purpose of description, and shall not be understood as an indication or implication of relative importance or implicit indication of a quantity of indicated technical features. Therefore, a feature limited by “first” and “second” may explicitly or implicitly include one or more features. In the descriptions of embodiments of the present disclosure, unless otherwise specified, “a plurality of” means two or more.

The term “user interface (user interface, UI)” in the following embodiments of the present disclosure is a medium interface for interaction and information exchange between an application or an operating system and a user. The user interface implements conversion between an internal form of information and a form acceptable to the user. A frequently-used representation form of the user interface is a graphical user interface (graphic user interface, GUI), and is a user interface that is displayed in a graphical manner and that is related to a computer operation. The user interface may be a visual interface element such as a text, an icon, a button, a menu, a tab, a text box, a dialog box, a status bar, a navigation bar, or a Widget that is displayed on a display of the electronic device.

The following describes embodiments of the present disclosure with reference to the accompanying drawings in embodiments of the present disclosure.

### Wearing Form of an Earphone 1000

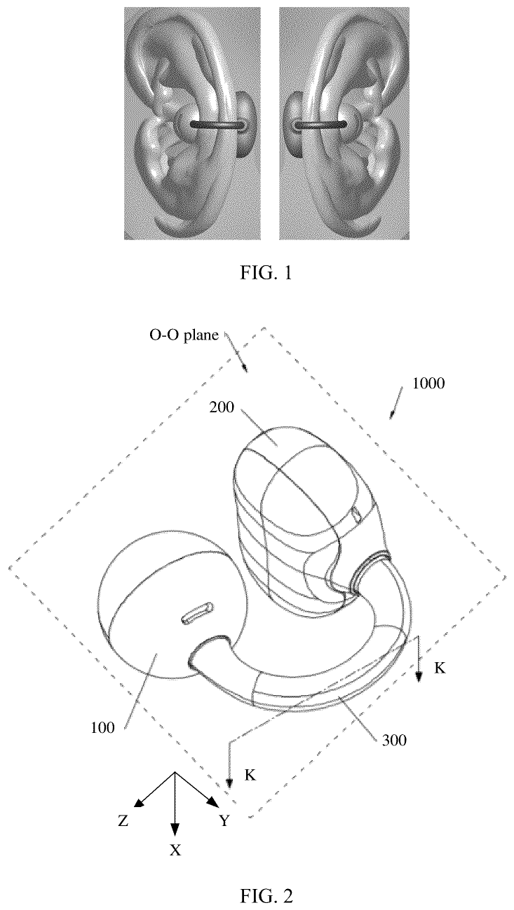

FIG. 1 is a state diagram in which an earphone 1000 is respectively worn on a left ear and a right ear according to the present disclosure.

In some embodiments, the earphone 1000 may be referred to as a wearable device.

As shown in FIG. 1, the earphone 1000 is a wireless clip-on earphone, and may be clipped on an ear. The clip-on earphone can reduce discomfort of an ear of a wearer and improve wearing comfort. The earphone 1000 includes two earbuds. For example, the earphone 1000 may include a first earbud and a second earbud. The first earbud and the second earbud are respectively worn on a left ear and a right ear of a user. An earbud structure of the first earbud is the same as that of the second earbud, and therefore there is no need to distinguish between the left ear and the right ear when the earbud is worn. In other words, the first earbud may be worn on the left ear or the right ear, and the second earbud may be worn on the left ear or the right ear. In this way, portability of using the earbud is improved.

### Composition Structure of the Earphone (a First Earbud Body 100, a Cantilever Arm 300, and a Second Earbud Body 200)

The following describes in detail the earphone in the present disclosure with reference to the accompanying drawings.

FIG. 2 is a diagram of a structure of the earphone 1000 according to the present

### DISCLOSURE

As shown in FIG. 2, the earphone 1000 is approximately U-shaped, and includes the first earbud body 100, the second earbud body 200, and the cantilever arm 300. The cantilever arm 300 is approximately U-shaped, and is connected between the first earbud body 100 and the second earbud body 200. The first earbud body 100 and the second earbud body 200 are disposed opposite to each other. The cantilever arm 300 enables the first earbud body 100 and the second earbud body 200 to form a physical connection, and the first earbud body 100 and the second earbud body 200 are also electrically connected.

For ease of description, a geometric center of the first earbud body 100, a geometric center of the second earbud body 200, and a geometric center of the cantilever arm 300 determine a unique plane, that is, an O—O plane (shown by using a dashed line in FIG. 2). For ease of description, a connection line between the geometric center of the second earbud body 200 and the geometric center of the first earbud body 100 is defined as a Z axis, and a direction in which the geometric center of the second earbud body 200 points to the geometric center of the first earbud body 100 is defined as a positive direction of the Z axis. A straight line that passes through a geometric center of an end face on which the cantilever arm 300 is connected to the second earbud body 200 and that is perpendicular to the end face is defined as a Y axis, and a direction in which the geometric center of the end face points to the cantilever arm 300 is defined as a positive direction of the Y axis. A straight line perpendicular to both the Z axis and the Y axis is defined as an X axis. As shown in FIG. 2, a direction that is perpendicular to the Z axis and the Y axis and that points to the ground is a positive direction of the X axis.

### Wearing Form of a Single Earbud

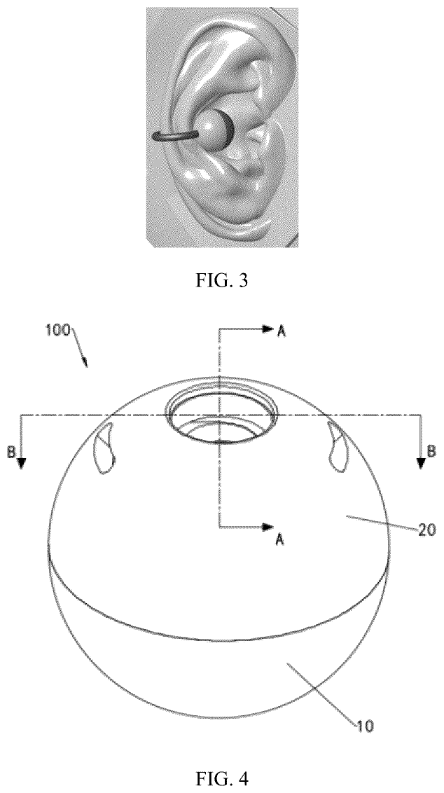

FIG. 3 is a state diagram in which the user wears the single earbud on the right ear.

As shown in FIG. 3, in a use process, the first earbud body 100 is clipped in a cavity of concha of the user, and does not go deep into an ear canal of the user. The first earbud body 100 may be spherical, or certainly may be an irregular sphere. A tolerance degree of a cavity of concha of the human body is far higher than that of an ear canal. Therefore, the earphone 1000 provided in the present disclosure can greatly improve wearing comfort.

The second earbud body 200 is located outside the ear of the user and on a side that is away from the first earbud body 100. The second earbud body 200 adopts a contoured design, is shaped like a broad bean, and is attached to a curved surface of an auricle of the user when being worn, so that wearing comfort of the user can be improved.

The cantilever arm 300 is hooked onto an outer edge side of the ear of the user, and extends from the cavity of concha to a rear position of the ear. The cantilever arm 300, together with the first earbud body 100 and the second earbud body 200, is clipped on the auricle of the user, so that the earphone 1000 is worn on the ear. In this embodiment provided in the present disclosure, the cantilever arm 300 has a deformation capability, and can adjust and control an adjustment distance L between the first earbud body 100 and the second earbud body 200. The distance L between the first earbud body 100 and the second earbud body 200 needs to be greater than or equal to 2 mm and less than or equal to 5 mm, to ensure that clipping force of the earphone 1000 is moderate, the earphone 1000 does not slip off the auricle, and no excessive clipping is generated on the ear. A height H of the cantilever arm 300 needs to be greater than or equal to 3 mm and less than or equal to 30 mm, to avoid scratching the outer edge of the auricle of the user during daily use.

Actually, the first earbud body 100 and the second earbud body 200 are disposed opposite to each other and have an initial distance. The deformation of the cantilever arm can adjust the initial distance between the first earbud body and the second earbud body to the adjustment distance. The adjustment distance is a distance obtained after the initial distance increases or decreases.

Specifically, both the initial distance and the adjustment distance are the distance L between the first earbud body 100 and the second earbud body 200. The distance L is a distance between surfaces that the first earbud body 100 and the second earbud body 200 face each other, and is also a distance between two earbud surfaces that first contact the ear. The height H of the cantilever arm 300 is a longest distance between the cantilever arm 300 and an end face of the cantilever arm 300 in a direction perpendicular to the end face of the cantilever arm 300 (a Y-axis direction).

The earphone 1000 equipped with the cantilever arm 300 may be adapted to users with different ear thicknesses, and provide proper clipping force for the users, to avoid affecting wearing experience caused by excessively tight clipping or excessively loose clipping. In addition, when wearing and removing the earphone 1000 provided in the present disclosure, the user may increase the distance L between the first earbud body 100 and the second earbud body 200 via the cantilever arm 300, to ensure that the earphone 1000 is smoothly worn or removed, avoid deformation of the ear due to pressure, and improve experience of the user when the earphone 1000 is worn or removed.

### Structural Form of the First Earbud Body 100

FIG. 4 is a diagram of a structure of an implementation of the first earbud body 100 in

FIG. 1.

As shown in FIG. 4, the first earbud body 100 may include a first housing 10 and a second housing 20.

In some embodiments, a first capacitive sensor is disposed in the first earbud body 100. The first capacitive sensor is configured to implement a wearing detection function: identifying whether the user wears the earphone 1000. The first capacitive sensor is disposed in the first earbud body 100. For example, the first capacitive sensor is connected to an inner surface of the second housing 20.

When the earphone is worn on the ear, the auricle contacts the first capacitive sensor in the first earbud body 100, so that a capacitance value of the first capacitive sensor changes, and whether the user wears the earphone may be determined based on the change of the capacitance value of the first capacitive sensor. In a possible implementation, there may be one or more first capacitive sensors.

In another embodiment, the wearing detection function may alternatively be implemented by a proximity sensor. Specifically, the first earbud body 100 has a transmit end and a receive end. The transmit end and the receive end are configured to perform optical detection, that is, determine, by transmitting and receiving light, whether an object approaches, to implement the wearing detection function. The transmit end may transmit a specific light section, and the receive end may receive an optical signal and make determining. Specifically, when the user wears the earphone 1000, the specific light section transmitted by the transmit end is reflected by the auricle of the user to the receive end, and the receive end detects the specific light section signal, and therefore determines that the user wears the earphone 1000. When the user does not wear the earphone 1000, the specific light section transmitted by the transmit end is not reflected by the auricle of the user, and the receive end cannot detect the specific light section signal, and therefore determines that the user does not wear the earphone 1000 or fails to wear the earphone 1000.

In another embodiment, the wearing detection function may alternatively be implemented in an optical detection manner. Specifically, the first earbud body 100 further includes a receive end, and the second earbud body 200 further includes a transmit end. The receive end and the transmit end are disposed side by side and opposite to each other. The transmit end may transmit a specific light section, and the receive end may receive an optical signal and make determining. Specifically, when the user wears the earphone 1000, the specific light section transmitted by the transmit end is blocked by the auricle of the user, and the receive end cannot detect the specific light section signal, and therefore determines that the user does not wear the earphone 1000 or fails to wear the earphone 1000. When the user does not wear the earphone 1000, the specific light section transmitted by the transmit end directly enters the receive end, and the receive end detects the specific light section signal, and therefore determines that the user wears the earphone 1000.

Optionally, the transmit end may alternatively be located in the first earbud body 100, and the receive end may be located in the second earbud body 200.

In addition to the capacitive sensor and the optical detection manner, whether the user wears the earphone 1000 may be determined in another manner. This is not limited in the present disclosure.

### Structural Form of the Second Earbud Body 200

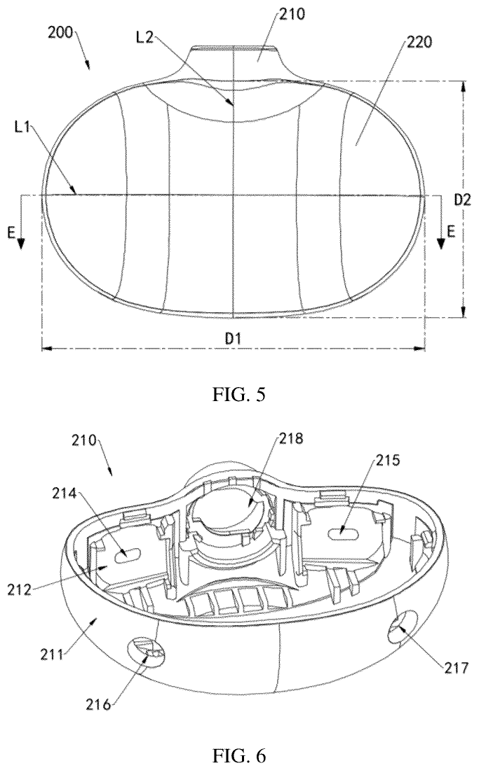

FIG. 5 is a diagram of a structure of an implementation of the second earbud body 200 shown in FIG. 2. As shown in FIG. 5, the second earbud body 200 may include a third housing 210 and a fourth housing 220.

FIG. 6 is a diagram of a structure of an implementation of the third housing 210 shown in FIG. 5.

As shown in FIG. 6, the third housing 210 is provided with a first sound pickup hole 214 and a second sound pickup hole 215 that are spaced. The first sound pickup hole 214 and the second sound pickup hole 215 are spaced in a direction parallel to a major axis L1. An outer surface 211 of the third housing 210 communicates with an inner surface 212 of the third housing 210 through the first sound pickup hole 214. The outer surface 211 of the third housing 210 may communicate with the inner surface 212 of the third housing 210 through the second sound pickup hole 215.

In some embodiments, a first feedforward microphone and a second feedforward microphone are disposed in the second earbud body 200. In some implementations, the first feedforward microphone and the second feedforward microphone may be symmetrical with respect to an O—O symmetry plane. The first feedforward microphone and the second feedforward microphone may be disposed opposite to each other. The first feedforward microphone may be located below the first sound pickup hole 214 and pick up an audio near the first sound pickup hole 214. The second feedforward microphone may be located below the second sound pickup hole 215, and pick up an audio near the second sound pickup hole 215.

In some implementations, the first sound pickup hole 214 and the second sound pickup hole 215 may be symmetrical with respect to the O—O symmetry plane.

The third housing 210 is provided with a fifth through hole 216 and a sixth through hole 217 that are spaced. The fifth through hole 216, the sixth through hole 217, the first sound pickup hole 214, and the second sound pickup hole 215 are spaced. The fifth through hole 216 and the sixth through hole 217 are spaced in the direction parallel to the major axis L1. The outer surface 211 of the third housing 210 may communicate with the inner surface 212 of the third housing 210 through the fifth through hole 216. The outer surface 211 of the third housing 210 may communicate with the inner surface 212 of the third housing 210 through the sixth through hole 217.

In some implementations, the fifth through hole 216 and the sixth through hole 217 may be symmetric with respect to the O—O symmetry plane (that is, an X-Y plane).

The third housing 210 may be further provided with a seventh through hole 218. The seventh through hole 218 is spaced from the first sound pickup hole 214, the second sound pickup hole 215, the fifth through hole 216, and the sixth through hole 217. The outer surface 211 of the third housing 210 communicates with the inner surface 212 of the third housing 210 through the seventh through hole 218.

As shown in FIG. 6, a charging terminal may be located on a side that is of a battery 240 and that is away from the seventh through hole 218. For example, the charging terminal includes a first electrode and a second electrode. The first electrode is fastened to the third housing 210, and is exposed from the second earbud body 200 at the fifth through hole 216. The second electrode is fastened to the third housing 210, and is exposed from the second earbud body 200 at the sixth through hole 217. In another implementation, the fifth through hole 216 and the sixth through hole 217 may alternatively be disposed on the fourth housing 220, and the first electrode and the second electrode may alternatively be fastened to the fourth housing 220. This is not limited in the present disclosure.

When the user charges the carphone 1000, the first electrode and the second electrode respectively serve as a positive electrode and a negative electrode, but correspondences between the first and second electrodes and the positive and negative electrodes are not fixed. It may be understood that the first electrode may be used as a positive electrode, and the second electrode may be used as a negative electrode; or the first electrode may be used as a negative electrode, and the second electrode may be used as a positive electrode.

In some embodiments, a second capacitive sensor is disposed in the second earbud body 200. The second capacitive sensor is configured to implement a wearing detection function: identifying whether the user wears the earphone 1000. The second capacitive sensor is disposed in the second earbud body 200.

In another embodiment, the wearing detection function may alternatively be implemented by a proximity sensor.

In addition to the capacitive sensor and the optical detection manner, whether the user wears the earphone 1000 may be determined in another manner. This is not limited in the present disclosure. For details, refer to the description in the embodiment in FIG. 4. Details are not described herein again in the present disclosure.

In some embodiments, the second earbud body 200 further includes an inertial detector (Inertial Measurement Unit, IMU), configured to determine a posture. Specifically, after a wearing detector of the earphone 1000 detects that the user wears the earphone 1000, the inertial detector may determine whether the earphone 1000 is worn on the left ear or the right ear of the user, and then perform operations such as switching between a left audio channel and a right audio channel, switching gesture control, identifying battery levels of a left earbud and a right earbud, and determining a primary mic.

The inertial detector is not limited to being located in the second earbud body 200, the inertial detector may alternatively be located in the first earbud body 100, and the inertial detector may alternatively be located in the cantilever arm 300. This is not limited in the present disclosure.

Therefore, the earphone 1000 provided in this embodiment can resolve a problem that it is difficult to distinguish between the left ear and the right ear when earbud forms are similar, so that the user does not need to distinguish between the left ear and the right ear when wearing the earphone 1000, thereby improving flexibility of using the earphone 1000 by the user, and improving use experience of wearing and using the wireless earphone 1000 by the user.

### Structural Form of the Cantilever Arm 300

The cantilever arm 300 may include a first connector and a second connector. The cantilever arm 300 may be connected to the first earbud body 100 via the first connector, and connected to the second earbud body 200 via the second connector. The cantilever arm 300 may further implement signal transmission between the first earbud body 100 and the second earbud body 200.

In the foregoing embodiments provided in the present disclosure, a support member 330 in the cantilever arm 300 may adjust and control a distance between two opposite ends of the cantilever arm 300 in an X-axis direction. Therefore, after connecting the first earbud body 100 and the second earbud body 200, the cantilever arm 300 can adapt to users with different ear thicknesses by adjusting and controlling the distance L between the first earbud body 100 and the second earbud body 200, thereby providing proper clipping force for the users, and improving comfort of the user in a long-time process of wearing the earphone 1000 and processes of wearing and removing the earphone 1000.

### Symmetrical Structure of the First Earbud Body 100, the Cantilever Arm 300, and the Second Earbud Body 200

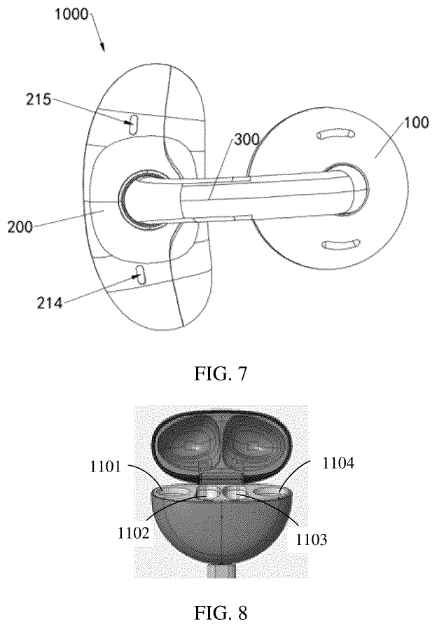

FIG. 7 is a diagram of a structure of the earphone 1000 shown in FIG. 2 at another angle.

As shown in FIG. 7, an appearance surface of the first earbud body 100 has a symmetry plane 1. An appearance surface of the second earbud body 200 has a symmetry plane 2. An appearance surface of the cantilever arm also has a symmetry plane 3. The symmetry plane 1, the symmetry plane 2, and the symmetry plane 3 are coplanar. It may be understood that, due to an assembly tolerance, a micro included angle is allowed between any two of the symmetry plane 1, the symmetry plane 2, and the symmetry plane 3, and the included angle is less than or equal to 1°, for example, 0.2°, 0.5°, 0.9°, or 1.0°. For example, an included angle between the symmetry plane 1 and the symmetry plane 2 may be less than 1°, or an included angle between the symmetry plane 1 and the symmetry plane 3 may be less than 1°, or an included angle between the symmetry plane 2 and the symmetry plane 3 may be less than 1°. In this case, any one of the symmetry plane 1, the symmetry plane 2, and the symmetry plane 3 is the symmetry plane 0-0 of the earphone 1000. In this way, an overall appearance of the earphone 1000 is in a symmetrical structure, and in a process in which the user uses the earphone 1000, there is no need to distinguish between the left ear and the right ear.

In the present disclosure, an earphone 1000 is specifically described with reference to related accompanying drawings. The earphone 1000 includes a first earbud body 100, a cantilever arm 300, and a second earbud body 200. The cantilever arm 300 is connected between the first earbud body 100 and the second earbud body 200, and the first earbud body 100 is configured to make a sound. The second earbud body 200 includes a housing, a first feedforward microphone, and a second feedforward microphone. A second space is disposed inside the housing. A first sound pickup hole 214 and a second sound pickup hole 215 are disposed inside the housing. The second space communicates with the outside of the second earbud body 200 through the first sound pickup hole 214 and the second sound pickup hole 215. The first feedforward microphone picks up an external sound of the second earbud body 200 through the first sound pickup hole 214, the second feedforward microphone picks up an external sound of the second earbud body 200 through the second sound pickup hole 215. An appearance surface of the second earbud body 200 is symmetric with respect to a symmetry plane 2, the appearance surface of the second earbud body 200 has a major axis L1, and the first sound pickup hole 214 and the second sound pickup hole 215 are symmetric with respect to the symmetry plane 2, and are located on a side that is of the major axis and that is close to the cantilever arm 300.

It may be understood that, compared with a solution in which only one of the first sound pickup hole 214 or the second sound pickup hole 215 is disposed, in this solution, regardless of whether the user wears the earphone 1000 on the left ear or the right ear, one of the first sound pickup hole 214 and the second sound pickup hole 215 can keep facing the ground and the other can keep facing a side away from the ground. When the sound pickup hole facing the side away from the ground is blocked by sweat dripping, the other sound pickup hole can still operate normally to implement active noise reduction.

In addition, compared with a solution in which the major axis L1 passes through the first sound pickup hole 214 and the second sound pickup hole 215, in this solution, the first sound pickup hole 214 and the second sound pickup hole 215 are disposed on one side of the major axis L1, so that when the user wears the earphone 1000, a risk that sweat drips into the first sound pickup hole 214 or the second sound pickup hole 215 can be reduced, to prevent the first sound pickup hole 214 or the second sound pickup hole 215 from being blocked by sweat, thereby preventing active noise reduction effect from being affected.

In some implementations, the appearance, a charging design, audio effect, and the like of the earphone 1000 in the present disclosure is symmetric with respect to the O—O plane. Therefore, the user does not need to distinguish between the left ear and the right ear when using the earphone 1000.

It should be noted that embodiments in the present disclosure and features in embodiments may be combined with each other without a conflict, and any combination of features in different embodiments also falls within the protection scope of the present disclosure. In other words, the foregoing described plurality of embodiments may be further combined according to an actual requirement.

### Place the Earphone 1000 and a Charging Case for Charging the Earphone 1000

As shown in FIG. 8, a charging case 2000 includes a slot 1101, a slot 1102, a slot 1103, and a slot 1104. The slot 1101 and the slot 1102 may be used to place any earbud in the earphone 1000, and the slot 1103 and the slot 1104 may be used to place any earbud in the earphone 1000.

The slot 1101 and the slot 1104 are used to place first earbud bodies 100, and the slot 1102 and the slot 1103 are used to place second earbud bodies 200.

The first earbud or the second earbud in the earphone 1000 may be randomly placed in the slot 1101 and the slot 1102, or in the slot 1103 and the slot 1104.

For ease of opening and closing, a vertical opening and closing structure may be used for the charging case 2000. When the two earbuds in the earphone 1000 are placed in the charging case 2000, the charging case 2000 restores default attributes of the earbuds based on placement positions of the earbuds.

The default attribute of the earbud may be determined based on the position at which the earbud is placed in the charging case 2000. For example, when the earbud is located in the slot 1101 and the slot 1102 in the charging case 2000, the default attribute of the earbud is a left earbud attribute. When the earbud is located in the slot 1103 and the slot 1104 in the charging case 2000, the default attribute of the earbud is a right earbud attribute.

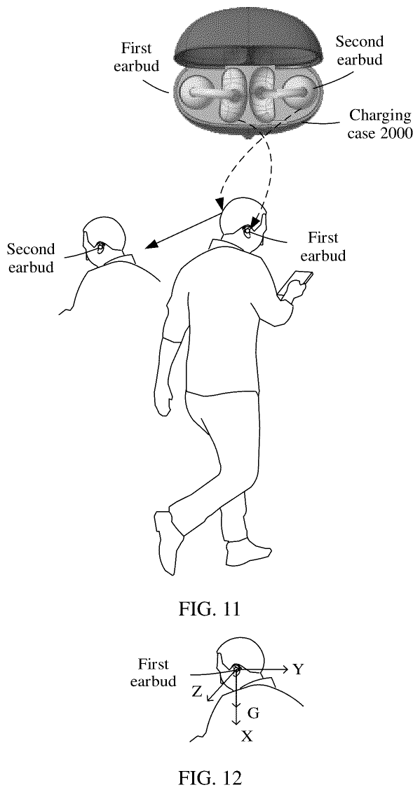

For example, an opening of the charging case faces the user. An attribute of an earbud placed in the slot 1101 and the slot 1102 shown in FIG. 11 is a left earbud attribute, and an attribute of an earbud placed in the slot 1103 and the slot 1104 shown in FIG. 11 is a right earbud attribute.

In some embodiments, the slot 1101 and the slot 1102 in the charging case 2000 may be referred to as a left compartment, and the slot 1103 and the slot 1104 in the charging case 2000 may be referred to as a right compartment. An earbud attribute of an earbud placed in the left compartment is a left earbud attribute, and an earbud attribute of an earbud placed in the right compartment is a right earbud attribute.

For example, the earphone 1000 includes a first earbud and a second earbud. When the first earbud is placed in the left compartment in the charging case 2000, an earbud attribute of the first earbud is the left earbud attribute. When the second earbud is placed in the right compartment in the charging case 2000, an earbud attribute of the second earbud is the right earbud attribute.

In this way, it is ensured that the earbud attribute is correct when the earbud is taken out from the compartment after being placed in the compartment, to avoid disorder of the earbud attribute.

### Identify a Wearing Status of the Earphone

As described above, the user does not need to distinguish between the left earbud and the right earbud when wearing the earphone 1000. However, when the user wears the earphone 1000, the earphone 1000 needs to identify whether the first earbud in the earphone 1000 is worn on the left ear or the right ear and/or the second earbud in the earphone 1000 is worn on the left ear or the right ear. In a possible implementation, the first earbud may identify, based on collected inertial data, whether the first earbud is worn on the left ear or the right ear, and the second earbud may also identify, based on collected inertial data, whether the second earbud is worn on the left ear or the right ear. In another possible implementation, an electronic device that establishes a communication connection to the earphone 1000 may alternatively determine whether the first earbud is worn on the left ear or the right ear and the second earbud is worn on the left ear or the right ear. Specifically, the first earbud may send collected inertial data to the electronic device, the electronic device may determine, based on the inertial data sent by the first earbud, whether the first earbud is worn on the left ear or the right ear, and then the electronic device sends a confirmation result to the first earbud. Similarly, the second earbud may also send collected inertial data to the electronic device, the electronic device may determine, based on the inertial data sent by the second earbud, whether the second earbud is worn on the left ear or the right ear, and then the electronic device sends a confirmation result to the second earbud.

The following embodiments of the present disclosure are described by using an example in which the first earbud identifies whether the first earbud is worn on the left ear or the right ear and the second earbud identifies whether the second earbud is worn on the left ear or the right ear.

After the first earbud identifies that the first earbud is worn on the left ear or the right ear and/or the second earbud identifies that the second earbud is worn on the left ear or the right ear, the first earbud may determine a wearing attribute of the earphone and/or the second earbud may determine a wearing attribute of the earphone, to switch between a left audio channel and a right audio channel, switch gesture control, identify battery levels of the left earbud and the right earbud, determine a primary mic, and the like based on the wearing attribute of the earphone.

The wearing attribute of the earphone is determined based on that the earphone is worn on the left ear or the right ear. The wearing attribute of the earphone may include a left earbud attribute and a right earbud attribute. The left earbud attribute indicates that the earphone is currently worn on the left ear of the user, and the right earbud attribute indicates that the earphone is currently worn on the right ear of the user. For example, when the first earbud identifies that the first earbud is worn on the left ear, a wearing attribute of the first earbud is the left earbud attribute; or when the first earbud identifies that the first earbud is worn on the right ear, a wearing attribute of the first earbud is the right earbud attribute. Similarly, when the second earbud identifies that the second earbud is worn on the left ear, a wearing attribute of the second earbud is the left earbud attribute; or when the second earbud identifies that the second earbud is worn on the right ear, a wearing attribute of the second earbud is the right earbud attribute. In some embodiments, before identifying whether the earphone is worn on the left ear or the right ear, the earphone needs to determine whether the earphone is in a worn state. When the earphone is in the worn state, it is determined whether the earphone is worn on the left ear or the right ear. When the earphone is in an unworn state, it is also unnecessary to determine whether the earphone is worn on the left ear or the right ear, so that power consumption of the earphone can be reduced.

In some embodiments, a first capacitive sensor is preset in the first earbud body 100. The first capacitive sensor is configured to implement a wearing detection function: identifying whether the user wears the earphone 1000.

In some embodiments, a second capacitive sensor is preset in the second earbud body 200. The second capacitive sensor is configured to implement a wearing detection function: identifying whether the user wears the earphone 1000.

The earphone may identify, via the first capacitive sensor or the second capacitive sensor, whether the user wears the earphone 1000.

In some embodiments, for people with different ear shapes and different wearing angles, a scenario in which the second earbud body 200 is not attached to an ear or the first earbud body 100 is not attached to an ear may occur. To improve accuracy of wearing identification, the earphone may identify, via the first capacitive sensor and the second capacitive sensor, whether the user wears the earphone 1000.

The following embodiments of the present disclosure are described by using an example in which the earphone identifies, via the first capacitive sensor and the second capacitive sensor, whether the user wears the earphone 1000.

When the user wears the earphone 1000, the capacitive sensor can be closely attached to the auricle of the user, and form a specific capacitance difference, to determine that the user is wearing the earphone 1000. When the user does not wear the earphone 1000, the capacitive sensor does not contact the auricle. In this case, the capacitance difference is stable, and it may be determined that the user does not wear the earphone 1000.

For example, wearing detection may include the following three scenarios.

(1) When the user correctly wears the earphone 1000, the first capacitive sensor and the second capacitive sensor can be closely attached to the auricle of the user, and the capacitive sensor in the earphone forms a specific capacitance value (the capacitance value is large). In addition, both the first capacitive sensor and the second capacitive sensor are close to the ear of the user, and a difference between a capacitance value generated by the first capacitive sensor and a capacitance value generated by the second capacitive sensor is small.

The earphone may detect the capacitance value of the first capacitive sensor and the capacitance value of the second capacitive sensor. That the user is wearing the earphone 1000 is determined based on a capacitance change value.

For example, when a first capacitance value detected by the first capacitive sensor is greater than a first preset value, and a second capacitance value detected by the second capacitive sensor is greater than a second preset value, it may be determined that the earphone is in the worn state.

In some embodiments, the earphone may obtain a capacitance change curve based on the capacitance value collected by the capacitive sensor, and the capacitance change curve indicates capacitance values collected by the capacitive sensor at different moments.

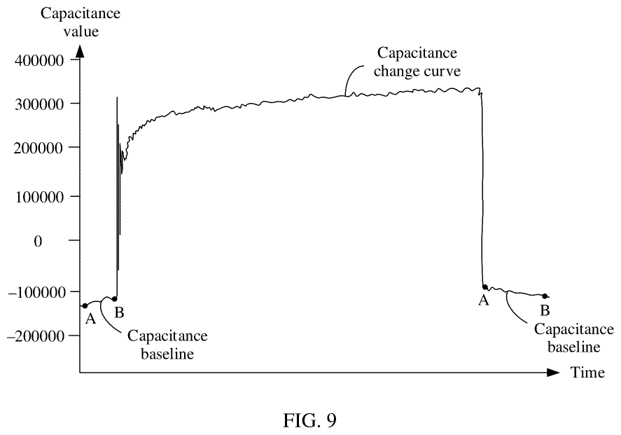

For example, FIG. 9 is an example of a diagram of the capacitance change curve.

It can be learned from FIG. 9 that, when the earphone is in the unworn state, a capacitance value collected by the capacitive sensor is low and is stable at a small value. For example, the capacitance value may be stable at about-110000. In some embodiments, a capacitance change curve between a moment A and a moment B may be used as a capacitance baseline, and the capacitance baseline indicates a capacitance value collected by the capacitive sensor when the earphone is in the unworn state.

When the user wears the earphone, a capacitance value collected by the capacitive sensor in the earphone increases sharply. For example, the capacitance value collected by the capacitive sensor increases suddenly and then is stable at a large value. For example, the capacitance value may be stable at about 260000.

When the user takes off the earphone again, a capacitance value collected by the capacitive sensor in the earphone decreases sharply and is stable at a small value. For example, the capacitance value may be stable at about −100000. In some embodiments, a capacitance change curve between a moment C and a moment D may be also used as the capacitance baseline.

Based on the foregoing analysis, the earphone may determine, based on the change of the capacitance value, whether the earphone is in the worn state or the unworn state.

In some embodiments, the capacitance value collected by the capacitive sensor is easily affected by a temperature, and different temperatures have different impact on the capacitance value collected by the capacitive sensor. To improve accuracy for identifying the wearing status, the earphone identifies, based on both the capacitance difference and temperature compensation, whether the earphone is in the worn state or the unworn state.

The temperature compensation may be understood as an error value of a capacitance value collected by the capacitive sensor at a different temperature. The earphone may determine a capacitance error value based on a current ambient temperature, and determine a target capacitance value based on the capacitance value collected by the capacitive sensor and the capacitance error value. If the target capacitance value is greater than a preset value, it may be determined that the earphone is in the worn state. If the target capacitance value is less than the preset value, it may be determined that the earphone is in the unworn state.

It should be noted that different ambient temperatures correspond to different capacitance error values.

For example, the earphone may detect the first capacitance value based on the first capacitive sensor, and then the earphone determines the capacitance error value based on the current ambient temperature. Finally, the earphone determines a first target capacitance value based on the first capacitance value and the capacitance error value. Similarly, the earphone may detect the second capacitance value based on the second capacitive sensor, and then the earphone determines the capacitance error value based on the current ambient temperature. Finally, the earphone determines a second target capacitance value based on the second capacitance value and the capacitance error value. When the first target capacitance value is greater than the first preset value, and the second target capacitance value is greater than the second preset value, it may be determined that the earphone is in the worn state.

In some embodiments, temperature compensation may be performed only on the capacitance value collected by the first capacitive sensor, and temperature compensation does not need to be performed on the capacitance value collected by the second capacitive sensor.

In another embodiment, temperature compensation may alternatively be performed only on the capacitance value collected by the second capacitive sensor, and temperature compensation does not need to be performed on the capacitance value collected by the first capacitive sensor.

(2) When the user does not wear the earphone 1000, and the first capacitive sensor and the second capacitive sensor do not contact each other, a capacitance value detected by the first capacitive sensor and a capacitance value detected by the second capacitive sensor are small, and a difference between the capacitance value generated by the first capacitive sensor and the capacitance value generated by the second capacitive sensor is small.

For example, when a first capacitance value detected by the first capacitive sensor is less than a first preset value, and a second capacitance value detected by the second capacitive sensor is less than a second preset value, it may be determined that the earphone is in the unworn state.

In some embodiments, the earphone may detect the first capacitance value based on the first capacitive sensor, and then the earphone determines a capacitance error value based on a current ambient temperature. Finally, the earphone determines a first target capacitance value based on the first capacitance value and the capacitance error value. Similarly, the earphone may detect the second capacitance value based on the second capacitive sensor, and then the earphone determines a capacitance error value based on a current ambient temperature. Finally, the earphone determines a second target capacitance value based on the second capacitance value and the capacitance error value. When the first target capacitance value is less than the first preset value, and the second target capacitance value is less than the second preset value, it may be determined that the earphone is in the unworn state.

(3) When the user picks up the earphone 1000 or another obstacle covers either of the first capacitive sensor and the second capacitive sensor, one of the first capacitive sensor and the second capacitive sensor is close to the obstacle, and the other is away from the obstacle. In this case, a difference between a capacitance value generated by the first capacitive sensor and a capacitance value generated by the second capacitive sensor is large.

It may be understood that, the earphone 1000 may determine, based on an absolute value between capacitance generated by the first capacitive sensor and capacitance generated by the second capacitive sensor, whether the earphone 1000 is in the scenario (1) or the scenario (2), and determine, based on a difference (that is, a relative value of the capacitance) between capacitance generated by the first capacitive sensor and capacitance generated by the second capacitive sensor, whether the earphone 1000 is in the scenario (3).

It may be understood that, compared with a solution in which only the first capacitive sensor or the second capacitive sensor is disposed, in the present disclosure, the first capacitive sensor is disposed on the first earbud body 100, and the second capacitive sensor is disposed on the second earbud body 200, so that a risk of misidentification can be reduced, and accuracy and reliability of wearing detection of the earphone 1000 can be improved.

In some embodiments, the first capacitive sensor may alternatively be disposed only on the first earbud body 100, or the second capacitive sensor may be disposed only on the second earbud body 200. This is not limited in the present disclosure.

Identify Whether the Earphone is Worn on the Left Ear or the Right Ear, and Determine, Based on that the Earphone is Worn on the Left Ear or the Right Ear, Whether to Reset the Wearing Attribute of the Earphone

After the earphone determines that the earphone is in the worn state, the earphone further needs to identify whether the earphone is worn on the left ear or the right ear, to determine whether the wearing attribute of the earphone needs to be reset, so as to perform operations such as switching between a left audio channel and a right audio channel, switching gesture control, identifying battery levels of the left earbud and the right earbud, determining a primary mic, and the like based on the wearing attribute of the earphone.

The user may wear the earphone in two steps: taking out the earphone and wearing the earphone.

I. The first earbud and the second earbud are taken out from the charging case 2000, the first earbud allocates a wearing attribute to the first earbud, and the second earbud allocates a wearing attribute to the second earbud.

1. Based on the foregoing description, the first earbud and the second earbud are placed in the charging case 2000, the first earbud resets the earbud attribute of the first earbud to the default attribute, and the second earbud also resets the earbud attribute of the second earbud to the default attribute.

The following embodiments of the present disclosure are described by using an example in which the first earbud is placed in the left compartment and the second earbud is placed in the right compartment.

In this case, when the first earbud and the second earbud are placed in the charging case 2000, the default attribute of the first earbud is the left earbud attribute, and the default attribute of the second earbud is the right earbud attribute.

2. After the user takes out the first earbud and the second earbud from the charging case 2000, before the user wears the first earbud and the second earbud on the ears, the wearing attribute of the first earbud is the same as the default attribute of the first earbud, and the wearing attribute of the second earbud is the same as the default attribute of the second earbud.

For example, the wearing attribute of the first earbud is the left earbud attribute, and the wearing attribute of the second earbud is the right earbud attribute.

3. After the user wears the first earbud and the second earbud on the ears respectively, if wearing time is short, when the first earbud has not identified whether the first earbud is worn on the left ear or the right ear and the second earbud has not identified whether the second earbud is worn on the left ear or the right ear, the wearing attribute of the first earbud is still the left earbud attribute, and the wearing attribute of the second earbud is still the right earbud attribute.

4. After the first earbud and the second earbud are worn on the ears respectively, if wearing time is long, the first earbud can identify whether the first earbud is worn on the left ear or the right ear and the second earbud can identify whether the second earbud is worn on the left ear or the right ear, and determine, based on that the first earbud is worn on the left ear or the right ear and the second earbud is worn on the left ear or the right ear, whether to change the wearing attribute of the first earbud and the wearing attribute of the second earbud.

In some embodiments, when the first earbud is worn on the left ear of the user for a long time, and the second earbud is worn on the right ear of the user for a long time, the wearing attribute of the first earbud is still the left earbud attribute, and the wearing attribute of the second earbud is still the right earbud attribute.

In some embodiments, when the first earbud is worn on the right ear of the user for a long time, and the second earbud is worn on the left ear of the user for a long time, the wearing attribute of the first earbud and the wearing attribute of the second earbud need to be changed. For example, the wearing attribute of the first earbud needs to be modified from the left earbud attribute to the right earbud attribute, and the wearing attribute of the first earbud needs to be modified from the right earbud attribute to the left earbud attribute.

The following describes how to identify whether the earphone is worn on the left ear or the right ear.

To determine the wearing attribute of the earphone, the earphone needs to identify whether the earphone is worn on the left ear or the right ear. Different body postures of the user when wearing the earphone affect the earphone 1000 to identify whether the earphone is worn on the left ear or the right ear.

I. When the user is standing or sitting, the earphone identifies whether the earphone is worn on the left ear or the right ear.

1. When the user is standing, the earphone identifies whether the earphone is worn on the left ear or the right ear.

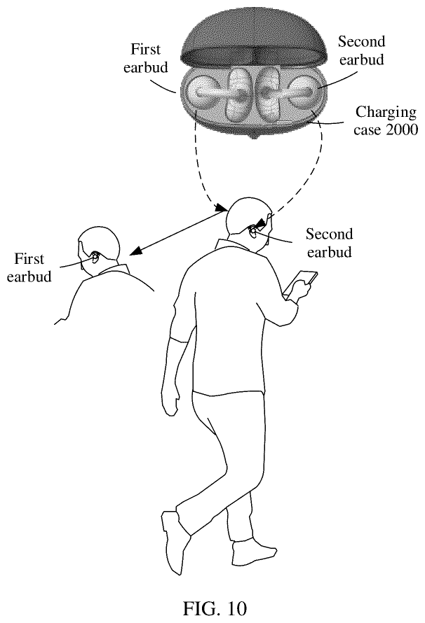

FIG. 10 and FIG. 11 are diagrams in which the user wears the earphone 1000 when standing.

As shown in FIG. 10, when the user is standing, the user wears the first earbud on the left ear (not shown in FIG. 10), and wears the second earbud on the right ear.

In the scenario shown in FIG. 10, if the wearing time is short, the wearing attribute of the first earbud is the left earbud attribute, and the wearing attribute of the second earbud is the right earbud attribute.

If the wearing time is long, the earphone 1000 can identify whether the first earbud is worn on the left ear or the right ear and the second earbud is worn on the left ear or the right ear. For example, the first earbud may determine that the first earbud is worn on the left ear of the user, and the second earbud may determine that the second earbud is worn on the right ear of the user. When the first earbud is worn on the left ear, the first earbud may determine that the wearing attribute of the first earbud is the left earbud attribute. When the first earbud is worn on the right ear, the second earbud may determine that the wearing attribute of the second earbud is the right earbud attribute.

As shown in FIG. 11, when the user is standing, the user wears the first earbud on the right ear, and wears the second earbud on the left ear (not shown in FIG. 11).

In the scenario shown in FIG. 11, if the wearing time is short, the earphone has not determined whether the earphone is worn on the left ear or the right ear, the wearing attribute of the first earbud is the left earbud attribute, and the wearing attribute of the second earbud is the right earbud attribute.

If the wearing time is long, the earphone 1000 can identify whether the first earbud is worn on the left ear or the right ear and the second earbud is worn on the left ear or the right ear. For example, the first earbud may determine that the first earbud is worn on the right ear of the user, and the second earbud may determine that the second earbud is worn on the left ear of the user. When the first earbud is worn on the right ear, the first earbud may determine that the wearing attribute of the first earbud is the right earbud attribute, and the first earbud may switch from the left earbud attribute to the right earbud attribute. When the first earbud is worn on the left ear, the second earbud may determine that the wearing attribute of the second earbud is the left earbud attribute, and the second earbud may switch from the right earbud attribute to the left earbud attribute.

The following describes how the earphone identifies whether the earphone is worn on the left ear or the right ear.

In some embodiments, an IMU sensor is preset in the second earbud body 200. The earphone may determine, based on a gravity acceleration collected by the IMU sensor, whether the earphone is worn on the left ear or the right ear.

In addition to the IMU sensor, whether the earphone is worn on the left ear or the right ear is alternatively determined based on a gravity acceleration collected by a separate ACC device. This is not limited in the present disclosure.

Optionally, the IMU sensor is not limited to the second earbud body 200, and the IMU sensor may alternatively be preset in the first earbud body 100 or the cantilever arm 300. This is not limited in the present disclosure either.

FIG. 12 is a diagram of gravity acceleration components on three axes when the first earbud is worn on the left ear.

As shown in FIG. 12, a geometric center of the first earbud body 100, a geometric center of the second earbud body 200, and a geometric center of the cantilever arm 300 determine a unique plane, that is, an O—O plane (shown by using a dashed line in FIG. 1). For ease of description, a connection line between the geometric center of the second earbud body 200 and the geometric center of the first earbud body 100 is defined as a Z axis, and a direction in which the geometric center of the second earbud body 200 points to the geometric center of the first earbud body 100 is defined as a positive direction of the Z axis. A straight line that passes through a geometric center of an end face on which the cantilever arm 300 is connected to the second earbud body 200 and that is perpendicular to the end face is defined as a Y axis, and a direction in which the geometric center of the end face points to the cantilever arm 300 is defined as a positive direction of the Y axis. A straight line perpendicular to both the Z axis and the Y axis is defined as an X axis. As shown in FIG. 2, a direction that is perpendicular to the Z axis and the Y axis and that points to the ground is a positive direction of the X axis.

A gravity acceleration G of a second earbud vertically points downward to the ground. Gravity acceleration components of the gravity acceleration G on the X axis, the Y axis, and the Z axis may be obtained based on the gravity acceleration G.

In some embodiments, whether the earphone is worn on the left ear or the right ear may be determined based on the acceleration component of the gravity acceleration G on the X axis.

As shown in FIG. 12, when the first earbud is worn on the left ear of the user, the acceleration component of the gravity acceleration G in the positive direction of the X axis is a positive value.

When the gravity acceleration G meets a preset condition, it may be determined that the second earbud is worn on the left ear of the user.

The preset condition may include but is not limited to one or more of the following: the acceleration component of the gravity acceleration G in the positive direction of the X axis is the positive value, the acceleration component of the gravity acceleration G on the Z axis is close to a minimum value, and the acceleration component of the gravity acceleration G on the Y axis is close to a minimum value.

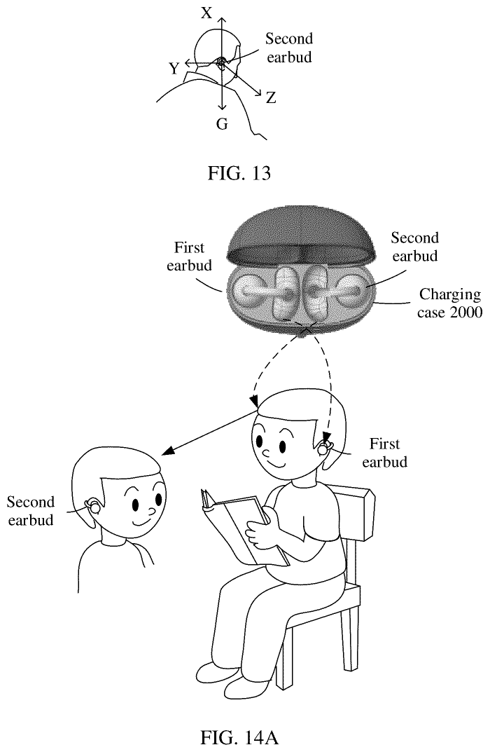

As shown in FIG. 13, when the second earbud is worn on the right ear of the user, an acceleration component of a gravity acceleration G in the positive direction of the X axis is a negative value.

When the gravity acceleration G meets a preset condition, it may be determined that the second earbud is worn on the right ear of the user.

The preset condition may include but is not limited to one or more of the following: the acceleration component of the gravity acceleration G in the positive direction of the X axis is the negative value, an acceleration component of the gravity acceleration G on the Z axis is close to a minimum value, and an acceleration component of the gravity acceleration G on the Y axis is close to a minimum value.

When the two earbuds 1000 in the earphone 1000 are in the worn state, it may be determined, based on the acceleration component of the gravity acceleration G in the first earbud in the positive direction of the X axis and the acceleration component of the gravity acceleration G in the second earbud in the positive direction of the X axis, whether the first earbud is worn on the left ear or the right ear and the second earbud is worn on the left ear or the right ear.

For example, when the acceleration component of the gravity acceleration G in the first earbud in the positive direction of the X axis is the positive value, and the acceleration component of the gravity acceleration G in the second earbud in the positive direction of the X axis is the negative value, it may be determined that the first earbud is worn on the left ear of the user, and the second earbud is worn on the right ear of the user.

For another example, when the acceleration component of the gravity acceleration G in the first earbud in the positive direction of the X axis is a negative value, and the acceleration component of the gravity acceleration G in the second earbud in the positive direction of the X axis is a positive value, it may be determined that the first earbud is worn on the right ear of the user, and the second earbud is worn on the left ear of the user.

It should be noted that, whether the earphone is worn on the left ear or the right ear is not limited to being determined based on the acceleration component of the gravity acceleration G in the positive direction of the X axis, and whether the earphone is worn on the left ear or the right ear when the user wears the earphone 1000 when standing may alternatively be determined in another manner. This is not limited in the present disclosure.

In some embodiments, only when both the first earbud and the second earbud are in the worn state, the earphone identifies whether the earphone is worn on the left ear or the right ear, and determines the wearing attribute based on wearing. The wearing attribute of the earphone may be the same as or different from the default attribute of the earphone.

In another embodiment, when only one of the first earbud or the second earbud is in the worn state, if the earphone does not identify whether the earphone is worn on the left ear or the right ear, the wearing attribute of the earphone is consistent with the default attribute of the earphone.

2. When the user is sitting, the earphone identifies whether the earphone is worn on the left ear or the right ear.

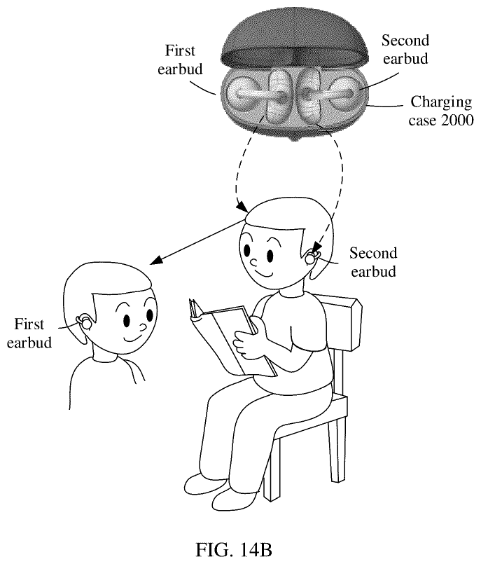

FIG. 14A and FIG. 14B are diagrams in which the user wears the earphone 1000 when sitting.

As shown in FIG. 14A, when the user is sitting, the user wears the first earbud on the left ear, and wears the second earbud on the right ear (not shown in FIG. 14A).

In the scenario shown in FIG. 14A, if the wearing time is short, the wearing attribute of the first earbud is the left earbud attribute, and the wearing attribute of the second earbud is the right earbud attribute.

If the wearing time is long, the earphone 1000 can identify whether the first earbud is worn on the left ear or the right ear and the second earbud is worn on the left ear or the right ear. For example, the first earbud may determine that the first earbud is worn on the left ear of the user, and the second earbud may determine that the second earbud is worn on the right ear of the user. When the first earbud is worn on the left ear, the first earbud may determine that the wearing attribute of the first earbud is the left earbud attribute. When the first earbud is worn on the right ear, the second earbud may determine that the wearing attribute of the second earbud is the right earbud attribute.

As shown in FIG. 14B, when the user is standing, the user wears the first earbud on the right ear (not shown in FIG. 14B), and wears the second earbud on the left ear.

In the scenario shown in FIG. 14B, if the wearing time is short, the earphone has not determined whether the earphone is worn on the left ear or the right ear, the wearing attribute of the first earbud is the left earbud attribute, and the wearing attribute of the second earbud is the right earbud attribute.

If the wearing time is long, the earphone 1000 can identify whether the first earbud is worn on the left ear or the right ear and the second earbud is worn on the left ear or the right ear. For example, the first earbud may determine that the first earbud is worn on the right ear of the user, and the second earbud may determine that the second earbud is worn on the left ear of the user. When the first earbud is worn on the right ear, the first earbud may determine that the wearing attribute of the first earbud is the right earbud attribute, and the first earbud may switch from the left earbud attribute to the right earbud attribute. When the first earbud is worn on the left ear, the second earbud may determine that the wearing attribute of the second earbud is the left earbud attribute, and the second earbud may switch from the right earbud attribute to the left earbud attribute.

A method for identifying whether the earphone is worn on the left ear or the right ear when the user is sitting is the same as the method for identifying whether the earphone is worn on the left ear or the right ear when the user is standing. For details, refer to the description in which the earphone identifies whether the earphone is worn on the left ear or the right ear when the user is standing. Details are not described herein again in the present disclosure.

II. When the user is lying, the earphone identifies whether the earphone is worn on the left ear or the right ear.

Lying postures of the user may be further classified into a flat lying posture and a side lying posture. For different lying postures, the earphone 1000 identifies whether the earphone is worn on the left ear or the right ear in different manners.

1. When the user is flat lying, the earphone identifies whether the earphone is worn on the left ear or the right ear.

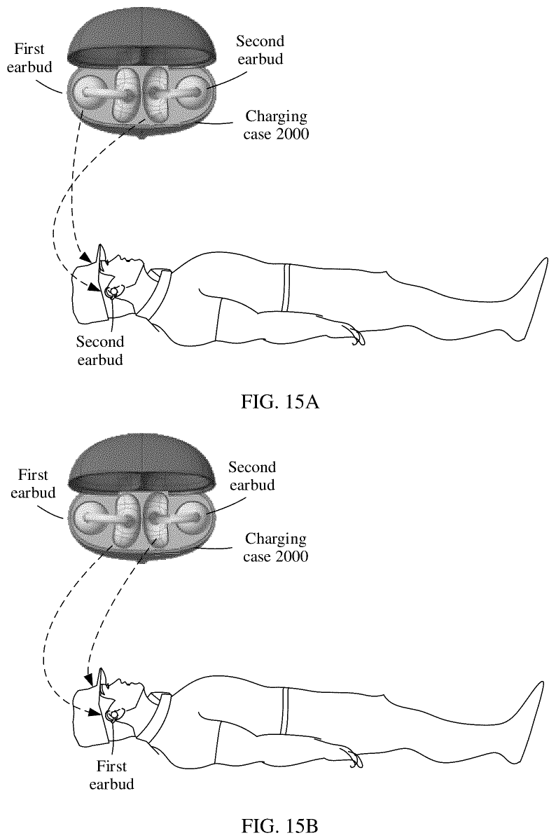

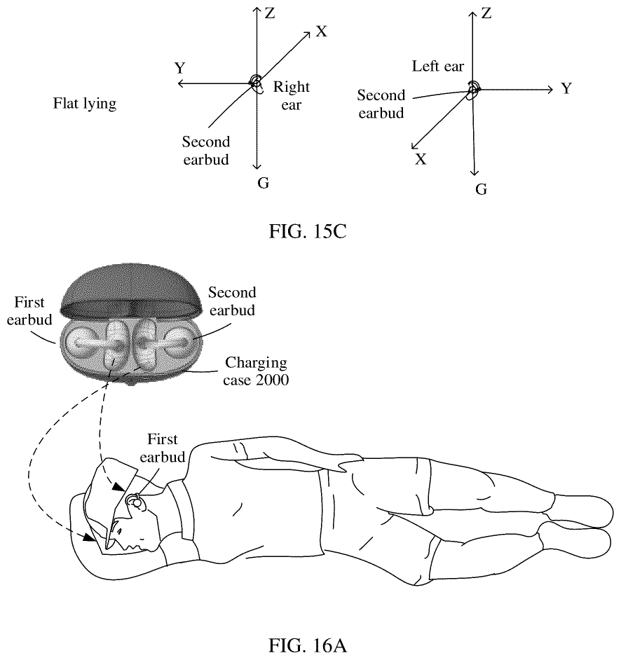

FIG. 15A and FIG. 15B are diagrams in which the user wears the earphone 1000 when flat lying.

As shown in FIG. 15A, when the user is flat lying, the user wears the first earbud on the left ear (not shown in FIG. 15A), and wears the second earbud on the right ear.

As shown in FIG. 15B, when the user is flat lying, the user wears the first earbud on the right ear, and wears the second earbud on the left ear (not shown in FIG. 15B).

In some embodiments, an IMU sensor is preset in the second earbud body 200. The earphone may determine, based on a gravity acceleration collected by the IMU sensor, whether the earphone is worn on the left ear or the right ear.

A diagram of components of a gravity acceleration on coordinate axes shown in FIG. 15C may be obtained by using a chin-to-vertex projection shown in FIG. 15A. FIG. 15C is a diagram of gravity accelerations G when the user wears the first earbud and the second earbud when flat lying.

It can be learned from FIG. 15C that, when the user is flat lying, the acceleration components of the gravity accelerations G on the Y axis are close to 0, the acceleration components of the gravity accelerations G on the X axis are close to minimum values, and both the acceleration components of the gravity accelerations G on the Z axis are negative values.

When the gravity acceleration G meets a preset condition, it may be determined that the user is flat lying, and whether the earphone is worn on the left ear or the right ear is not distinguished.

The preset condition may include but is not limited to one or more of the following: the acceleration components of the gravity accelerations G on the Y axis are close to minimum values, the acceleration components of the gravity accelerations G on the X axis are close to the minimum values, and the acceleration components of the gravity accelerations G on the Z axis are the negative values.

For example, when the two earbuds 1000 in the earphone 1000 are in the worn state, when the acceleration component of the gravity acceleration G in the first earbud on the Z axis is the negative value, and the acceleration component of gravity acceleration G in the second earbud on the Z axis is the negative value, it may be determined that the user is in the flat lying posture, and there is no need to distinguish whether the first earbud is worn on the left ear or the right ear and the second earbud is worn on the left ear or the right ear. The wearing attribute of the first earbud is the same as the default attribute of the first earbud, and the wearing attribute of the second earbud is the same as the default attribute of the second earbud.

For another example, when the two earbuds 1000 in the earphone 1000 are in the worn state, when the acceleration component of the gravity acceleration G in the first earbud on the Y axis is close to the minimum value, the acceleration component of the gravity acceleration G in the first earbud on the X axis is close to the minimum value, the acceleration component of the gravity acceleration G in the first earbud on the Z axis is the negative value, the acceleration component of the gravity acceleration G in the second earbud on the Y axis is close to the minimum value, the acceleration component of the gravity acceleration G in the second earbud on the X axis is close to the minimum value, and the acceleration component of the gravity acceleration G in the second earbud on the Z axis is the negative value, it may be determined that the user is in the flat lying posture, and there is no need to distinguish whether the first earbud is worn on the left ear or the right ear and the second earbud is worn on the left ear or the right ear. The wearing attribute of the first earbud is the same as the default attribute of the first earbud, and the wearing attribute of the second earbud is the same as the default attribute of the second earbud.

In some embodiments, when both the first earbud and the second earbud are in the worn state, and the user is in the flat lying posture, the earphone does not need to identify whether the earphone is worn on the left ear or the right ear, and the wearing attribute of the earphone may be the same as the default attribute of the earphone.

In another embodiment, when only one of the first earbud or the second earbud is in the worn state, if the earphone does not identify whether the earphone is worn on the left ear or the right ear, the wearing attribute of the earphone is consistent with the default attribute of the earphone.

It should be noted that, the flat lying posture of the user when the user wears the earphone 1000 may alternatively be determined in another manner. This is not limited in the present disclosure.

2. When the user is side lying, the earphone identifies whether the earphone is worn on the left ear or the right ear.

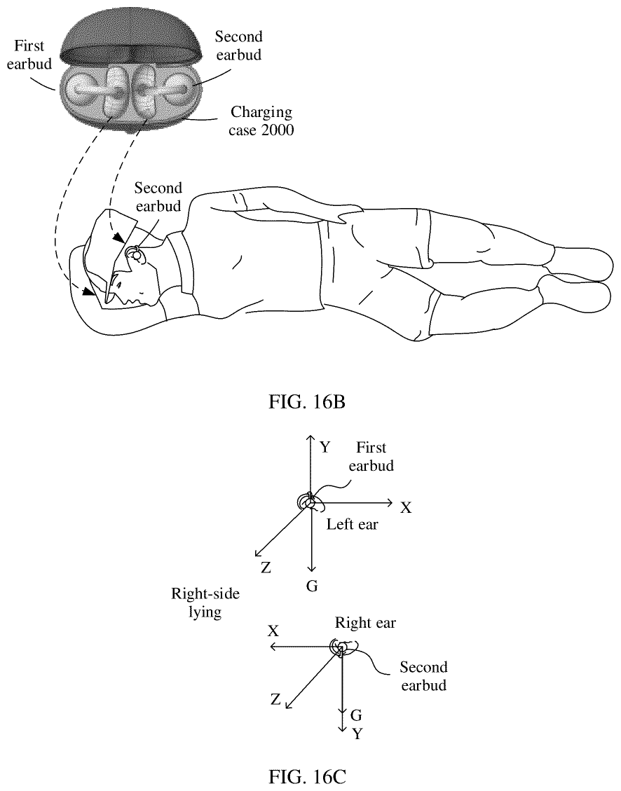

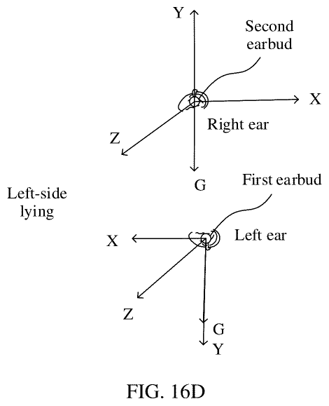

FIG. 16A and FIG. 16B are diagrams in which the user wears the earphone during right-side lying.

As shown in FIG. 16A, when the user is in a right-side lying posture, the user wears the first earbud on the left ear, and wears the second earbud on the right ear (not shown in FIG. 16A).

In the scenario shown in FIG. 16A, if the wearing time is short, the wearing attribute of the first earbud is the left earbud attribute, and the wearing attribute of the second earbud is the right earbud attribute.

If the wearing time is long, the earphone 1000 can identify whether the first earbud is worn on the left ear or the right ear and the second earbud is worn on the left ear or the right ear. For example, the first earbud may determine that the first earbud is worn on the left ear of the user, and the second earbud may determine that the second earbud is worn on the right ear of the user. When the first earbud is worn on the left ear, the first earbud may determine that the wearing attribute of the first earbud is the left earbud attribute. When the first earbud is worn on the right ear, the second earbud may determine that the wearing attribute of the second earbud is the right earbud attribute.

As shown in FIG. 16B, when the user is in a right-side lying posture, the user wears the first earbud on the right ear (not shown in FIG. 16B), and wears the second earbud on the left ear.

In the scenario shown in FIG. 16B, if the wearing time is short, the earphone has not determined whether the earphone is worn on the left ear or the right ear, the wearing attribute of the first earbud is the left earbud attribute, and the wearing attribute of the second earbud is the right earbud attribute.

If the wearing time is long, the earphone 1000 can identify whether the first earbud is worn on the left ear or the right ear and the second earbud is worn on the left ear or the right ear. For example, the first earbud may determine that the first earbud is worn on the right ear of the user, and the second earbud may determine that the second earbud is worn on the left ear of the user. When the first earbud is worn on the right ear, the first earbud may determine that the wearing attribute of the first earbud is the right earbud attribute, and the first earbud may switch from the left earbud attribute to the right earbud attribute. When the first earbud is worn on the left ear, the second earbud may determine that the wearing attribute of the second earbud is the left earbud attribute, and the second earbud may switch from the right earbud attribute to the left earbud attribute.

In some embodiments, side lying postures may be further classified into a left-side lying posture and a right-side lying posture. FIG. 16A and FIG. 16B are diagrams in which the user wears the earphone 1000 during right-side lying. The figure does not show a diagram in which the user wears the earphone 1000 during left-side lying.

The following describes how the earphone identifies whether the earphone is worn on the left ear or the right ear.

(1) When the user wears the earphone 1000 during right-side lying, the earphone identifies whether the earphone is worn on the left ear or the right ear.

In some embodiments, whether the earphone is worn on the left ear or the right ear may be determined based on the acceleration component of the gravity acceleration G on the Y axis.

A diagram of components of a gravity acceleration on coordinate axes shown in FIG. 16C may be obtained by using a user's chin-to-vertex projection shown in FIG. 16A.

As shown in FIG. 16C, when the first earbud is worn on the left ear of the user, the acceleration component of the gravity acceleration G in the positive direction of the Y axis is a negative value.

When the gravity acceleration G meets a preset condition, it may be determined that the first earbud is worn on the left ear of the user.

The preset condition may include but is not limited to one or more of the following: the gravity acceleration component of the gravity acceleration G in the positive direction of the Y axis is the negative value, the gravity acceleration component of the gravity acceleration G on the X axis is a minimum value, and the gravity acceleration component of the gravity acceleration G on the Z axis is a minimum value.

As shown in FIG. 16C again, when the second earbud is worn on the right ear of the user, the acceleration component of the gravity acceleration G in the positive direction of the Y axis is a positive value.

When the gravity acceleration G meets a preset condition, it may be determined that the second earbud is worn on the right ear of the user.

The preset condition may include but is not limited to one or more of the following: the acceleration component of the gravity acceleration G in the positive direction of the Y axis is the positive value, a gravity acceleration component of the gravity acceleration G on the X axis is a minimum value, and a gravity acceleration component of the gravity acceleration G on the Z axis is a minimum value.

When the two earbuds 1000 in the earphone 1000 are in the worn state, it may be determined, based on the acceleration component of the gravity acceleration G in the first earbud in the positive direction of the Y axis and the acceleration component of the gravity acceleration G in the second earbud in the positive direction of the Y axis, whether the first earbud is worn on the left ear or the right ear and the second earbud is worn on the left ear or the right ear.

For example, when the acceleration component of the gravity acceleration G in the first earbud in the positive direction of the Y axis is the negative value, and the acceleration component of the gravity acceleration G in the second earbud in the positive direction of the Y axis is the positive value, it may be determined that the first earbud is worn on the left ear of the user, and the second earbud is worn on the right ear of the user.

For another example, when the acceleration component of the gravity acceleration G in the first earbud in the positive direction of the Y axis is a positive value, the gravity acceleration component of the gravity acceleration G in the first earbud on the X axis is the minimum value, the gravity acceleration component of the gravity acceleration G in the first earbud on the Z axis is the minimum value, the acceleration component of the gravity acceleration G in the second earbud in the positive direction of the Y axis is a negative value, the gravity acceleration component of the gravity acceleration G in the second earbud on the X axis is the minimum value, and the gravity acceleration component of the gravity acceleration G in the second earbud on the Z axis is the minimum value, it may be determined that the first earbud is worn on the right ear of the user, and the second earbud is worn on the left ear of the user.

It should be noted that, whether the earphone is worn on the left ear or the right ear is not limited to being determined based on the acceleration component of the gravity acceleration G in the positive direction of the Y axis, and whether the earphone is worn on the left ear or the right ear when the user wears the earphone 1000 during right-side lying may alternatively be determined in another manner. This is not limited in the present disclosure.

(2) When the user wears the earphone 1000 during left-side lying, the earphone identifies whether the earphone is worn on the left ear or the right ear.

In some embodiments, whether the earphone is worn on the left ear or the right ear may be determined based on the acceleration component of the gravity acceleration G in the positive direction of the Y axis.

A diagram of components of a gravity acceleration on coordinate axes when the user is left-side lying shown in FIG. 16D may be obtained by using a user's chin-to-vertex projection when the user is left-side lying.

As shown in FIG. 16D, when the first earbud is worn on the left ear of the user, the acceleration component of the gravity acceleration G in the positive direction of the Y axis is a positive value.

When the gravity acceleration G meets a preset condition, it may be determined that the first earbud is worn on the left ear of the user.

The preset condition may include but is not limited to one or more of the following: the acceleration component of the gravity acceleration G in the positive direction of the Y axis is the positive value, the gravity acceleration component of the gravity acceleration G on the X axis is a minimum value, and the gravity acceleration component of the gravity acceleration G on the Z axis is a minimum value.

As shown in FIG. 16D, when the second earbud is worn on the right ear of the user, the acceleration component of the gravity acceleration G in the positive direction of the Y axis is a negative value.

When the gravity acceleration G meets a preset condition, it may be determined that the second earbud is worn on the right ear of the user.

The preset condition may include but is not limited to one or more of the following: the acceleration component of the gravity acceleration G in the positive direction of the Y axis is the negative value, a gravity acceleration component of the gravity acceleration G on the X axis is a minimum value, and a gravity acceleration component of the gravity acceleration G on the Z axis is a minimum value.

When the two earbuds 1000 in the earphone 1000 are in the worn state, it may be determined, based on the acceleration component of the gravity acceleration G in the first earbud in the positive direction of the Y axis and the acceleration component of the gravity acceleration G in the second earbud in the positive direction of the Y axis, whether the first earbud is worn on the left ear or the right ear and the second earbud is worn on the left ear or the right ear.

For example, when the acceleration component of the gravity acceleration G in the first earbud in the positive direction of the Y axis is the positive value, and the acceleration component of the gravity acceleration G in the second earbud in the positive direction of the Y axis is the negative value, it may be determined that the first earbud is worn on the left ear of the user, and the second earbud is worn on the right ear of the user.

For another example, when the acceleration component of the gravity acceleration G in the first earbud in the positive direction of the Y axis is a negative value, the gravity acceleration component of the gravity acceleration G in the first earbud on the X axis is the minimum value, the gravity acceleration component of the gravity acceleration G in the first earbud on the Z axis is the minimum value, the acceleration component of the gravity acceleration G in the second earbud in the positive direction of the Y axis is a positive value, the gravity acceleration component of the gravity acceleration G in the second earbud on the X axis is the minimum value, and the gravity acceleration component of the gravity acceleration G in the second earbud on the Z axis is the minimum value, it may be determined that the first earbud is worn on the right ear of the user, and the second earbud is worn on the left ear of the user.

It should be noted that, whether the earphone is worn on the left ear or the right ear is not limited to being determined based on the acceleration component of the gravity acceleration G in the positive direction of the Y axis, and whether the earphone is worn on the left ear or the right ear when the user wears the earphone 1000 during left-side lying may alternatively be determined in another manner. This is not limited in the present disclosure.

In some embodiments, when both the first earbud and the second earbud are in the worn state, and the user is in the side lying posture (for example, the left-side lying posture and the right-side lying posture), the earphone does not need to identify whether the earphone is worn on the left ear or the right ear, and the wearing attribute of the earphone may be the same as the default attribute of the earphone.

In another embodiment, when only one of the first earbud or the second earbud is in the worn state, if the earphone does not identify whether the earphone is worn on the left ear or the right ear, the wearing attribute of the earphone is consistent with the default attribute of the earphone.

### Perform an Earphone Control Operation Based on the Wearing Attribute of the Earphone

After the earphone identifies that the earphone is worn on the left ear or the right ear, and determines the wearing attribute of the earphone, the first earbud may perform, based on the wearing attribute of the first earbud and/or the second earbud may perform, based on the wearing attribute of the second earbud, but are not limited to the following control operations: switching between a left audio channel and a right audio channel, switching gesture control, identifying battery levels of the left earbud and the right earbud, determining a primary mic, and the like.

### I. Determine a Left Audio Channel and a Right Audio Channel Based on the Wearing Attribute

Switching between the left audio channel and the right audio channel means that the electronic device sends audio data of a corresponding audio channel to an earphone with a corresponding wearing attribute.

For example, the electronic device needs to send a left channel audio to an earphone with a left wearing attribute, and play the left channel audio via the earphone with the left wearing attribute. The electronic device establishes a communication connection (for example, a Bluetooth connection) to the earphone 1000. The electronic device needs to send a right channel audio to an earphone with a right wearing attribute, and play the right channel audio via the earphone with the right wearing attribute.

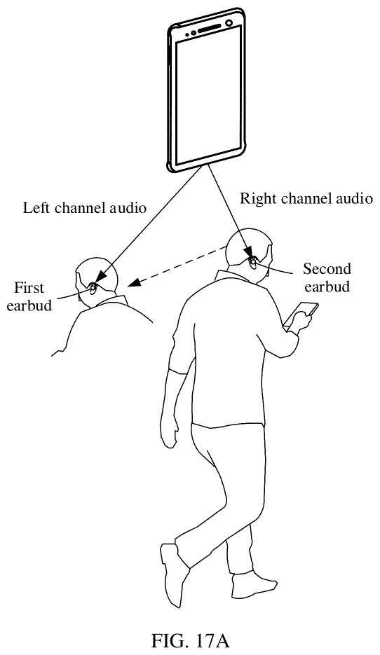

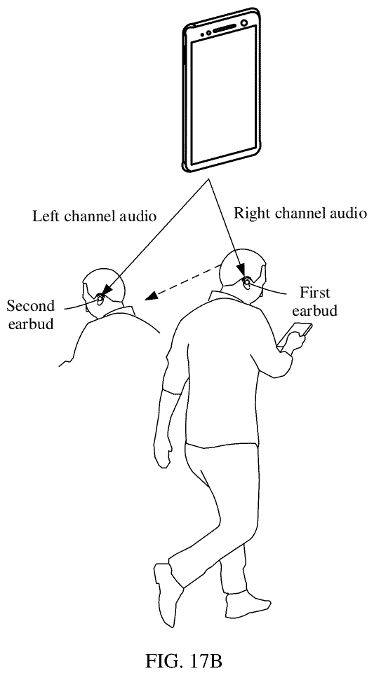

For example, as shown in FIG. 17A, if the user wears the first earbud on the left ear, and wears the second earbud on the right ear. The wearing attribute of the first earbud is the left-ear attribute, and the wearing attribute of the second earbud is the right-ear attribute.

The earphone 1000 then sends the wearing attribute of the first earbud and the wearing attribute of the second earbud to the electronic device, and the electronic device may send audio data of corresponding channels to the first earbud and the second earbud based on the wearing attribute of the first earbud and the wearing attribute of the second earbud.

As shown in FIG. 17A, the electronic device establishes a communication connection to the earphone 1000. After the electronic device receives the wearing attribute of the first earbud and the wearing attribute of the second earbud that are sent by the earphone 1000, the electronic device may send a left channel audio to the first earbud based on the left-ear attribute, and send a right channel audio to the second earbud based on the right-ear attribute. The first earbud may play the left channel audio, and the second earbud may play the right channel audio.

In some embodiments, after the earphone 1000 is taken out from the charging case 2000, if the user wears the first earbud on the right ear and wears the second earbud on the left ear, or in a process in which the user wears the earphone, the user changes a wearing position of the earphone, for example, the user takes off the first earbud from the left ear and wears the first earbud on the right ear, and takes off the second earbud from the right ear and wears the second earbud on the left ear. In this case, the wearing attribute of the first earbud is the right-ear attribute, and the wearing attribute of the second earbud is the left-ear attribute.

The earphone 1000 then sends the wearing attribute of the first earbud and the wearing attribute of the second earbud to the electronic device, and the electronic device may send the audio data of the corresponding channels to the first earbud and the second earbud based on the wearing attribute of the first earbud and the wearing attribute of the second earbud.

As shown in FIG. 17B, the electronic device establishes a communication connection to the earphone 1000. After the electronic device receives the wearing attribute of the first earbud and the wearing attribute of the second earbud that are sent by the earphone 1000, the electronic device may send a left channel audio to the second earbud based on the left-ear attribute, and send a right channel audio to the first earbud based on the right-ear attribute. The second earbud may play the left channel audio, and the first earbud may play the right channel audio.

In some embodiments, if the earphone 1000 is taken out from the charging case 2000, the first earbud and the second earbud may be respectively worn on ears of two users.

In a possible implementation, the first earbud may be worn on a left ear of a first user, and the second earbud may be worn on a right ear of a second user. The wearing attribute of the first earbud is the left-ear attribute, and the wearing attribute of the second earbud is the right-ear attribute. In this case, for how the electronic device sends the audio data to the earphone 1000, refer to the description in the embodiment in FIG. 17A. Details are not described herein again in the present disclosure.

In a possible implementation, the first earbud may be worn on a right ear of a first user, and the second earbud may be worn on a left ear of a second user. The wearing attribute of the first earbud is the right-ear attribute, and the wearing attribute of the second earbud is the left-ear attribute. In this case, for how the electronic device sends the audio data to the earphone 1000, refer to the description in the embodiment in FIG. 17B. Details are not described herein again in the present disclosure.

In a possible implementation, the first earbud may be worn on a right ear of a first user, and the second earbud may be also worn on a right ear of a second user. In this case, the wearing attribute of the first earbud is the right-ear attribute, and the wearing attribute of the second earbud is also the right-ear attribute.

The earphone 1000 then sends the wearing attribute of the first earbud and the wearing attribute of the second earbud to the electronic device, and the electronic device may send the audio data of the corresponding channels to the first earbud and the second earbud based on the wearing attribute of the first earbud and the wearing attribute of the second earbud.

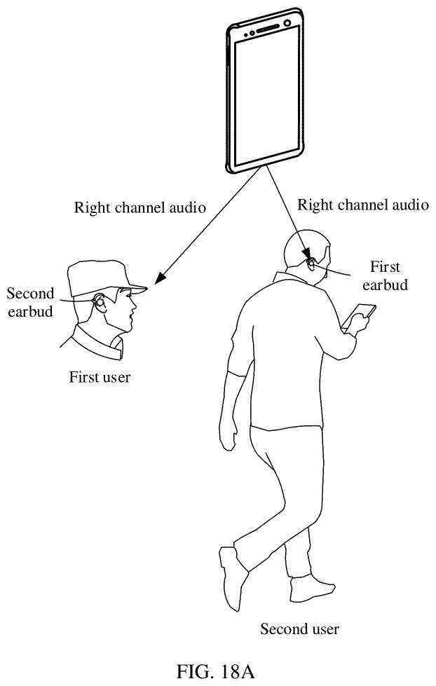

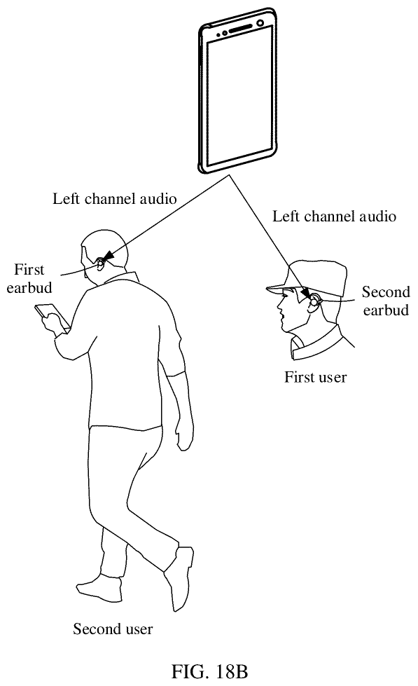

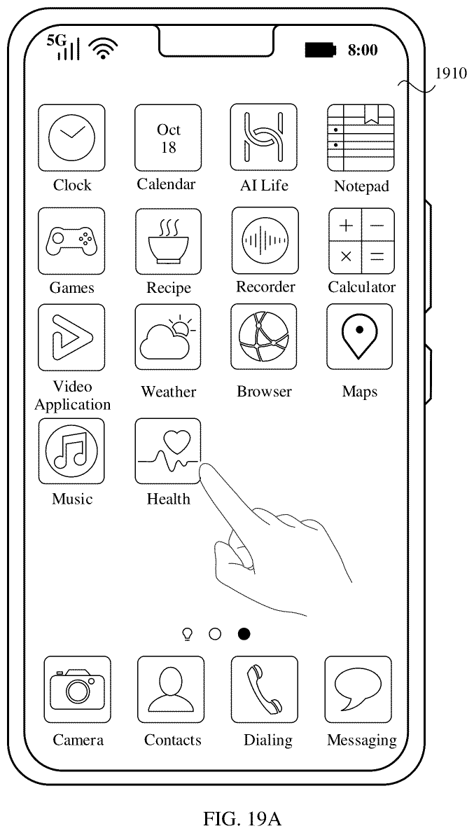

As shown in FIG. 18A, the electronic device establishes a communication connection to the earphone 1000. After the electronic device receives the wearing attribute of the first earbud and the wearing attribute of the second earbud that are sent by the earphone 1000, the electronic device may send a right channel audio to the first earbud based on the right-ear attribute, and send a right channel audio to the second earbud based on the right-ear attribute. The first earbud may play the right channel audio, and the second earbud may also play the right channel audio.

In another possible implementation, when both the first earbud and the second earbud have the right-ear attribute, the electronic device may synthesize the left channel audio and the right channel audio into a mixed channel audio, send the mixed channel audio to the first earbud, and send the mixed channel audio to the second earbud. The first earbud may play the mixed channel audio, and the second earbud may also play the mixed channel audio.

In a possible implementation, the first earbud may be worn on the left ear of the first user, and the second earbud may be also worn on the left ear of the second user. In this case, the wearing attribute of the first earbud is the left-ear attribute, and the wearing attribute of the second earbud is also the left-ear attribute.

The earphone 1000 then sends the wearing attribute of the first earbud and the wearing attribute of the second earbud to the electronic device, and the electronic device may send the audio data of the corresponding channels to the first earbud and the second earbud based on the wearing attribute of the first earbud and the wearing attribute of the second earbud.

As shown in FIG. 18B, the electronic device establishes a communication connection to the earphone 1000. After the electronic device receives the wearing attribute of the first earbud and the wearing attribute of the second earbud that are sent by the earphone 1000, the electronic device may send a left channel audio to the first earbud based on the left-ear attribute, and send a left channel audio to the second earbud based on the left-ear attribute. The first earbud may play the left channel audio, and the second earbud may also play the left channel audio.

In another possible implementation, when both the first earbud and the second earbud have the left-ear attribute, the electronic device may synthesize the left channel audio and the right channel audio into a mixed channel audio, send the mixed channel audio to the first earbud, and send the mixed channel audio to the second earbud. The first earbud may play the mixed channel audio, and the second earbud may also play the mixed channel audio.

### II. Based on the Wearing Attribute, Determine an Earphone Touch-Control Gesture and Display Battery Levels of the Left Earbud and the Right Earbud

In some embodiments, in a Health application of the electronic device, the user may view and set the earphone touch-control gesture and view the battery levels of the left earbud and the right earbud.

In addition to the Health application, in another application, the user may further view and set the earphone touch-control gesture and view the battery levels of the left earbud and the right earbud. In the present disclosure, the Health application is merely used as an example for description, but should not be construed as a limitation.

For example, in an AI life application, the user may further view and set the earphone touch-control gesture and view the battery levels of the left earbud and the right earbud.

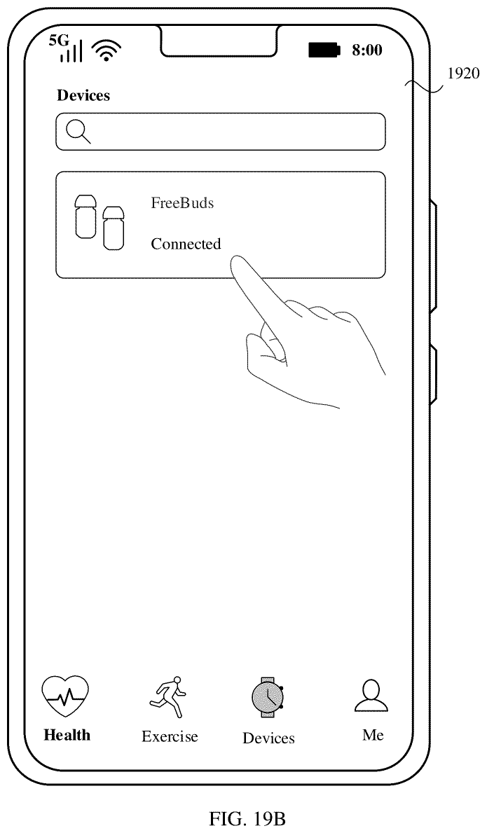

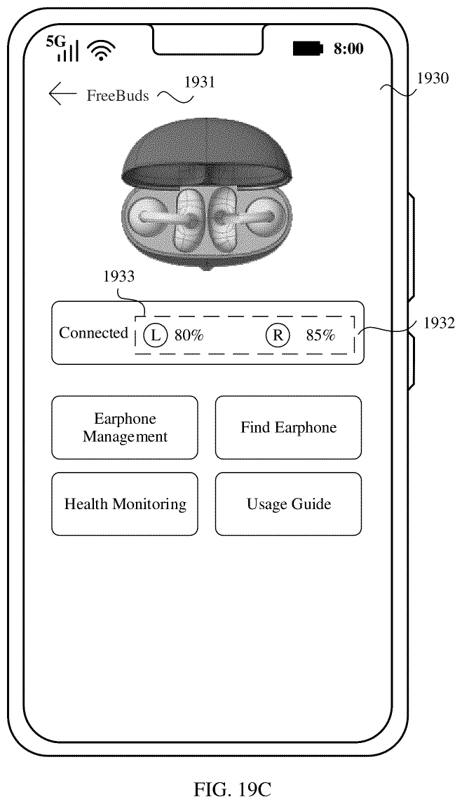

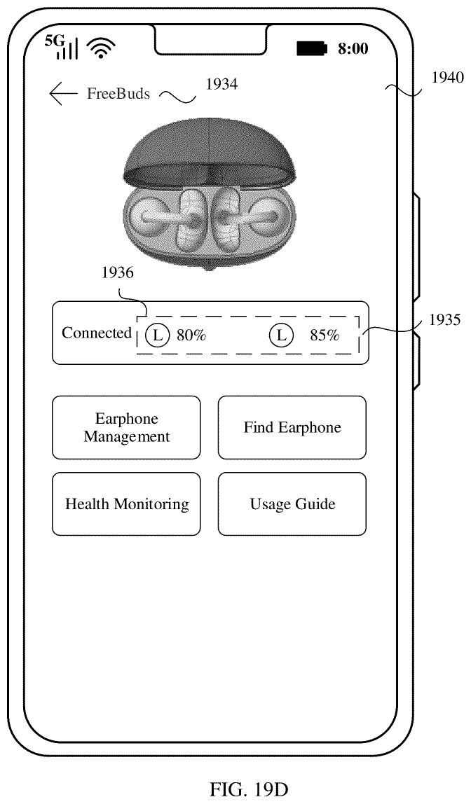

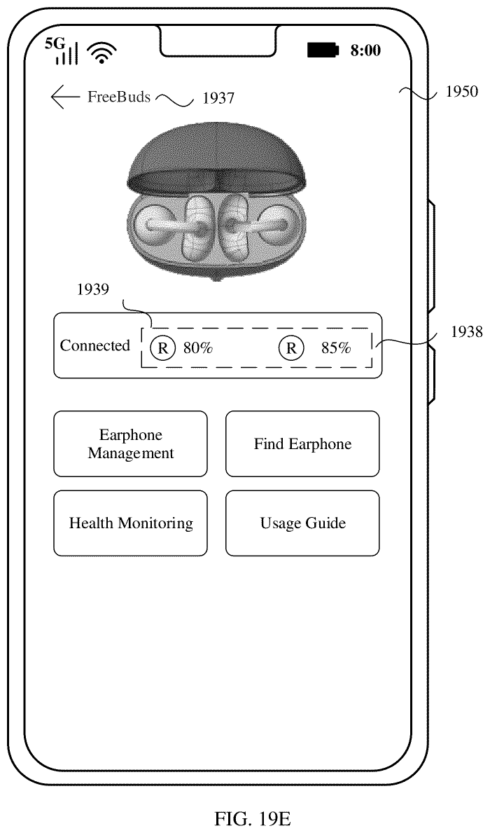

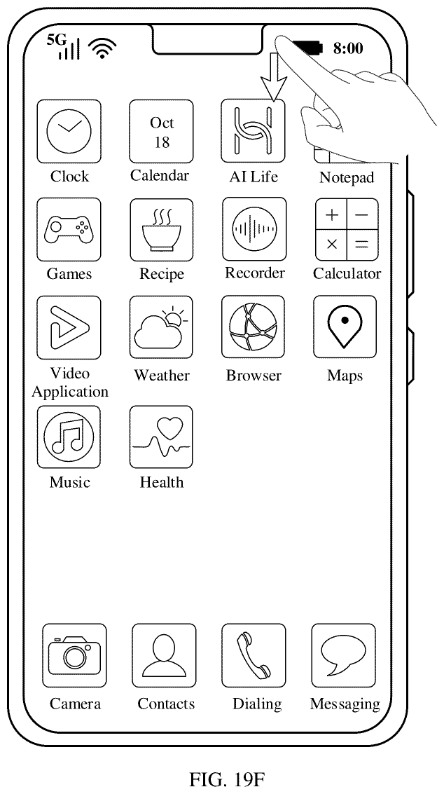

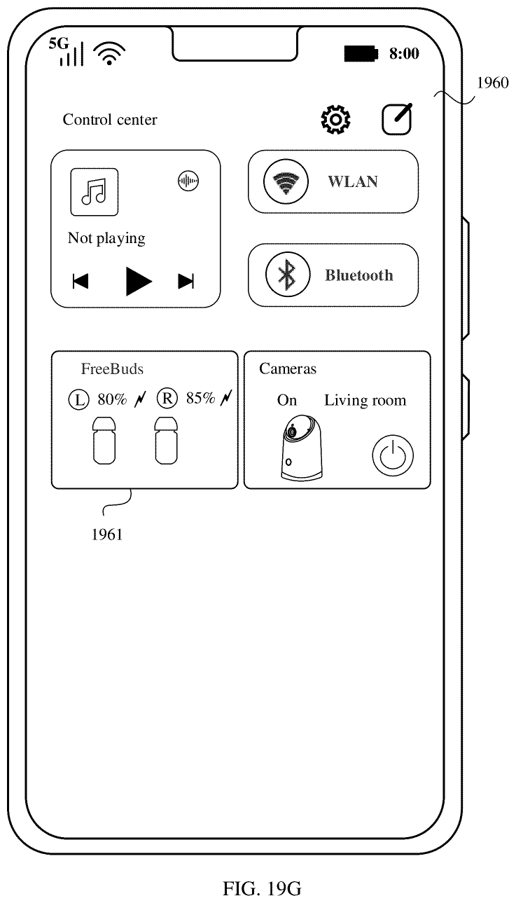

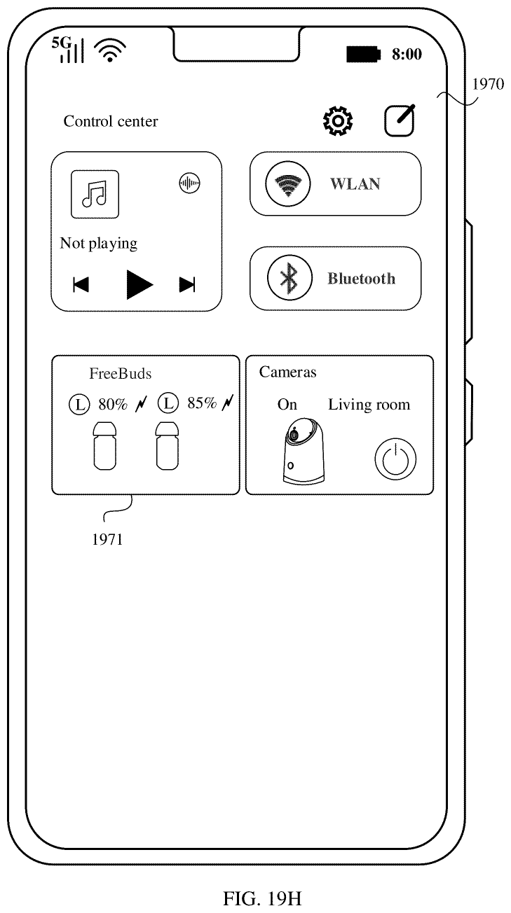

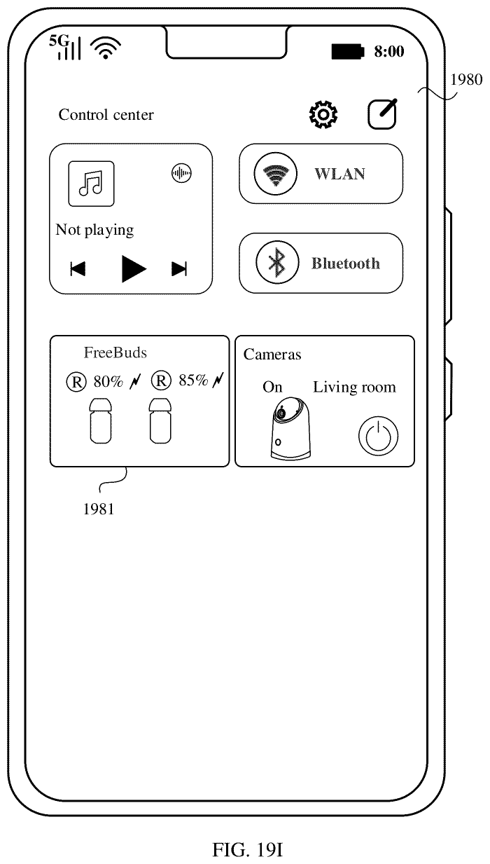

FIG. 19A to FIG. 19I are diagrams in which the user views and sets the earphone touch-control gesture and views the battery levels of the left earbud and the right earbud in the Health application of the electronic device.

In some embodiments, after the electronic device is paired with the earphone 1000 and establishes a communication connection (for example, a Bluetooth connection) to the earphone 1000, the earphone 1000 may send battery level information of the earphone 1000 to the electronic device. The electronic device may display a battery level of the earphone 1000 based on the received battery level information. In this way, the user may further view the battery level of the earphone 1000 on the electronic device.

It should be noted that an application used for the earphone 1000 may be installed in the electronic device. The application used for managing the earphone 1000 may be, for example, the Health application. The electronic device may display, on a user interface of the Health application, the battery level of the earphone 1000 and a related option used for managing the earphone 1000. An application used for managing the earphone 1000 is not limited in this embodiment of the present disclosure. In subsequent embodiments, the Health application is specifically used as an example for description.

As shown in FIG. 19A, the electronic device may display a user interface 1910. The user interface 1910 may include an application icon, for example, a Health application icon. In response to an operation on the Health application icon, the electronic device may open the Health application.

As shown in FIG. 19B, when the Health application is opened, the electronic device may display a user interface 1920. The user interface 1920 may include a device option. The device option may be a device option corresponding to the earphone 1000. A device icon and a device name of the earphone 1000 and a connection status between the earphone 1000 and the electronic device may be displayed on the device option. Content displayed on the device option is not limited in embodiments of the present disclosure. In response to an operation on the device option, the electronic device may display a user interface 1930 shown in FIG. 19C. The user interface 1930 may be a user interface used for managing the earphone 1000 in the Health application.

As shown in FIG. 19C, the user interface 1930 may include a page title 1931 and a device information display box 1932.

The page title 1931 may indicate a device corresponding to the user interface 1930. For example, the page title 1931 may be a name “FreeBuds” of the earphone 1000.

The device information display box 1932 may include battery level information 1933 of the earphone 1000 and a connection status between the electronic device and the earphone 1000. The battery level information 1933 of the earphone may indicate current battery levels of two earbuds in the earphone 1000. For example, it can be learned from the battery level information 1933 of the earphone that, in the earphone 1000, a battery level of an earbud with a left earbud attribute is 80% of a full battery level, and a battery level of an earbud with a right earbud attribute is 85% of the full battery level. The connection status between the earphone 1000 and the electronic device is a “Connected” state.

In some embodiments, the earbud with the left earbud attribute may be an earbud located in a left compartment in the charging case 2000. In another embodiment, the earbud with the left earbud attribute may alternatively be an earbud worn on the left ear of the user.

Similarly, the earbud with the right earbud attribute may be an earbud located in a right compartment in the charging case 2000. In another embodiment, the earbud with the right earbud attribute may alternatively be an earbud worn on the right ear of the user.

For the two earbuds: the earbud with the left earbud attribute and the earbud with the right earbud attribute shown in FIG. 19C, both the two earbuds may be located in the charging case 2000. Alternatively, for the two earbuds: the earbud with the left earbud attribute and the earbud with the right earbud attribute shown in FIG. 19C, one earbud may be located in the left compartment in the charging case 2000, and the other earbud may be worn on the right ear of the user. Alternatively, for the two earbuds: the earbud with the left earbud attribute and the earbud with the right earbud attribute shown in FIG. 19C, one earbud may be located in the right compartment in the charging case 2000, and the other earbud may be worn on the left ear of the user. Alternatively, for the two earbuds: the earbud with the left earbud attribute and the earbud with the right earbud attribute shown in FIG. 19C, one earbud may be worn on the left ear of the user, and the other earbud may be worn on the right ear of the user.

It should be noted that when the two earbuds are respectively worn on the left ear and the right ear of the user, the two earbuds may be respectively worn on a left ear and a right ear of a same user, or may be respectively worn on a left ear and a right ear of different users.

In some embodiments, in response to an operation performed by the user on the device option, the electronic device may display a user interface 1940 shown in FIG. 19D. The user interface 1940 is similar to the user interface 1930. A difference lies in that device information display boxes are different.

As shown in FIG. 19D, the user interface 1930 may include a page title 1934 and a device information display box 1935.

The page title 1934 may indicate a device corresponding to the user interface 1930. For example, the page title 1934 may be a name “FreeBuds” of the earphone 1000.

The device information display box 1935 may include battery level information 1936 of the earphone 1000 and a connection status between the electronic device and the earphone 1000. The battery level information 1936 of the earphone may indicate current battery levels of two earbuds in the earphone 1000. For example, it can be learned from the battery level information 1936 of the earphone that, in the earphone 1000, a battery level of one earbud with a left earbud attribute is 80% of a full battery level, and a battery level of the other earbud with a left earbud attribute is 85% of the full battery level. The connection status between the earphone 1000 and the electronic device is a “Connected” state.

In some embodiments, the earbud with the left earbud attribute may be an earbud located in a left compartment in the charging case 2000. In another embodiment, the earbud with the left earbud attribute may alternatively be an earbud worn on the left ear of the user.

Attributes of two earbuds shown in the device information display box 1935 are both left earbud attributes. In this case, one of the two earbuds is located in the left compartment in the charging case 2000, and the other earbud is worn on the left ear of the user. Alternatively, the two earbuds are worn on left ears of two users at the same time.

In some embodiments, in response to an operation performed by the user on the device option, the electronic device may display a user interface 1950 shown in FIG. 19E. The user interface 1950 is similar to the user interface 1930. A difference lies in that device information display boxes are different.

As shown in FIG. 19E, the user interface 1950 may include a page title 1937 and a device information display box 1938.

The page title 1937 may indicate a device corresponding to the user interface 1930. For example, the page title 1937 may be a name “FreeBuds” of the earphone 1000.

The device information display box 1938 may include battery level information 1939 of the earphone 1000 and a connection status between the electronic device and the earphone 1000. The battery level information 1939 of the earphone may indicate current battery levels of two earbuds in the earphone 1000. For example, it can be learned from the battery level information 1939 of the earphone that, in the earphone 1000, a battery level of one earbud with a right earbud attribute is 80% of a full battery level, and a battery level of the other earbud with a right earbud attribute is 85% of the full battery level. The connection status between the earphone 1000 and the electronic device is a “Connected” state.

In some embodiments, the earbud with the right earbud attribute may be an earbud located in a right compartment in the charging case 2000. In another embodiment, the earbud with the right earbud attribute may alternatively be an earbud worn on the right ear of the user.

Attributes of two earbuds shown in the device information display box 1939 are both right earbud attributes. In this case, one of the two earbuds is located in the right compartment in the charging case 2000, and the other earbud is worn on the right ear of the user. Alternatively, the two earbuds are worn on right ears of two users at the same time.

In another embodiment, after the electronic device is paired with the earphone 1000 and establishes a communication connection (for example, a Bluetooth connection) to the earphone 1000, the earphone 1000 may send battery level information of the earphone 1000 to the electronic device. The electronic device may display a battery level of the earphone 1000 based on the received battery level information. In this way, the user may further view the battery level of the earphone 1000 on the electronic device.

For example, the electronic device may view the battery level of the earphone 1000 in a pull-down notification bar.

As shown in FIG. 19F, the electronic device may receive and respond to a pull-down operation of sliding down from a top right area of a screen of the electronic device by the user, and the electronic device may display a user interface 1960 shown in FIG. 19G. The user interface 1960 may be a pull-down control interface of the electronic device. A user operation for opening the pull-down control interface is not limited in embodiments of the present disclosure.

As shown in FIG. 19G, the user interface 1960 may include a card 1961.

The card 1961 may be configured to open a user interface (for example, the user interface 1920 shown in FIG. 19B) used for managing the earphone 1000. The card 1961 may display the battery level information of the earphone 1000. In other words, the user may open the pull-down control interface through the pull-down operation, and quickly view the battery level of the earphone 1000 on the pull-down control interface.

The battery level information of the earphone 1000 shown in FIG. 19G may indicate current battery levels of the two earbuds in the earphone 1000. For example, it can be learned from the battery level information of the earphone 1000 that, in the earphone 1000, a battery level of one earbud with a left earbud attribute is 80% of a full battery level, and a battery level of the other earbud with a left earbud attribute is 85% of the full battery level. In some embodiments, the earbud with the left earbud attribute may be an earbud located in a left compartment in the charging case 2000. In another embodiment, the earbud with the left earbud attribute may alternatively be an earbud worn on the left ear of the user.

Attributes of the two earbuds shown in the card 1961 are respectively the left earbud attribute and the right earbud attribute, and both the two earbuds may be located in the charging case 2000. Alternatively, one earbud may be located in the left compartment in the charging case 2000, and the other earbud may be worn on the right ear of the user. Alternatively, one earbud may be located in a right compartment in the charging case 2000, and the other earbud may be worn on the left ear of the user. Alternatively, one earbud may be worn on the left ear of the user, and the other earbud may be worn on the right ear of the user.

It should be noted that when the two earbuds are respectively worn on the left ear and the right ear of the user, the two earbuds may be respectively worn on a left ear and a right ear of a same user, or may be respectively worn on a left ear and a right ear of different users.

In some embodiments, in response to a pull-down operation of sliding down from a top right area of a screen of the electronic device by the user, the electronic device may display a user interface 1970 shown in FIG. 19H. The user interface 1970 is similar to the user interface 1960. A difference lies in that the card 1971 is different from the card 1961.

Both attributes of two earbuds shown in the card 1961 are left earbud attributes. In this case, one of the two earbuds is located in the left compartment in the charging case 2000, and the other earbuds is worn on the left ear of the user. Alternatively, the two earbuds are worn on left ears of two users at the same time.

In some embodiments, in respond to a pull-down operation of sliding down from a top right area of a screen of the electronic device by the user, the electronic device may display a user interface 1980 shown in FIG. 19I. The user interface 1980 is similar to the user interface 1960. A difference lies in that the card 1981 is different from the card 1961.

Both attributes of two earbuds shown in the card 1981 are right earbud attributes. In this case, one of the two earbuds is located in the right compartment in the charging case 2000, and the other earbuds is worn on the right ear of the user. Alternatively, the two earbuds are worn on right ears of two users at the same time.

In addition to the user interface of the Health application and the pull-down control interface, the electronic device 5-200 may further display the battery level information of the earphone 1000 at another position. For example, the electronic device may further display the battery level information of the earphone 1000 on a HiBoard interface. A position at which the electronic device displays the battery level information of the earphone 1000 is not limited in this embodiment of the present disclosure.

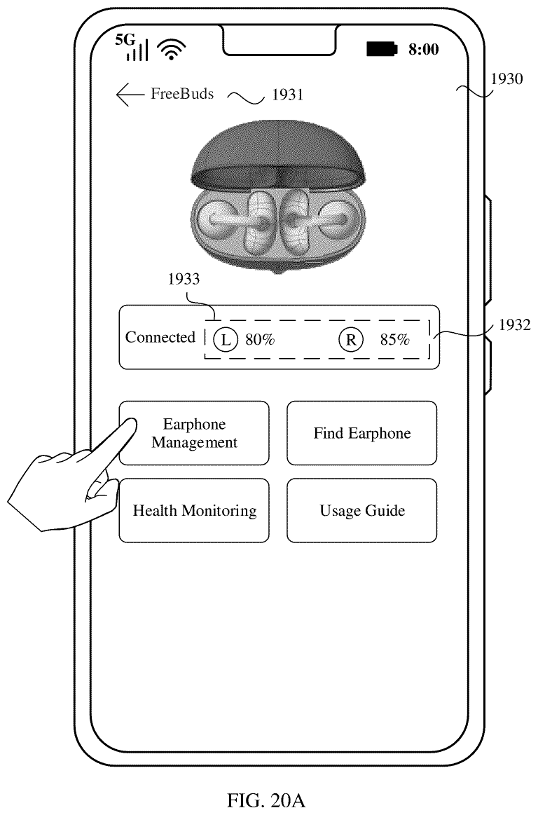

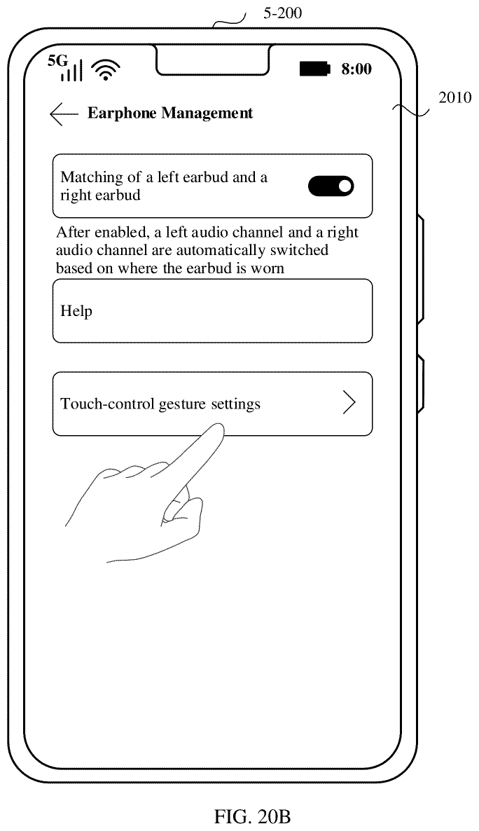

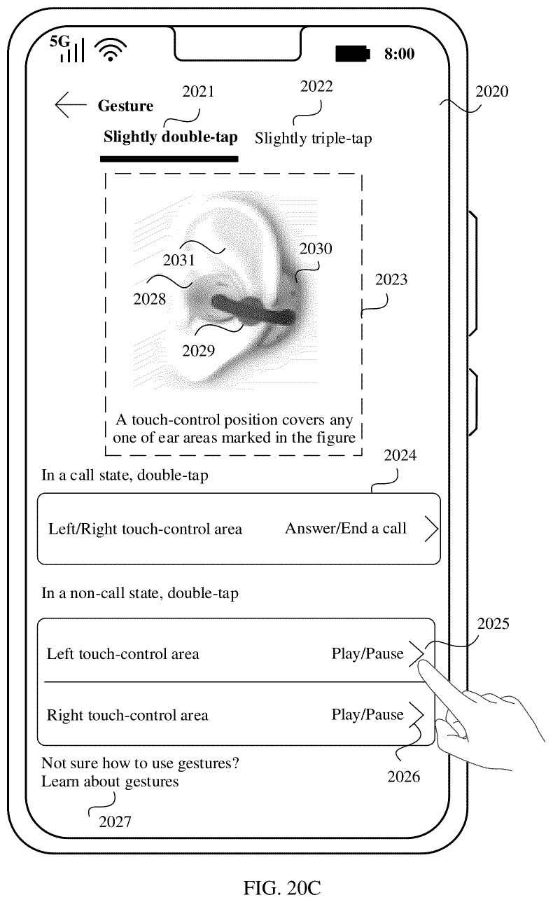

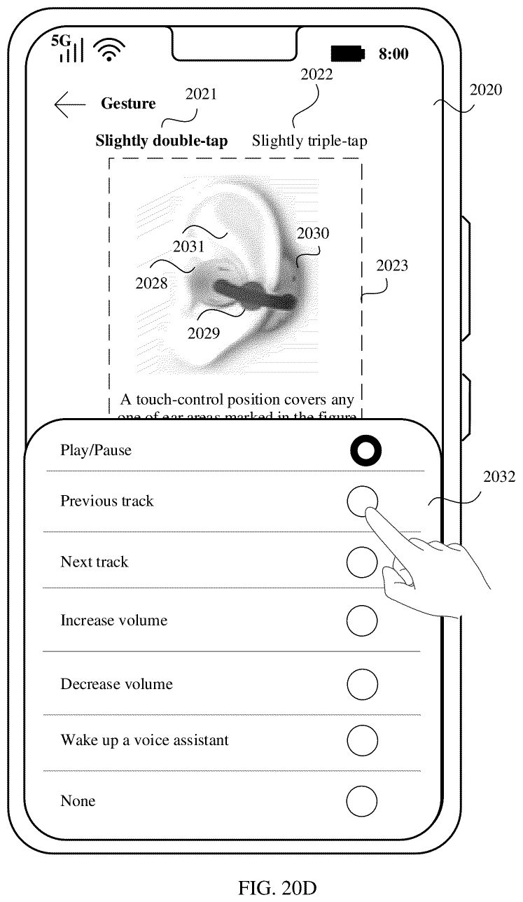

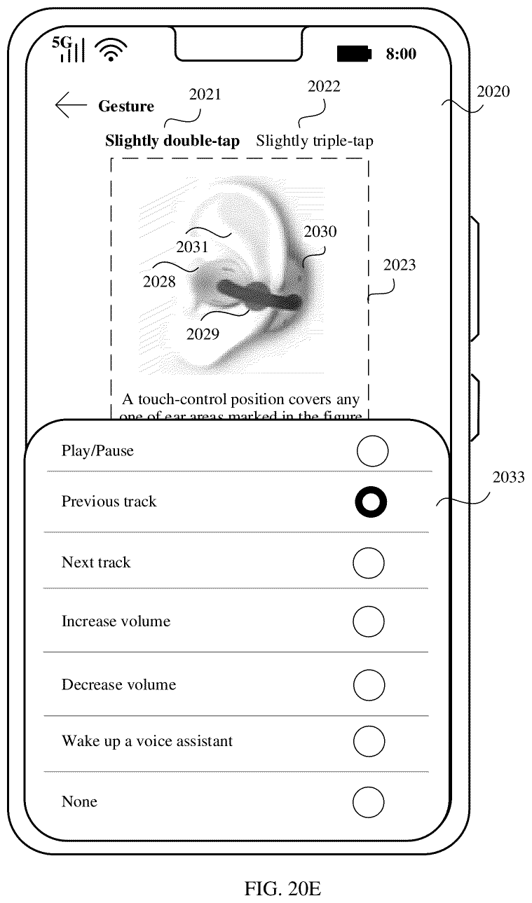

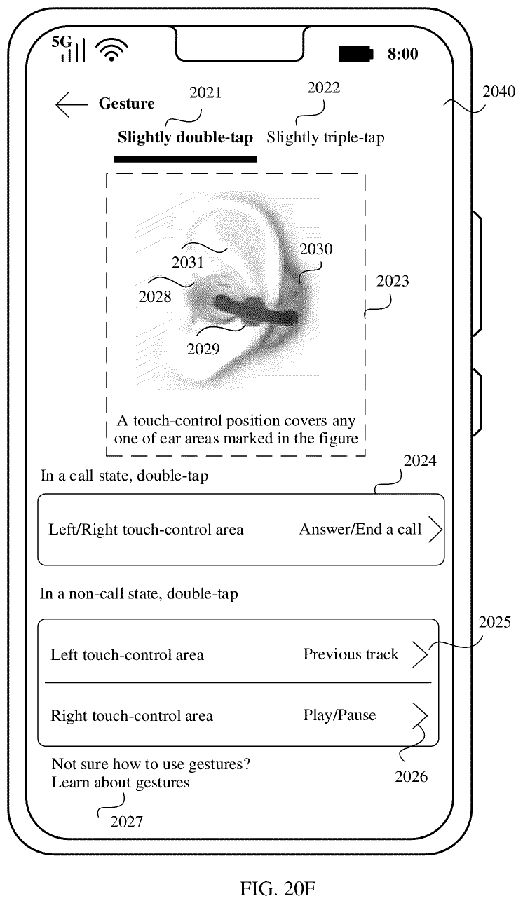

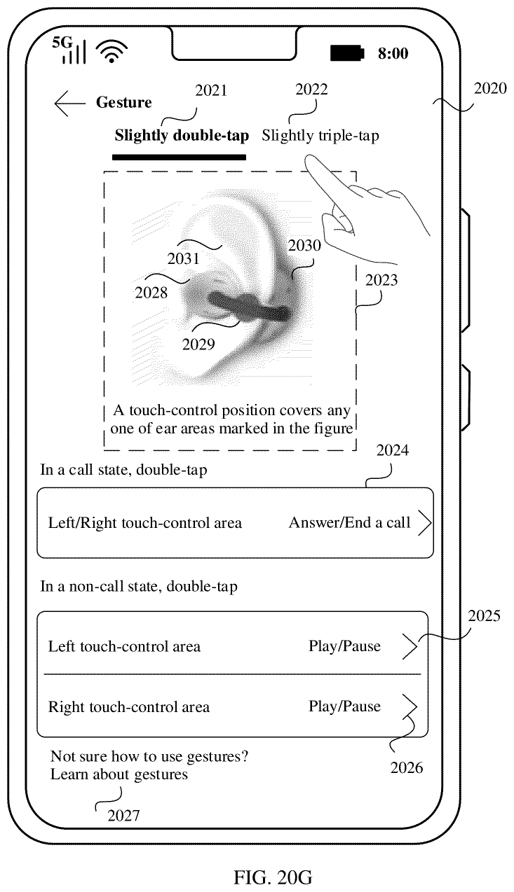

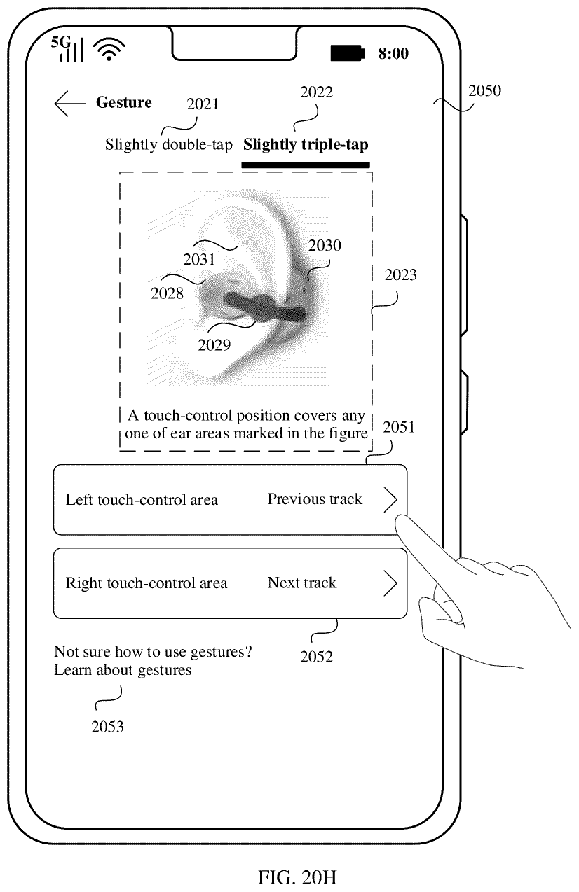

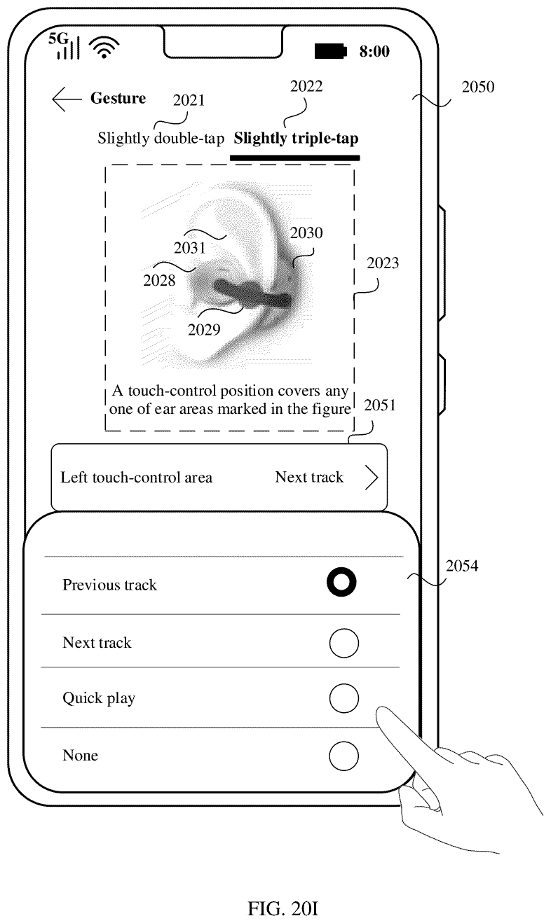

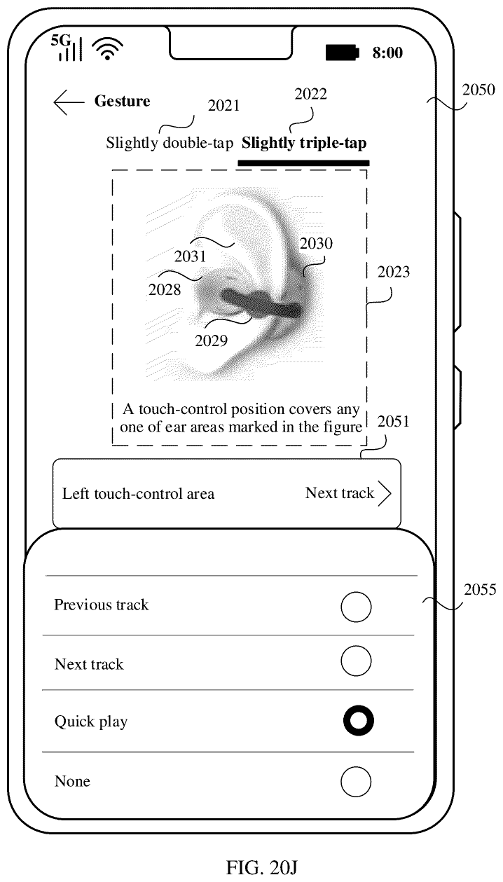

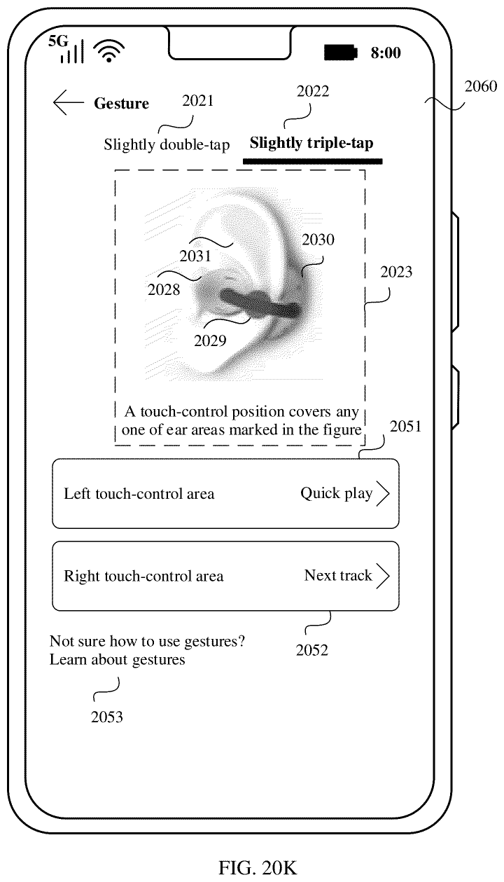

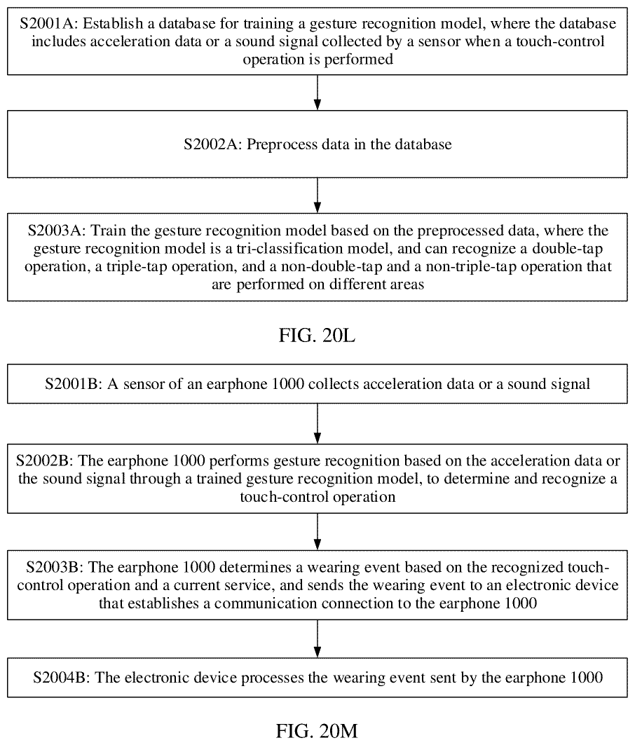

FIG. 20A to FIG. 20K are diagrams in which the user views and sets the earphone touch-control gesture on the electronic device.

In some embodiments, the user may view and set the earphone touch-control gesture in the Health application of the electronic device.

In addition to the Health application, the user may further view and set the earphone touch-control gesture in another application. In the present disclosure, the Health application is merely used as an example for description, but should not be construed as a limitation.

As shown in FIG. 20A, the electronic device may display the user interface 1930. The electronic device may receive an input operation (for example, a single tap) of the user for an earphone management option on the user interface 1930, and in response to the input operation of the user, the electronic device may display a user interface 2010 shown in FIG. 20B.

As shown in FIG. 20B, the user interface 2010 may include a touch-control gesture setting option and the like. The user may view and set the earphone touch-control gesture through a wide-area touch-control option. A touch-control function may be a function in which the earphone 1000 detects a preset operation in a preset area and executes an instruction corresponding to the preset operation when the earphone 1000 is in the worn state. The preset area may be a touch-control area distributed on a user's ear, an area around the user's ear, and the earphone. The preset operation may include but is not limited to a slightly double-tap operation and a slightly triple-tap operation. The slightly double-tap operation may be an operation of quickly tapping twice consecutively. The slightly triple-tap operation may be an operation of quickly tapping three times consecutively. The instruction corresponding to the preset operation may include but is not limited to: a play instruction, a playing pause instruction, an answering instruction, an ending instruction, an instruction for switching to a previous track, an instruction for switching to a next track, an instruction for waking up a voice assistant, a volume adjustment instruction, a noise control instruction, a quick play instruction, and a song identification instruction.

As shown in FIG. 20B, the electronic device may receive an input operation (for example, a single tap) of the user for the touch-control gesture setting option on the user interface 2010, and in response to the input operation of the user, the electronic device may display a user interface 2020 shown in FIG. 20C.

The user interface 2020 may include a slightly double-tap option 2021, a slightly triple-tap option 2022, touch-control area information 2023, a left/right touch-control area 2024, a left touch-control area option 2025, a right touch-control area option 2026, and a gesture learning control 2027.

It should be noted that the left touch-control area herein is related to the left earbud attribute. For example, when the first earbud is worn on the left ear of the user, the wearing attribute of the first earbud is the left earbud attribute. In this case, the “slightly double-tap” operation performed by the user on the left touch-control area is used to control, via the first earbud, the earphone 1000 to execute an instruction corresponding to the slightly double-tap operation. Similarly, the right touch-control area is related to the right earbud attribute. For example, when the second earbud is worn on the right ear of the user, the wearing attribute of the second earbud is the right earbud attribute. In this case, the “slightly double-tap” operation performed by the user on the right touch-control area is used to control, via the second earbud, the earphone 1000 to execute an instruction corresponding to the slightly double-tap operation.

In some embodiments, the attribute of the earphone may be changed. For example, the user takes off the first earbud from the left ear and wears the first earbud on the right ear of the user. In this case, the wearing attribute of the first earbud is switched from the left earbud attribute to the right earbud attribute. In this case, the “slightly double-tap” operation performed by the user on the right touch-control area is used to control, via the first earbud, the earphone 1000 to execute the instruction corresponding to the slightly double-tap operation.

Similarly, if the user takes off the second earbud from the right ear and wears the second earbud on the left ear of the user, the wearing attribute of the second earbud is switched from the right earbud attribute to the left earbud attribute. In this case, the “slightly double-tap” operation performed by the user on the left touch-control area is used to control, via the second earbud, the earphone 1000 to execute the instruction corresponding to the slightly double-tap operation.

The slightly double-tap option 2021 may be used to trigger the electronic device to display a user interface used for setting the instruction corresponding to the “slightly double-tap” operation.

The slightly triple-tap option 2022 may be used to trigger the electronic device to display a user interface used for setting the instruction corresponding to the “slightly triple-tap” operation.

The slightly double-tap option 2021 and the slightly triple-tap option 2022 may help the user switch between setting interfaces of different operations. When the slightly double-tap option 2021 is in a selected state, the electronic device may display the user interface 2020 shown in FIG. 20C. In other words, the user interface 2020 is a user interface used for setting the instruction corresponding to the “slightly triple-tap” operation.

The touch-control area information 2023 may indicate an area in which the touch-control function can be implemented, namely, an area in which the foregoing preset operation (for example, the slightly double-tap operation or the slightly triple-tap operation) is performed.

For example, the touch-control area information 2023 includes a diagram in which the earphone 1000 is worn on the ear, and the diagram of the ear is marked with a touch-control area 2028, a touch-control area 2029, a touch-control area 2030, and a touch-control area 2031. The touch-control area 2028 may be a touch-control area of a ball on the earphone. The touch-control area 2029 may be a touch-control area of a cantilever arm on the earphone. The touch-control area 2030 may be a touch-control area of a bean on the earphone. The touch-control area 2031 may be an area where a triangular fossa is located on an auricle. The user may trigger the earphone to execute the instruction corresponding to the preset operation by performing the preset operation in any one of the plurality of touch-control areas.

The touch-control area 2028, the touch-control area 2029, the touch-control area 2030, and the touch-control area 2031 are merely examples for description in the present disclosure. The earphone may further include more or fewer other touch-control areas, which should not constitute a limitation on the present disclosure. The foregoing touch-control function may be further supported on more touch-control areas.

The left/right touch-control area 2024 may be used for setting, when the earphone is in a call state, an instruction corresponding to the “slightly double-tap” operation performed in the touch-control area. When the earphone is in the call state, an instruction triggered by the “slightly double-tap” touch-control gesture in the left touch-control area is the same as an instruction triggered by the “slightly double-tap” touch-control gesture in the right touch-control area. When the earphone is currently in the call state, the instruction triggered by the “slightly double-tap” touch-control gesture performed on the left/right touch-control area is to answer/end a call.

The left touch-control area option 2025 may be used for setting the instruction corresponding to the “slightly double-tap” operation performed in the touch-control area. For example, “play/pause” may be displayed in the left touch-control area option 2025, and it may indicate that the instruction corresponding to the “slightly double-tap” operation performed in the left touch-control area is a play/pause instruction. The play/pause instruction may be used to control, via the earphone with the left earbud attribute, the earphone 1000 to start audio playing, pause audio playing, or the like.

The right touch-control area option 2026 may be used for setting the instruction corresponding to the “slightly double-tap” operation performed in the touch-control area. For example, “play/pause” may be displayed in the right touch-control area option 2026, and it may indicate that the instruction corresponding to the “slightly double-tap” operation performed in the right touch-control area is a play/pause instruction. The play/pause instruction may be used to control, via the earphone with the right earbud attribute, the earphone 1000 to start audio playing, pause audio playing, or the like.

The gesture learning control 2027 may be used to view more usage descriptions of gestures supported by the touch-control function.

In some embodiments, the electronic device may receive a user operation to change the instruction corresponding to the “slightly double-tap” operation performed by the user in the left touch-control area and/or the right touch-control area.

For example, as shown in FIG. 20C, the electronic device may receive an input operation (for example, a single tap) of the user for the left touch-control area option 2025, and in response to the input operation of the user, the electronic device may display a pop-up window 2032 shown in FIG. 20D. The pop-up window 2032 may include a plurality of setting options, for example, a play/pause setting option, a previous track setting option, a next track setting option, a volume increasing setting option, a volume decreasing option, and a voice assistant wakeup setting option. The play/pause setting option shown in the pop-up window 2032 is in a selected state, and the selected state indicates that the instruction corresponding to the “slightly double-tap” operation performed in the left touch-control area is a play/pause instruction.

As shown in FIG. 20D, the electronic device may receive an input operation (for example, a single tap) of the user for the previous track setting option, and in response to the input operation of the user, the electronic device may display a pop-up window 2033 shown in FIG. 20E. The pop-up window 2033 is similar to the pop-up window 2032. A difference lies in that the previous track setting option shown in the pop-up window 2033 is in a selected state, and the selected state indicates that the instruction corresponding to the “slightly double-tap” operation performed in the left touch-control area is an instruction for switching to the previous track.

For example, when the user sets the instruction corresponding to the “slightly double-tap” operation performed in the left touch-control area as the instruction for switching to the previous track, the electronic device may display a user interface 2040 shown in FIG. 20F. The user interface 2040 is similar to the user interface 2010. A difference lies in that “previous track” may be displayed in the left touch-control area option 2025 on the user interface 2040, and may indicate that the instruction corresponding to the “slightly double-tap” operation performed in the left touch-control area is the instruction for switching to the previous track. The instruction for switching to the previous track may control, via the earphone with the left earbud attribute, the earphone 1000 to switch to the previous track.

In some implementations, the electronic device may also receive a user operation to view the user interface of the instruction corresponding to the slightly triple-tap option 2022. For example, as shown in FIG. 20G, the electronic device may receive an input operation (for example, a single tap) of the user for the slightly triple-tap option 2022 on the user interface 2020, and in response to the input operation of the user, the electronic device may display a user interface 2050 shown in FIG. 20H.

As shown in FIG. 20H, the user interface 2050 includes a left touch-control area option 2051, a right touch-control area option 2052, and a gesture learning control 2027.

The left touch-control area option 2051 may be used for setting the instruction corresponding to the “slightly triple-tap” operation performed in the touch-control area. For example, “previous track” may be displayed in the left touch-control area option 2051, and it may indicate that the instruction corresponding to the “slightly triple-tap” operation performed in the left touch-control area is a play/pause instruction. The instruction for switching to the previous track may control, via the earphone with the left earbud attribute, the earphone 1000 to switch to the previous track.

The right touch-control area option 2052 may be used for setting the instruction corresponding to the “slightly triple-tap” operation performed in the touch-control area. For example, “next track” may be displayed in the right touch-control area option 2052, and it may indicate that the instruction corresponding to the “slightly triple-tap” operation performed in the right touch-control area is a play/pause instruction. The play/pause instruction may control, via the earphone with the right earbud attribute, the earphone 1000 to switch to the next track.

The gesture learning control 2053 may be used to view more usage descriptions of gestures supported by the touch-control function.

In some embodiments, the electronic device may receive a user operation to change the instruction corresponding to the “slightly triple-tap” operation performed by the user in the left touch-control area and/or the right touch-control area.

For example, as shown in FIG. 20H, the electronic device may receive an input operation (for example, a single tap) of the user for the left touch-control area option 2051, and in response to the input operation of the user, the electronic device may display a pop-up window 2054 shown in FIG. 201. The pop-up window 2054 may include a plurality of setting options, for example, a previous track setting option, a next track setting option, a quick play setting option, and a no operation instruction setting option. The previous track setting option shown in the pop-up window 2054 is in a selected state, and the selected state indicates that the instruction corresponding to the “slightly triple-tap” operation performed in the left touch-control area is an instruction for switching to the previous track.

As shown in FIG. 201, the electronic device may receive an input operation (for example, a single tap) of the user for the quick play setting option, and in response to the input operation of the user, the electronic device may display a pop-up window 2055 shown in FIG. 20J. The pop-up window 2055 is similar to the pop-up window 2054. A difference lies in that the quick play setting option shown in the pop-up window 2055 is in a selected state, and the selected state indicates that the instruction corresponding to the “slightly triple-tap” operation performed in the left touch-control area is an instruction for waking up quick play.

For example, when the user sets the instruction corresponding to the “slightly triple-tap” operation performed in the left touch-control area as an instruction for switching to wake up quick play, the electronic device may display a user interface 2060 shown in FIG. 20K. The user interface 2060 is similar to the user interface 2050. A difference lies in that “quick play” may be displayed in the left touch-control area option 2051 on the user interface 2060, and may indicate that the instruction corresponding to the “slightly triple-tap” operation performed in the left touch-control area is the instruction for waking up quick play. The instruction for waking up quick play may control, via the earphone with the left earbud attribute, the earphone 1000 to wake up quick play.

FIG. 20A to FIG. 20K are diagrams in which the user may view and set the earphone touch-control gesture on the electronic device. When the earphone is in the worn state, the user may conveniently control the earphone 1000 through a gesture.

Different gestures of the user acting on the earphone have different control operations on the earphone 1000. The earphone needs to accurately identify the touch-control gesture of the user, and then control, based on the touch-control gesture of the user, the earphone 1000 to execute a corresponding instruction.

The following describes how the earphone identifies the different touch-control gestures of the user.

In the present disclosure, the touch-control gesture may include but is not limited to a double-tap gesture and a triple-tap gesture, and the touch-control gesture may further include more other gestures. In the present disclosure, only the double-tap gesture and the triple-tap gesture are used as examples for description.

In some embodiments, two earbuds in the earphone 1000 each may store a trained gesture recognition model. The gesture recognition model may be used to recognize a touch-control operation. The touch-control operation may include various types of operations performed on touch-control areas. For example, the touch-control operation may include a double-tap operation (that is, the slightly double-tap operation), a triple-tap operation (that is, the slightly triple-tap operation), and the like that are performed on the touch-control area 2028/touch-control area 2029/touch-control area 2030/touch-control area 2031. In this way, the earphone 1000 may execute, based on the touch-control operation recognized by the gesture recognition model, an instruction corresponding to the touch-control operation, to implement a corresponding function.

An implementation method for training the gesture recognition model is first described herein.

FIG. 20L shows an example of a flowchart of the method for training the gesture recognition model.

As shown in FIG. 20L, the method may include steps S2001A to S2003A. Steps S2001A to S2003A may be performed by a model training device. The model training device may be a cloud server. A type of the model training device is not limited in embodiments of the present disclosure.

S2001A: Establish a database for training the gesture recognition model, where the database includes acceleration data or a sound signal collected by a sensor when a touch-control operation is performed.

When performing the touch-control operation, the user needs to tap an ear, an area around the ear, or the earphone. In this case, the area touch-control operation may cause vibration of an auricle, and may make a tapping sound. If a bone conduction sensor or an IMU sensor is disposed in the earphone, the bone conduction sensor or the IMU may collect the acceleration data. The acceleration data may reflect vibration of the auricle caused by the area touch-control operation. If a sound pickup sensor (for example, a microphone) is disposed in the earphone, the sound pickup sensor may collect a sound signal. The sound signal may reflect a sound made by the touch-control operation. Therefore, the acceleration data or the sound signal may be used to train the gesture recognition model.

In some embodiments, the database may further include acceleration data or a sound signal collected by the sensor when a non touch-control operation is performed. The non touch-control operation may include an operation that easily causes a touch-control operation recognition error. For example, the non touch-control operation may include a single-tap operation performed on a touch-control area. The gesture recognition model is trained based on the acceleration data or the sound signal collected by the sensor when the non touch-control operation is performed, so that recognition accuracy of the gesture recognition model can be improved.

The model training device may receive and store the database.

S2002A: Preprocess data in the database.

In some embodiments, the data in the database may be preprocessed according to a decision tree algorithm. This is not limited to the decision tree algorithm, and may be another means. This is not limited in the present disclosure.

The model training device may preprocess the data in the database according to the decision tree algorithm, to obtain a plurality of groups of training samples. The decision tree algorithm may be used to recognize a signal waveform generated by a double-tap operation (for example, a signal waveform of acceleration data or a waveform of a sound signal) and a signal waveform generated by a triple-tap operation. In the foregoing preprocessing process, a tapping strength (for example, a peak position of a waveform), a time interval between two adjacent taps, and a quantity of taps (for example, a peak quantity of waveforms) may be intercepted, to reduce decision options used in the decision tree algorithm, thereby improving decision accuracy of the decision tree algorithm.

In some embodiments, a plurality of groups of training samples obtained by the model training device by performing the foregoing preprocessing may include: a training sample corresponding to a double-tap operation performed in the touch-control area 2028, a training sample corresponding to a double-tap operation performed in the touch-control area 2029, a training sample corresponding to a double-tap operation performed in the touch-control area 2030, a training sample corresponding to a double-tap operation performed in the touch-control area 2031, a training sample corresponding to a triple-tap operation performed in the touch-control area 2028, a training sample corresponding to a triple-tap operation performed in the touch-control area 2029, a training sample corresponding to a triple-tap operation performed in the touch-control area 2030, a training sample corresponding to a triple-tap operation performed in the touch-control area 2031, and a training sample corresponding to a non-double-tap operation and a non-triple-tap operation.

A group of training samples corresponding to the double-tap operation performed on the touch-control area 2028 may include acceleration data or a sound signal collected by the sensor when the double-tap operation is performed once on the touch-control area 2028.

A group of training samples corresponding to the double-tap operation performed on the touch-control area 2029 may include acceleration data or a sound signal collected by the sensor when the double-tap operation is performed once on the touch-control area 2029.

A group of training samples corresponding to the double-tap operation performed on the touch-control area 2030 may include acceleration data or a sound signal collected by the sensor when the double-tap operation is performed once on the touch-control area 2030.

A group of training samples corresponding to the double-tap operation performed on the touch-control area 2031 may include acceleration data or a sound signal collected by the sensor when the double-tap operation is performed once on the touch-control area 2031.

A group of training samples corresponding to the triple-tap operation performed on the touch-control area 2028 may include acceleration data or a sound signal collected by the sensor when the triple-tap operation is performed once on the touch-control area 2028.

A group of training samples corresponding to the triple-tap operation performed on the touch-control area 2029 may include acceleration data or a sound signal collected by the sensor when the triple-tap operation is performed once on the touch-control area 2029.

A group of training samples corresponding to the triple-tap operation performed on the touch-control area 2030 may include acceleration data or a sound signal collected by the sensor when the triple-tap operation is performed once on the touch-control area 2030.

A group of training samples corresponding to the triple-tap operation performed on the touch-control area 2031 may include acceleration data or a sound signal collected by the sensor when the triple-tap operation is performed once on the touch-control area 2031.

A group of training samples corresponding to the non-double-tap and non-triple-tap operation may include acceleration data or a sound signal collected by the sensor when the non-double-tap and non-triple-tap operation is performed once.

S2003A: Train the gesture recognition model based on the preprocessed data, where the gesture recognition model is a tri-classification model, and can recognize a double-tap operation, a triple-tap operation, and a non-double-tap and a non-triple-tap operation that are performed on different areas.

The model training device may train the gesture recognition model by using the plurality of groups of training samples obtained through preprocessing. The gesture recognition model may be a neural network model, for example, a convolutional neural network model. A type of the gesture recognition model is not limited in embodiments of the present disclosure.

Specifically, the gesture recognition model may be a tri-classification model, and may recognize three types of operations: a double-tap operation, a triple-tap operation, and a non-double-tap and non-triple-tap operation. The foregoing process of training the gesture recognition model by using the plurality of groups of training samples is a process of enabling the gesture recognition model to recognize a touch-control operation and reducing a probability of misrecognizing a single-tap operation, an operation generated when a posture of the earphone is adjusted, an operation generated when the earphone is worn or removed, and a probability of confusing a double-tap operation and a triple-tap operation. A specific process of training the gesture recognition model by using the training samples is not limited in embodiments of the present disclosure.

The trained gesture recognition model may receive input data. The input data may be the acceleration data or the sound signal. The trained gesture recognition model may output a recognition result based on the received input data. The recognition result may indicate a touch-control operation corresponding to the input data.

FIG. 20K shows merely an example of the method for training the gesture recognition model according to the present disclosure, and should not constitute a limitation on the present disclosure. The model training device may alternatively obtain the gesture recognition model through training by using another method.

In some embodiments, the foregoing trained gesture recognition model may be preset on two earbuds (that is, the first earbud and the second earbud) of the earphone 1000 before delivery. The earphone 1000 may recognize a touch-control operation based on the gesture recognition model, to provide a touch-control function.

Here, an implementation method for providing the touch-control function by the earphone 1000 is described.

FIG. 20M shows an example of a flowchart of the method for providing the touch-control function by the earphone 1000.

As shown in FIG. 20M, the method may include steps S2001B to S2004B. The first earbud and the second earbud may separately perform the foregoing steps S2001B to S2004B. Here, the earphone 1000 is used as an execution body for description, to indicate that any earbud in the earphone 1000 may be used as an execution body of the method shown in FIG. 20L.

S2001B: A sensor of the earphone 1000 collects acceleration data or a sound signal.

A bone conduction sensor, an IMU sensor, and/or a sound pickup sensor may be disposed in the earphone 1000. The earphone 1000 may collect the acceleration data through the bone conduction sensor or the IMU sensor. The earphone 1000 may collect the sound signal through the sound pickup sensor.

S2002B: The earphone 1000 performs gesture recognition based on the acceleration data or the sound signal through the trained gesture recognition model, to determine and recognize a touch-control operation.

When the touch-control function is enabled, the earphone 1000 may continuously collect acceleration data through the bone conduction sensor or the IMU sensor, or continuously collect a sound signal through the sound pickup sensor. Then, the earphone 1000 may recognize, based on the trained gesture recognition model, the continuously collected acceleration data or the continuously collected sound signal, to determine whether a wide-area touch-control operation exists.

Based on the description in FIG. 20K, the trained gesture recognition model may filter out a single-tap operation, an operation generated when a posture of the earphone is adjusted, a misoperation generated when the earphone is worn or removed, a probability of confusing a double-tap operation and a triple-tap operation, and the like. The trained gesture recognition model can accurately recognize whether the touch-control operation of the user is a double-tap operation or a triple-tap operation.

S2003B: The earphone 1000 determines a wearing event based on the recognized touch-control operation and a current service, and sends the wearing event to an electronic device that establishes a communication connection to the earphone 1000.

The service performed by the earphone 1000 may include audio-related services such as a call service and a music service. It can be learned from the foregoing embodiments that a same touch-control operation may indicate different wearing events in different services, and may be used to trigger the earphone 1000 to execute different instructions.

The wearing event may include but is not limited to: an event of playing/pausing music, an event of switching to a previous track of music, an event of switching to a next track of music, an event of answering an incoming call, an event of ending a call, an event of waking up a voice assistant, and the like.

S2004B: The electronic device processes the wearing event sent by the earphone 1000.

In response to the wearing event sent by the earphone 1000, the electronic device may execute, based on a currently performed service, a corresponding wearing event of the service.

For example, when the service that is being performed on the electronic device is playing music, the wearing event may include but is not limited to an event of switching to a previous track of music, an event of switching to a next track of music, an event of pausing music, an event of waking up a voice assistant, and the like.

For another example, when the service that is being performed by the electronic device is answering a call, the wearing event may include but is not limited to an event of ending a call, and the like.

### III. Determine a Primary Mic

The primary mic on the earphone is configured to pick up an audio output by the user, and then the earphone sends the audio input and output by the user to an electronic device that establishes a communication connection to the earphone.

Based on the foregoing description, the second earbud body 200 includes two microphones, that is, a first feedforward microphone and a second feedforward microphone.

In some embodiments, the first feedforward microphone and the second feedforward microphone may operate together and pick up audios at the same time. The second earbud body 200 may synthesize the two channels of audio to obtain one channel of audio, and transmit the channel of audio to the electronic device that establishes the communication connection to the earphone. In this case, both the first feedforward microphone and the second feedforward microphone may be primary mics.

In some embodiments, the first feedforward microphone and the second feedforward microphone may be enabled at different time. For example, the second earbud body 200 may enable only the first feedforward microphone or enable only the second feedforward microphone. At the same time, only one microphone picks up an audio, and the second earbud body 200 may send one channel of audio to the electronic device that establishes the communication connection to the earphone. In this case, when the first feedforward microphone is enabled, the first feedforward microphone is the primary mic. When the second feedforward microphone is enabled, the second feedforward microphone is the primary mic.

The earphone 1000 includes a first earbud and a second earbud. Based on the foregoing description, both the first earbud and the second earbud may be in a worn state, or only one of the first earbud and the second earbud may be in a worn state.

When both the first earbud and the second earbud are in the worn state, the first earbud and the second earbud may be respectively worn on a left ear and a right ear of a same user, or the first earbud and the second earbud may be respectively worn on a left ear and a right ear of two different users, or the first earbud and the second earbud may be respectively worn on left ears of two different users, or the first earbud and the second earbud may be respectively worn on right ears of two different users.

Only one of the first earbud and the second earbud is in the worn state. The first earbud or the second earbud may be worn on the left ear of the user, or the first earbud or the second earbud may be worn on the right ear of the user.

The following describes how the earphone 1000 determines the primary mic when a single earbud is worn and when two earbuds are worn at the same time.

1. Scenario in which the Single Earbud is Worn

When only one of the two earbuds in the earphone 1000 is in the worn state, one feedforward microphone or two feedforward microphones in the single earbud in the worn state may be used as a primary mic/primary mics.

In this embodiment of the present disclosure, an example in which the first earbud in the earphone 1000 is in the worn state is used for description.

(1) The first earbud in the earphone 1000 is worn on the left ear of the user.

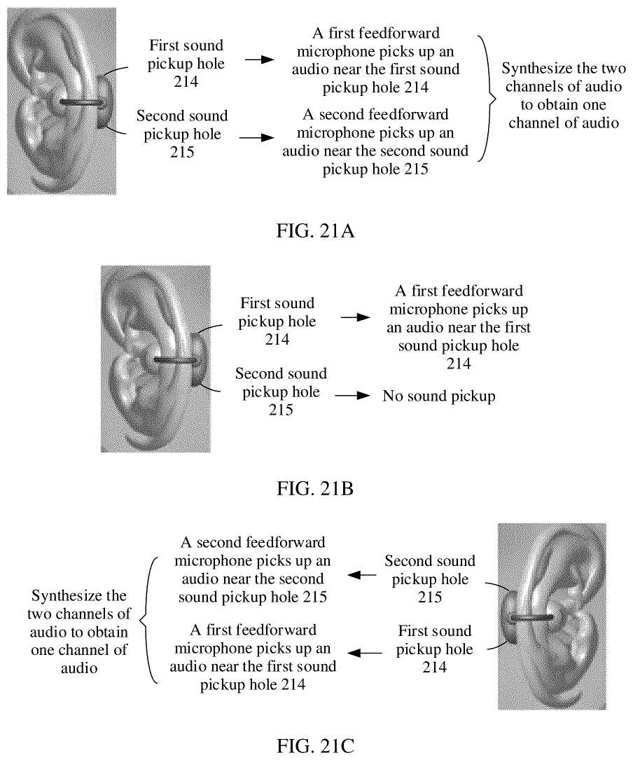

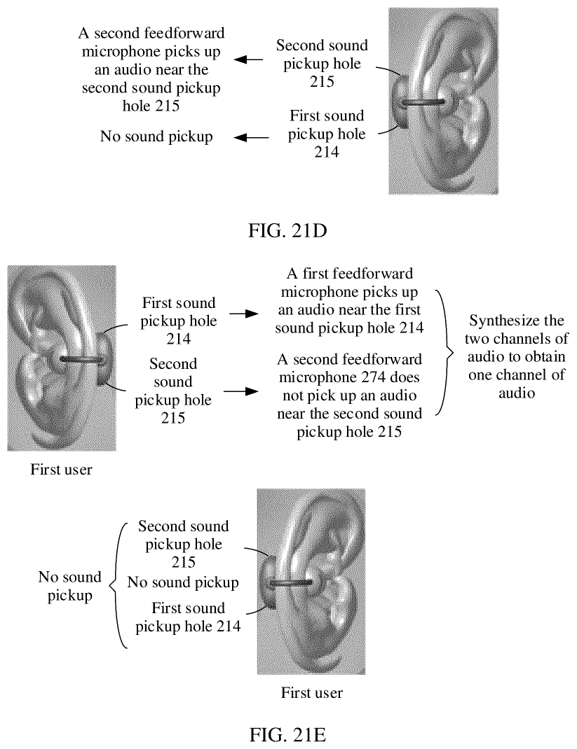

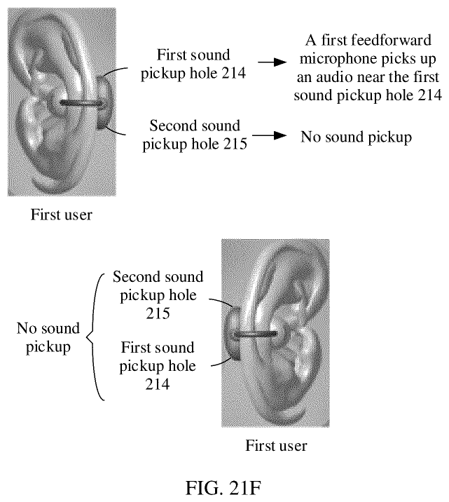

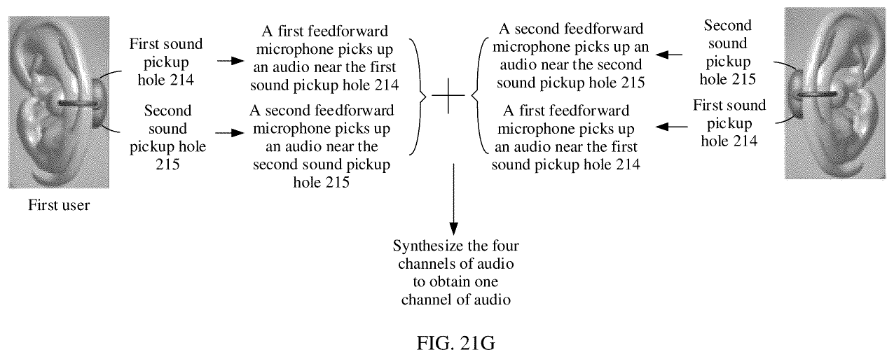

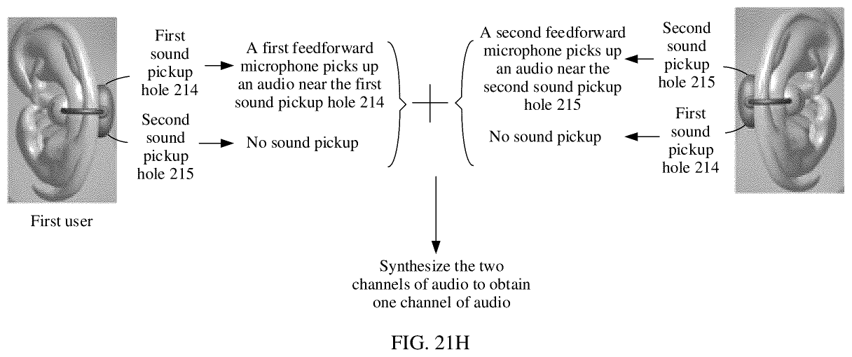

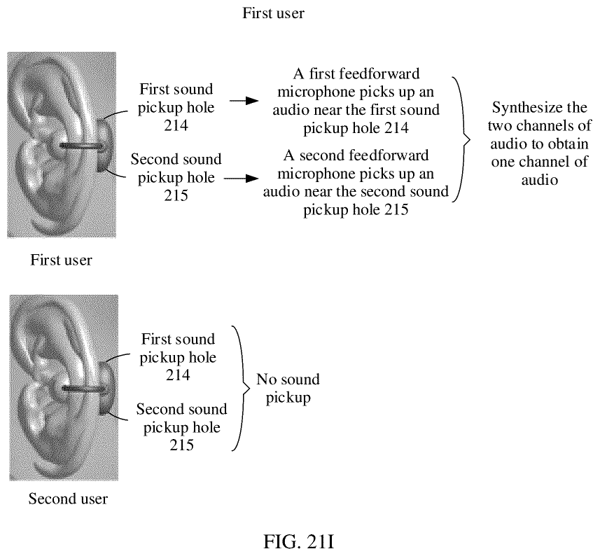

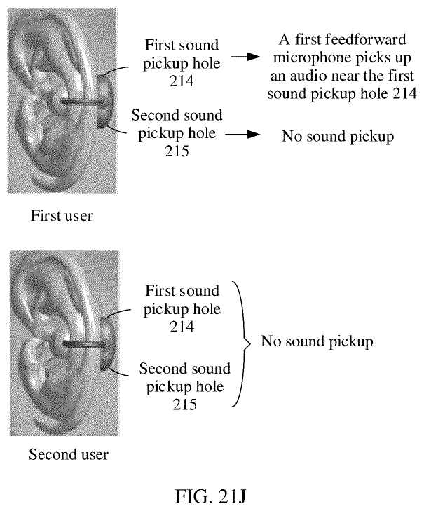

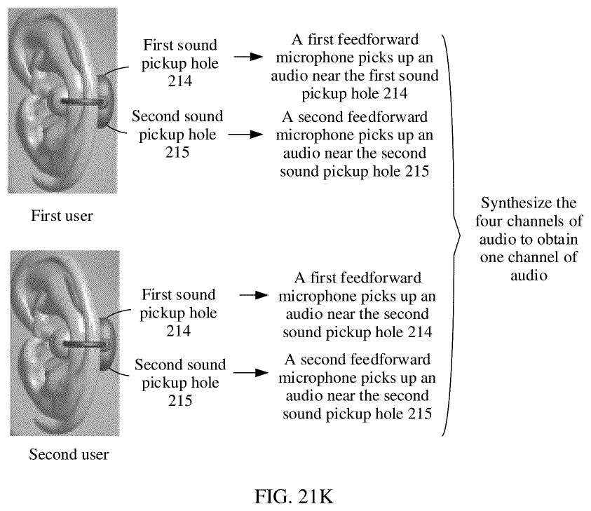

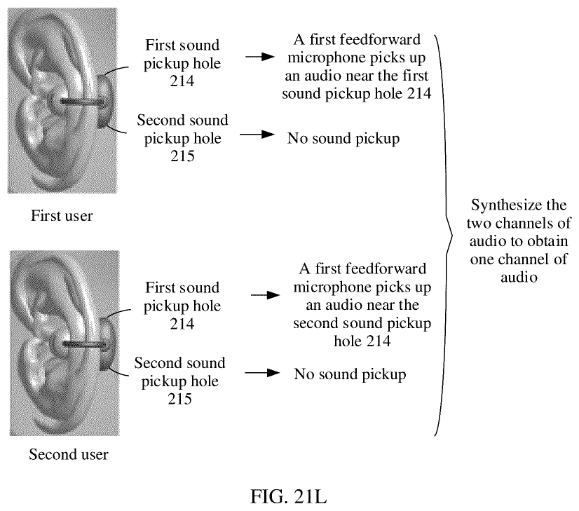

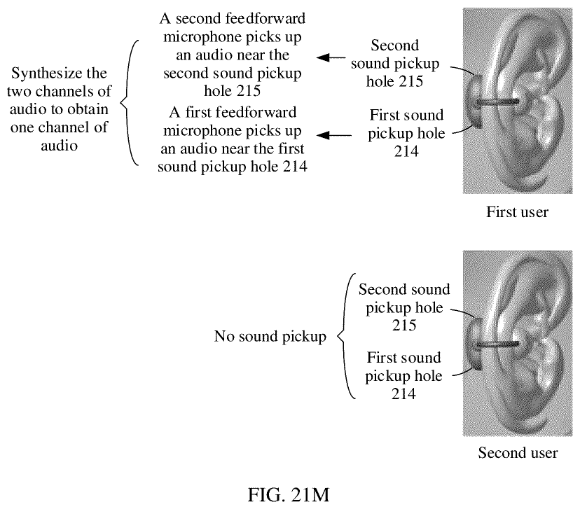

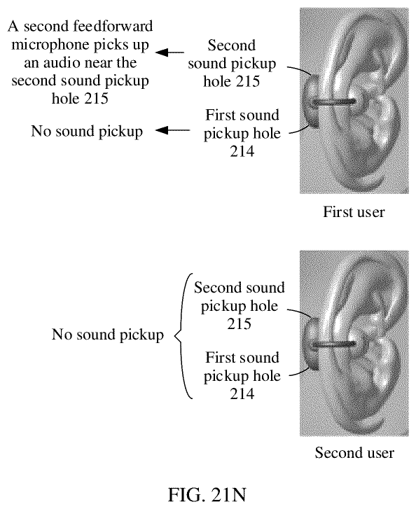

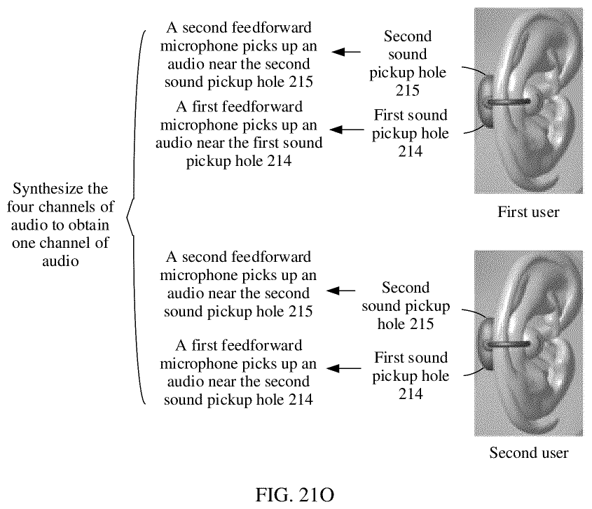

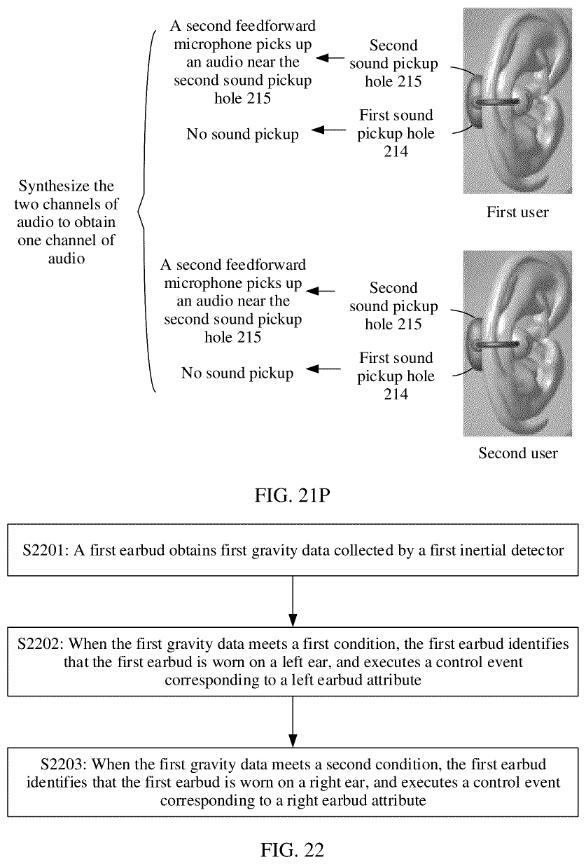

As shown in FIG. 21A, when the first earbud in the earphone 1000 is worn on the left ear of the user, the first feedforward microphone is located above the second feedforward microphone, and correspondingly, the first sound pickup hole 214 is also located above the second sound pickup hole 215.

In a possible implementation, as shown in FIG. 21A, both the first feedforward microphone and the second feedforward microphone in the first earbud may be enabled and operate, the first feedforward microphone may pick up a sound near the first sound pickup hole 214, the second feedforward microphone may pick up a sound near the second sound pickup hole 215, and the first earbud then synthesizes the two channels of data according to an algorithm to obtain one channel of mixed audio, and then sends the channel of mixed audio to an electronic device that establishes a communication connection to the first earbud.

In another possible implementation, as shown in FIG. 21B, the first earbud may enable the first feedforward microphone, and pick up a sound near the first sound pickup hole 214 by the first feedforward microphone. The second feedforward microphone is not enabled. The first earbud sends only the audio picked up by the first feedforward microphone to an electronic device that establishes a communication connection to the first earbud. In this way, the first feedforward microphone is located above the second feedforward microphone, quality of the audio picked up by the first feedforward microphone is higher than that of the audio picked up by the second feedforward microphone, and the first earbud may choose to pick up the audio via the first feedforward microphone with the high quality of the picked-up audio. This not only can improve the quality of the audio picked up by the first earbud but also can reduce power consumption of the first earbud.

In some embodiments, the first earbud may alternatively enable the second feedforward microphone, and pick up a sound near the second sound pickup hole 215 by the second feedforward microphone. The first feedforward microphone is not enabled. This is not limited in the present disclosure. In the present disclosure, only an example in which the first feedforward microphone is enabled is used for description.

(2) The first earbud in the earphone 1000 is worn on the right ear of the user.

As shown in FIG. 21C, when the first earbud in the earphone 1000 is worn on the right ear of the user, the second feedforward microphone is located above the first feedforward microphone, and correspondingly, the second sound pickup hole 215 is also located above the first sound pickup hole 214.

In a possible implementation, as shown in FIG. 21C, both the first feedforward microphone and the second feedforward microphone in the first earbud may be enabled and operate, the first feedforward microphone may pick up a sound near the first sound pickup hole 214, the second feedforward microphone may pick up a sound near the second sound pickup hole 215, and the first earbud then synthesizes the two channels of data according to an algorithm to obtain one channel of mixed audio, and then sends the channel of mixed audio to an electronic device that establishes a communication connection to the first earbud.

In another possible implementation, as shown in FIG. 21D, the first earbud may enable the second feedforward microphone, and pick up a sound near the second sound pickup hole 215 by the second feedforward microphone. The first feedforward microphone is not enabled. The first earbud sends only the audio picked up by the second feedforward microphone to an electronic device that establishes a communication connection to the first earbud. In this way, the second feedforward microphone is located above the first feedforward microphone, quality of the audio picked up by the second feedforward microphone is higher than that of the audio picked up by the first feedforward microphone, and the first earbud may choose to pick up the audio via the second feedforward microphone with the high quality of the picked-up audio. This not only can improve the quality of the audio picked up by the first earbud, but also can reduce power consumption of the first earbud.

2. Scenario in which the Two Earbuds are Worn

When both the two earbuds in the earphone 1000 are in the worn state, the first earbud and the second earbud in the earphone 1000 may be respectively worn on a left ear and a right ear of a same user, or the first earbud and the second earbud may be respectively worn on a left ear and a right ear of two different users, or the first earbud and the second earbud may be respectively worn on left ears of two different users, or the first earbud and the second earbud may be respectively worn on right ears of two different users.

(1) Both the first earbud and the second earbud are worn on the left ear and the right ear of the same user.

As shown in FIG. 21E, the first earbud may be worn on the left ear of the first user, and the second earbud may be worn on the right ear of the first user.

In response to that the first earbud is worn on the left ear of the first user, the first feedforward microphone is located above the second feedforward microphone, and correspondingly, the first sound pickup hole 214 is also located above the second sound pickup hole 215.

In response to that the second earbud is worn on the right ear of the first user, the second feedforward microphone is located above the first feedforward microphone, and correspondingly, the second sound pickup hole 215 is also located above the first sound pickup hole 214.

In some embodiments, the earphone 1000 may determine a primary earbud based on information such as a sequence of wearing the first earbud and the second earbud, or a remaining battery level of the first earbud and a remaining battery level of the second earbud. A feedforward microphone in the primary earbud picks up a sound, and a feedforward microphone in a non-primary earbud does not pick up a sound.

For example, when wearing time of the first earbud is earlier than wearing time of the second earbud, the earphone 1000 may determine that the primary earbud is the first earbud.

For another example, when the remaining battery level of the first earbud is greater than the remaining battery level of the second earbud, the earphone 1000 may determine that the primary earbud is the first earbud.

In addition to determining the primary earbud from the two earbuds based on the information such as the wearing sequence and the remaining battery levels, the primary earbud may alternatively be determined based on other information. For example, the user may alternatively actively operate to set the first earbud as the primary earbud. This is not limited in the present disclosure.

After the first earbud is determined as the primary earbud, the first feedforward microphone and the second feedforward microphone in the second earbud do not operate, and the earphone 1000 may determine a primary mic on the primary earbud based on the first feedforward microphone and the second feedforward microphone.

In a possible implementation, as shown in FIG. 21E, both the first feedforward microphone and the second feedforward microphone in the first earbud may be enabled and operate, the first feedforward microphone may pick up a sound near the first sound pickup hole 214, the second feedforward microphone may pick up a sound near the second sound pickup hole 215, and the first earbud then synthesizes the two channels of data according to an algorithm to obtain one channel of mixed audio, and then sends the channel of mixed audio to an electronic device that establishes a communication connection to the first earbud.

In another possible implementation, both the first feedforward microphone and the second feedforward microphone in the first earbud may be enabled and pick up sounds. However, the earbud may identify a microphone whose audio quality is good, determine one channel of audio with good audio quality, and send the channel of audio to the electronic device that establishes the communication connection to the earphone.

In another possible implementation, as shown in FIG. 21F, the first earbud may enable the second feedforward microphone, and pick up a sound near the second sound pickup hole 215 by the second feedforward microphone. The first feedforward microphone is not enabled. The first earbud sends only the audio picked up by the second feedforward microphone to an electronic device that establishes a communication connection to the first earbud. In this way, the second feedforward microphone is located above the first feedforward microphone, quality of the audio picked up by the second feedforward microphone is higher than that of the audio picked up by the first feedforward microphone, and the first earbud may choose to pick up the audio via the second feedforward microphone with the high quality of the picked-up audio. This not only can improve the quality of the audio picked up by the first earbud, but also can reduce power consumption of the first earbud.

In FIG. 21E to FIG. 21F, the first feedforward microphone and the second feedforward microphone in the second earbud do not operate, and only the first feedforward microphone and/or the second feedforward microphone in the first earbud pick/picks up sounds/a sound.

In another embodiment, when both the first earbud and the second earbud are in the worn state, the electronic device 100 may determine that the first earbud is the primary earbud, but both feedforward microphones in the first earbud and the second earbud need to pick up sounds. The first earbud then synthesizes the audio picked up by the first earbud and the audio picked up by the second earbud into one channel of audio, and then sends the channel of audio to an electronic device that establishes a communication connection to the earphone 1000.

In a possible implementation, as shown in FIG. 21G, both the first feedforward microphone and the second feedforward microphone in the first earbud are enabled, and both the first feedforward microphone and the second feedforward microphone in the second earbud are enabled. The first earbud may pick up the audio near the first sound pickup hole 214 by the first feedforward microphone and pick up the audio near the second sound pickup hole 215 by the second feedforward microphone. The second earbud may pick up the audio near the second sound pickup hole 215 by the second feedforward microphone and pick up the audio near the first sound pickup hole 214 by the first feedforward microphone. The first earbud (the primary earbud) then synthesizes the four channels of audio into one channel of audio and sends the channel of audio to the electronic device that establishes the communication connection to the earphone.

In another possible implementation, both the first feedforward microphone and the second feedforward microphone in the first earbud may be enabled and pick up sounds, and both the first feedforward microphone and the second feedforward microphone in the second earbud are also enabled and pick up sounds. However, the earbud may identify a microphone whose audio quality is good, determine one channel of audio with good audio quality, and send the channel of audio to the electronic device that establishes the communication connection to the earphone.

The audio quality may include but is not limited to: a larger low-frequency signal indicates better audio quality. The earphone may select, from two channels of audio, one channel of audio with a large low-frequency signal as an audio to be sent to the electronic device that establishes the communication connection to the earphone. The larger low-frequency signal indicates a smaller wind noise, which helps improve effect of active noise reduction.

The audio quality may alternatively be measured based on another standard. The low-frequency signal is merely an example for description, and does not constitute a limitation.

In another possible implementation, as shown in FIG. 21H, the first feedforward microphone in the first earbud and the second feedforward microphone in the second earbud are enabled, and the second feedforward microphone in the first earbud and the second feedforward microphone 273 in the second earbud are disabled. The first earbud may pick up the audio near the first sound pickup hole 214 by the first feedforward microphone, and the second earbud may pick up the audio near the second sound pickup hole 215 by the second feedforward microphone. The first earbud (the primary earbud) then synthesizes the two channels of audio into one channel of audio and sends the channel of audio to the electronic device that establishes the communication connection to the earphone.

In another possible implementation, the first feedforward microphone in the first earbud and the second feedforward microphone in the second earbud are enabled and pick up sounds. However, the earbud may identify a microphone whose audio quality is good, determine one channel of audio with good audio quality, and send the channel of audio to the electronic device that establishes the communication connection to the earphone.

In another possible implementation, the first feedforward microphone in the first earbud and the second feedforward microphone in the first earbud may be enabled and pick up sounds, and the second feedforward microphone in the second earbud may be enabled and pick up a sound.

In another possible implementation, the first feedforward microphone in the first earbud may be enabled and pick up sounds, and the first feedforward microphone and the second feedforward microphone in the second earbud may be enabled and pick up sounds.

(2) The first earbud and the second earbud are respectively worn on the left ear and the right ear of the two different users.

When the first earbud and the second earbud are respectively worn on the left ear and the right ear of the two different users, for example, the first earbud is worn on the left ear of the first user, and the second earbud is worn on the right ear of the second user. In this case, for how to determine the primary mic, refer to descriptions in FIG. 21E to FIG. 21H. Details are not described herein again in the present disclosure.

(3) The first earbud and the second earbud are respectively worn on the left ears of the two different users.

As shown in FIG. 211, the first earbud may be worn on the left ear of the first user, and the second earbud may be worn on the left ear of the second user.

In response to that the first earbud is worn on the left ear of the first user, the first feedforward microphone is located above the second feedforward microphone, and correspondingly, the first sound pickup hole 214 is also located above the second sound pickup hole 215.

In response to that the second earbud is worn on the left ear of the second user, the first feedforward microphone is located above the second feedforward microphone, and correspondingly, the first sound pickup hole 214 is also located above the second sound pickup hole 215.

In some embodiments, the earphone 1000 may determine a primary earbud based on information such as a sequence of wearing the first earbud and the second earbud, or a remaining battery level of the first earbud and a remaining battery level of the second earbud. A feedforward microphone in the primary earbud picks up a sound, and a feedforward microphone in a non-primary earbud does not pick up a sound.

For example, when wearing time of the first earbud is earlier than wearing time of the second earbud, the earphone 1000 may determine that the primary earbud is the first earbud.

For another example, when the remaining battery level of the first earbud is greater than the remaining battery level of the second earbud, the earphone 1000 may determine that the primary earbud is the first earbud.

In addition to determining the primary earbud from the two earbuds based on the information such as the wearing sequence and the remaining battery levels, the primary earbud may alternatively be determined based on other information. For example, the user may alternatively actively operate to set the first earbud as the primary earbud. This is not limited in the present disclosure.

After the first earbud is determined as the primary earbud, the first feedforward microphone and the second feedforward microphone in the second earbud do not operate, and the earphone 1000 may determine the primary mic on the primary earbud based on the first feedforward microphone and the second feedforward microphone in the first earbud.

In a possible implementation, as shown in FIG. 21I, both the first feedforward microphone and the second feedforward microphone in the first earbud may be enabled and operate, the first feedforward microphone may pick up a sound near the first sound pickup hole 214, the second feedforward microphone may pick up a sound near the second sound pickup hole 215, and the first earbud then synthesizes the two channels of data according to an algorithm to obtain one channel of mixed audio, and then sends the channel of mixed audio to an electronic device that establishes a communication connection to the first earbud.

In another possible implementation, both the first feedforward microphone and the second feedforward microphone in the first earbud may be enabled and pick up sounds. However, the earbud may identify a microphone whose audio quality is good, determine one channel of audio with good audio quality, and send the channel of audio to the electronic device that establishes the communication connection to the earphone.

In another possible implementation, as shown in FIG. 21J, the first earbud may enable the first feedforward microphone, and pick up a sound near the second sound pickup hole 215 by the second feedforward microphone. The second feedforward microphone is not enabled. The first earbud sends only the audio picked up by the first feedforward microphone to an electronic device that establishes a communication connection to the first earbud. In this way, the first feedforward microphone is located above the second feedforward microphone, quality of the audio picked up by the first feedforward microphone is higher than that of the audio picked up by the second feedforward microphone, and the first earbud may choose to pick up the audio via the first feedforward microphone with the high quality of the picked-up audio. This not only can improve the quality of the audio picked up by the first earbud, but also can reduce power consumption of the first earbud.

In FIG. 21J to FIG. 21J, the first feedforward microphone and the second feedforward microphone in the second earbud do not operate, and only the first feedforward microphone and/or the second feedforward microphone in the first earbud pick/picks up sounds/a sound.

In another embodiment, when both the first earbud and the second earbud are in the worn state, the electronic device 100 may determine that the first earbud is the primary earbud, but both feedforward microphones in the first earbud and the second earbud need to pick up sounds. The first earbud then synthesizes the audio picked up by the first earbud and the audio picked up by the second earbud into one channel of audio, and then sends the channel of audio to an electronic device that establishes a communication connection to the earphone 1000.

In a possible implementation, as shown in FIG. 21K, both the first feedforward microphone and the second feedforward microphone in the first earbud are enabled, and both the first feedforward microphone and the second feedforward microphone in the second earbud are enabled. The first earbud may pick up the audio near the first sound pickup hole 214 by the first feedforward microphone and pick up the audio near the second sound pickup hole 215 by the second feedforward microphone. The second earbud may pick up the audio near the second sound pickup hole 215 by the second feedforward microphone and pick up the audio near the first sound pickup hole 214 by the first feedforward microphone. The first earbud (the primary earbud) then synthesizes the four channels of audio into one channel of audio and sends the channel of audio to the electronic device that establishes the communication connection to the earphone.

In another possible implementation, both the first feedforward microphone and the second feedforward microphone in the first earbud are enabled and pick up sounds, and both the first feedforward microphone and the second feedforward microphone in the second earbud are enabled and pick up sounds. However, the earbud may identify a microphone whose audio quality is good, determine one channel of audio with good audio quality, and send the channel of audio to the electronic device that establishes the communication connection to the earphone.

In another possible implementation, as shown in FIG. 21L, the first feedforward microphone in the first earbud and the first feedforward microphone in the second earbud are enabled, and the second feedforward microphone in the first earbud and the second feedforward microphone in the second earbud are disabled. The first earbud may pick up the audio near the first sound pickup hole 214 by the first feedforward microphone, and the second earbud may pick up the audio near the first sound pickup hole 214 by the first feedforward microphone. The first earbud (the primary earbud) then synthesizes the two channels of audio into one channel of audio and sends the channel of audio to the electronic device that establishes the communication connection to the earphone.

In another possible implementation, both the first feedforward microphone in the first earbud and the first feedforward microphone in the second earbud are enabled and pick up sounds, and both the first feedforward microphone and the second feedforward microphone in the second earbud are enabled and pick up sounds. However, the earbud may identify a microphone whose audio quality is good, determine one channel of audio with good audio quality, and send the channel of audio to the electronic device that establishes the communication connection to the earphone.

In another possible implementation, the first feedforward microphone in the first earbud and the second feedforward microphone in the first earbud may be enabled and pick up sounds, and the first feedforward microphone in the second earbud may be enabled and pick up a sound.

In another possible implementation, the first feedforward microphone in the first earbud may be enabled and pick up sounds, and the first feedforward microphone and the second feedforward microphone in the second earbud may be enabled and pick up sounds.

(4) The first earbud and the second earbud are respectively worn on the right ears of the two different users.

As shown in FIG. 21M, the first earbud may be worn on the right ear of the first user, and the second earbud may be worn on the right ear of the second user.

In response to that the first earbud is worn on the right ear of the first user, the second feedforward microphone is located above the first feedforward microphone, and correspondingly, the second sound pickup hole 215 is also located above the first sound pickup hole 214.

In response to that the second earbud is worn on the right ear of the second user, the second feedforward microphone is located above the first feedforward microphone, and correspondingly, the second sound pickup hole 215 is also located above the first sound pickup hole 214.

In some embodiments, the earphone 1000 may determine a primary earbud based on information such as a sequence of wearing the first earbud and the second earbud, or a remaining battery level of the first earbud and a remaining battery level of the second earbud. A feedforward microphone in the primary earbud picks up a sound, and a feedforward microphone in a non-primary earbud does not pick up a sound.

For example, when wearing time of the first earbud is earlier than wearing time of the second earbud, the earphone 1000 may determine that the primary earbud is the first earbud.

For another example, when the remaining battery level of the first earbud is greater than the remaining battery level of the second earbud, the earphone 1000 may determine that the primary earbud is the first earbud.

In addition to determining the primary earbud from the two earbuds based on the information such as the wearing sequence and the remaining battery levels, the primary earbud may alternatively be determined based on other information. For example, the user may alternatively actively operate to set the first earbud as the primary earbud. This is not limited in the present disclosure.

After the first earbud is determined as the primary earbud, the first feedforward microphone and the second feedforward microphone in the second earbud do not operate, and the earphone 1000 may determine the primary mic on the primary earbud based on the first feedforward microphone and the second feedforward microphone in the first earbud.

In a possible implementation, as shown in FIG. 21M, both the first feedforward microphone and the second feedforward microphone in the first earbud may be enabled and operate, the first feedforward microphone may pick up a sound near the first sound pickup hole 214, the second feedforward microphone may pick up a sound near the second sound pickup hole 215, and the first earbud then synthesizes the two channels of data according to an algorithm to obtain one channel of mixed audio, and then sends the channel of mixed audio to an electronic device that establishes a communication connection to the first earbud.

In another possible implementation, both the first feedforward microphone and the second feedforward microphone in the first earbud may be enabled and pick up sounds. However, the earbud may identify a microphone whose audio quality is good, determine one channel of audio with good audio quality, and send the channel of audio to the electronic device that establishes the communication connection to the earphone.

In another possible implementation, as shown in FIG. 21N, the first earbud may enable the second feedforward microphone, and pick up a sound near the second sound pickup hole 215 by the second feedforward microphone. The first feedforward microphone is not enabled. The first earbud sends only the audio picked up by the second feedforward microphone to an electronic device that establishes a communication connection to the first earbud. In this way, the second feedforward microphone is located above the first feedforward microphone, quality of the audio picked up by the second feedforward microphone is higher than that of the audio picked up by the first feedforward microphone, and the first earbud may choose to pick up the audio via the second feedforward microphone with the high quality of the picked-up audio. This not only can improve the quality of the audio picked up by the first earbud, but also can reduce power consumption of the first earbud.

In FIG. 21M to FIG. 21N, the first feedforward microphone and the second feedforward microphone in the second earbud do not operate, and only the first feedforward microphone and/or the second feedforward microphone in the first earbud pick/picks up sounds/a sound.

In another embodiment, when both the first earbud and the second earbud are in the worn state, the electronic device 100 may determine that the first earbud is the primary earbud, but both feedforward microphones in the first earbud and the second earbud need to pick up sounds. The first earbud then synthesizes the audio picked up by the first earbud and the audio picked up by the second earbud into one channel of audio, and then sends the channel of audio to an electronic device that establishes a communication connection to the earphone 1000.

In a possible implementation, as shown in FIG. 210, both the first feedforward microphone and the second feedforward microphone in the first earbud are enabled, and both the first feedforward microphone and the second feedforward microphone in the second earbud are enabled. The first earbud may pick up the audio near the first sound pickup hole 214 by the first feedforward microphone and pick up the audio near the second sound pickup hole 215 by the second feedforward microphone. The second earbud may pick up the audio near the second sound pickup hole 215 by the second feedforward microphone and pick up the audio near the first sound pickup hole 214 by the first feedforward microphone. The first earbud (the primary earbud) then synthesizes the four channels of audio into one channel of audio and sends the channel of audio to the electronic device that establishes the communication connection to the earphone.

In another possible implementation, both the first feedforward microphone and the second feedforward microphone in the first earbud are enabled and pick up sounds, and both the first feedforward microphone and the second feedforward microphone in the second earbud are also enabled and pick up sounds. However, the earbud may identify a microphone whose audio quality is good, determine one channel of audio with good audio quality, and send the channel of audio to the electronic device that establishes the communication connection to the earphone.

In another possible implementation, as shown in FIG. 21P, the second feedforward microphone in the first earbud and the second feedforward microphone in the second earbud are enabled, and the first feedforward microphone in the first earbud and the first feedforward microphone in the second earbud are disabled. The first earbud may pick up the audio near the second sound pickup hole 215 by the second feedforward microphone, and the second earbud may pick up the audio near the second sound pickup hole 215 by the second feedforward microphone. The first earbud (the primary earbud) then synthesizes the two channels of audio into one channel of audio and sends the channel of audio to the electronic device that establishes the communication connection to the earphone.

In another possible implementation, the second feedforward microphone in the first earbud and the second feedforward microphone in the second earbud are enabled and pick up sounds. However, the earbud may identify a microphone whose audio quality is good, determine one channel of audio with good audio quality, and send the channel of audio to the electronic device that establishes the communication connection to the earphone.

In another possible implementation, the first feedforward microphone in the first earbud and the second feedforward microphone in the first earbud may be enabled and pick up sounds, and the second feedforward microphone in the second earbud may be enabled and pick up a sound.

In another possible implementation, the second feedforward microphone in the first earbud may be enabled and pick up sounds, and the first feedforward microphone and the second feedforward microphone in the second earbud may be enabled and pick up sounds.

In some embodiments, the first earbud or the second earbud may alternatively include only one microphone.

When the first earbud or the second earbud includes only one microphone, when a single earbud is worn, a sound is picked up by one microphone in the earbud.

If two earbuds are worn at the same time, the earphone earbud needs to identify whether the earphone is worn on the left ear or the right ear. For example, both the first earbud and the second earbud include the first microphone.

The first earbud and the second earbud are respectively worn on the left ear and the right ear.

When the first earbud is worn on the left ear, as shown in FIG. 21A, the first microphone in the first earbud is configured to collect an audio near the first sound pickup hole 214.

When the second earbud is worn on the right ear, as shown in FIG. 21C, the second microphone in the second earbud is configured to collect an audio near the first sound pickup hole 214.

The first microphone in the first earbud is located above the second microphone in the second earbud in a relative manner, and quality of the sound picked up by the first microphone in the first earbud is better than that of the sound picked up by the second microphone in the second earbud. The first microphone in the first earbud is preferentially enabled, and the sound is picked up by the first microphone in the first earbud.

In other words, in a scenario in which the two earbuds are worn at the same time, the earphone identifies whether the earphone is worn on the left ear or the right ear. The microphone for picking up the sound may be determined based on relative positions of two microphones in the two earbuds. For example, a microphone whose relative position is away from the ground may be determined from the two microphones to pick up a sound.

In another possible implementation, a first microphone in the first earbud and a second microphone in the second earbud are enabled and pick up sounds. However, the earbud may identify a microphone whose audio quality is good, determine one channel of audio with good audio quality, and send the channel of audio to the electronic device that establishes the communication connection to the earphone.

A specific implementation in which the first earbud is worn on the right ear and the second earbud is worn on the left ear is similar to the specific implementation in which the first earbud is worn on the left ear and the second earbud is worn on the right ear. Details are not described herein in the present disclosure.

The first earbud and the second earbud are respectively worn on the left ears of the two users.

When the first earbud is worn on the left ear, as shown in FIG. 21J, the first microphone in the first earbud is configured to collect an audio near the first sound pickup hole 214.

When the second earbud is worn on the left ear, as shown in FIG. 21J, the second microphone in the second earbud is configured to collect an audio near the first sound pickup hole 214.

A position of the first microphone in the first earbud is parallel to a position of the second microphone in the second earbud.

In a possible implementation, either the first microphone in the first earbud or the second microphone in the second earbud may be selected to be enabled. This helps determine, based on a wearing sequence, remaining battery levels, or the like, which microphone is to be enabled.

In another possible implementation, both the first microphone in the first earbud and the second microphone in the second earbud may be enabled and pick up sounds. However, the earbud may identify a microphone whose audio quality is good, determine one channel of audio with good audio quality, and send the channel of audio to the electronic device that establishes the communication connection to the earphone.

In another possible implementation, both the first microphone in the first earbud and the second microphone in the second earbud may be enabled and pick up sounds, and the two channels of audio are synthesized into one channel of audio and sent to the electronic device that establishes the communication connection to the earphone.

A specific implementation in which the first earbud and the second earbud are respectively worn on the right ears of the two users is similar to the specific implementation in which the first earbud and the second earbud are respectively worn on the left ears of the two users. Details are not described herein again in the present disclosure.

FIG. 22 is a schematic flowchart of an earphone control method according to the present disclosure.

S2201: A first earbud obtains first gravity data collected by a first inertial detector.

S2202: When the first gravity data meets a first condition, the first earbud identifies that the first earbud is worn on a left ear, and executes a control event corresponding to a left earbud attribute.

S2203: When the first gravity data meets a second condition, the first earbud identifies that the first earbud is worn on a right ear, and executes a control event corresponding to a right earbud attribute.

When the first earbud provided in the present disclosure is being worn, there is no need to distinguish between the left ear and the right ear. The first earbud may be worn on the left ear of a user, or the first earbud may be worn on the right ear of the user. In this way, portability of using the earbud is improved.

However, after the first earbud is worn, the first earbud needs to identify whether the first earbud is worn on the left ear or the right ear and executes different control events based on that the first earbud is worn on the left ear or the right ear.

In some embodiments of the present disclosure, the first earbud may determine, based on the gravity data collected by the preset first inertial detector, whether the first earbud is worn on the left ear or the right ear. This improves flexibility of using a wearable device by the user, and improves use experience of wearing the wearable device by the user.

In a possible implementation, the wearable device further includes a second earbud, the second earbud includes a second inertial detector, and the method further includes: The second earbud obtains second gravity data collected by the second inertial detector; and when the second gravity data meets the first condition, the second earbud identifies that the second earbud is worn on a left ear, and executes a control event corresponding to a left earbud attribute; or when the second gravity data meets the second condition, the second earbud identifies that the second earbud is worn on a right ear, and executes a control event corresponding to a right earbud attribute.

The wearable device may include two earbuds, that is, the first earbud and the second earbud. Similar to the first earbud, when the second earbud is being worn, there is no need to distinguish between the left ear and the right ear. The second earbud may be worn on the left ear of a user, or the second earbud may be worn on the right ear of the user. In this way, portability of using the earbud is improved.

However, after the second earbud is worn, the second earbud needs to identify whether the second earbud is worn on the left ear or the right ear, and executes different control events based on that the second earbud is worn on the left ear or the right ear. This improves flexibility of using the wearable device by the user, and improves use experience of wearing the wearable device by the user.

Only one of the first earbud and the second earbud may be in a worn state, or both the first earbud and the second earbud may be in a worn state.

In a possible implementation, the first earbud includes a first earbud body, a cantilever arm, and a second earbud body, the cantilever arm is connected between the first earbud body and the second earbud body, and the first earbud body and the second earbud body are disposed opposite to each other and have an initial distance; the cantilever arm is deformable, deformation of the cantilever arm can adjust the initial distance between the first earbud body and the second earbud body to an adjustment distance, a connection line between a geometric center of the second earbud body and a geometric center of the first earbud body is defined as a Z axis, and a direction in which the geometric center of the second earbud body points to the geometric center of the first earbud body is defined as a positive direction of the Z axis; a straight line that passes through a geometric center of an end face on which the cantilever arm is connected to the second earbud body and that is perpendicular to the end face is defined as a Y axis, and a direction in which the geometric center of the end face points to the cantilever arm is defined as a positive direction of the Y axis; and a straight line perpendicular to both the Z axis and the Y axis is defined as an X axis, where when the first earbud is worn on the left ear, a positive direction of the X axis points to the ground; and when a user is standing or sitting, the first condition includes: a gravity component of the gravity data in the positive direction of the X axis is a positive value; or when a user is standing or sitting, the second condition includes: a gravity component of the gravity data in the positive direction of the X axis is a negative value. For details, refer to the description in the embodiment in FIG. 2.

In another embodiment, the first condition may further include any one or more of the following: an acceleration component of a gravity acceleration G on the Z axis is close to a minimum value, and an acceleration component of the gravity acceleration G on the Y axis is close to a minimum value.

In another embodiment, the second condition may further include any one or more of the following: an acceleration component of a gravity acceleration G on the Z axis is close to a minimum value, and an acceleration component of the gravity acceleration G on the Y axis is close to a minimum value.

In some embodiments, the first earbud or the second earbud may further identify whether the first earbud or the second earbud is worn properly. After the first earbud or the second earbud is worn properly, accuracy for identifying whether the first earbud or the second earbud is worn on the left ear or the right ear can be improved. When the first earbud or the second earbud is not worn properly, the first earbud or the second earbud may prompt the user to wear the earbud in a proper posture until the first earbud or the second earbud is worn properly.

In some embodiments, after the first earbud or the second earbud is taken out from a charging case, and after the first earbud or the second earbud detects that the first earbud or the second earbud is worn, the first earbud or the second earbud may output an alert tone, where the alert tone is used to prompt the user to wear the earbud properly, to avoid inaccuracy for identifying whether the first earbud or the second earbud is worn on the left ear or the right ear because the user does not wear the earbud properly.

In some embodiments, after the first earbud or the second earbud is taken out from the charging case, and after the first earbud or the second earbud detects that the first earbud or the second earbud is worn, the first earbud or the second earbud may output an alert tone, where the alert tone is used to prompt the user to wear the earbud properly. After the user wears the first earbud or the second earbud, the first earbud or the second earbud may further identify whether the first earbud or the second earbud is worn properly. When the first earbud or the second earbud is not worn properly, the first earbud or the second earbud may prompt the user to wear the earbud in a proper posture until the first earbud or the second earbud is worn properly.

According to the foregoing manner, accuracy for identifying whether the first earbud or the second earbud is worn on the left ear or the right ear can be improved.

For how an earphone identifies whether the earphone is worn on the left ear or the right ear when the user is sitting and standing, refer to the descriptions in the embodiments in FIG. 10 to FIG. 13 and FIG. 14A and FIG. 14B. Details are not described herein again in the present disclosure.

In a possible implementation, when the user is left-side lying, the first condition includes: a gravity component of the gravity data on the Y axis is a positive value; or when the user is left-side lying, the second condition includes: a gravity component of the gravity data in the positive direction of the Y axis is a negative value.

In another embodiment, the first condition may further include: a gravity acceleration component of the gravity acceleration G on the X axis is a minimum value. The second condition may further include: a gravity acceleration component of the gravity acceleration G on the X axis is a minimum value.

For how an earphone identifies whether the earphone is worn on the left ear or the right ear when the user is left-side lying, refer to the description in the embodiment in FIG. 16D. Details are not described herein again in the present disclosure.

In a possible implementation, when the user is right-side lying, the first condition includes: a gravity component of the gravity data in the positive direction of the Y axis is a negative value; or when the user is right-side lying, the second condition includes: a gravity component of the gravity data in the positive direction of the Y axis is a positive value.

In another embodiment, the first condition may further include: a gravity acceleration component of the gravity acceleration G on the X axis is a minimum value. The second condition may further include: a gravity acceleration component of the gravity acceleration G on the X axis is a minimum value.

For how an earphone identifies whether the earphone is worn on the left ear or the right ear when the user is right-side lying, refer to the description in the embodiment in FIG. 16C. Details are not described herein again in the present disclosure.

In a possible implementation, the first earbud body includes a first capacitive sensor, and the second earbud body includes a second capacitive sensor; and before the first earbud obtains the gravity data collected by the inertial detector, the method further includes: The first earbud obtains a first capacitance value collected by the first capacitive sensor and a second capacitance value collected by the second capacitive sensor; and when the first capacitance value is greater than a first threshold and the second capacitance value is greater than a second threshold, the first earbud determines that the first earbud is in a worn state.

In some embodiments, for people with different ear shapes and different wearing angles, a scenario in which the second earbud body is not attached to an ear or the first earbud body is not attached to an ear may occur. To improve accuracy of wearing identification, the earphone may identify, via the first capacitive sensor and the second capacitive sensor, whether the user wears the earphone.

When the user wears the earphone, the capacitive sensor can be closely attached to an auricle of the user, and form a specific capacitance difference due to applied pressure, to determine that the user is wearing the earphone. When the user does not wear the earphone, the capacitive sensor is not pressed. In this case, a capacitance difference is stable, and it may be determined that the user does not wear the earphone.

In some embodiments, the first earbud may alternatively determine, based on only the first capacitance value collected by the first capacitive sensor or the second capacitance value collected by the second capacitive sensor, whether the user is wearing the earbud.

In a possible implementation, that the first earbud obtains the first gravity data collected by the first inertial detector specifically includes: when the first earbud determines that the first earbud is in the worn state, the first earbud obtains the first gravity data collected by the first inertial detector.

Only when identifying that the first earbud is in the worn state, the first earbud determines, based on the first gravity data collected by the first inertial detector, whether the first earbud is worn on the left ear or the right ear. When identifying that the first earbud is in an unworn state, the first earbud does not perform determining based on the first gravity data collected by the first inertial detector, so that power consumption of the first earbud can be reduced.

In a possible implementation, that the first earbud determines that the first earbud is in the worn state specifically includes: The first earbud obtains a first capacitance error value corresponding to a first ambient temperature; the first earbud obtains a first target capacitance value based on the first capacitance value and the first capacitance error value, and obtains a second target capacitance value based on the second capacitance value and the first capacitance error value; and when the first target capacitance value is greater than the first threshold and the second target capacitance value is greater than the second threshold, the first earbud determines that the first earbud is in the worn state.

It should be noted that different ambient temperatures correspond to different capacitance error values.

In some embodiments, the capacitance value collected by the capacitive sensor is easily affected by a temperature, and different temperatures have different impact on the capacitance value collected by the capacitive sensor. To improve accuracy for identifying a wearing status, the earphone identifies, based on both the capacitance difference and temperature compensation, whether the earphone is in the worn state or the unworn state.

In a possible implementation, the method includes: when the first earbud identifies that the first earbud is worn on a left ear of a first user, the first earbud executes a control event corresponding to a left earbud attribute; and when the second earbud identifies that the first earbud is worn on a right ear of the first user, the second earbud executes a control event corresponding to a right earbud attribute.

In this way, the first earbud and the second earbud may be worn on a left ear and a right ear of a same user at the same time.

In a possible implementation, the method includes: when the first earbud identifies that the first earbud is worn on a left ear of a first user, the first earbud executes a control event corresponding to a left earbud attribute; and when the second earbud identifies that the first earbud is worn on a right ear of a second user, the second earbud executes a control event corresponding to a right earbud attribute.

In this way, the first earbud and the second earbud may be worn on a left ear and a right ear of different users at the same time.

In a possible implementation, the method includes: when the first earbud identifies that the first earbud is worn on a left ear of a first user, the first earbud executes a control event corresponding to a left earbud attribute; and when the second earbud identifies that the first earbud is worn on a left ear of a second user, the second earbud executes a control event corresponding to a left earbud attribute.

In this way, the first earbud and the second earbud may be worn on left ears of different users at the same time.

In a possible implementation, the method includes: when the first earbud identifies that the first earbud is worn on a right ear of a first user, the first earbud executes a control event corresponding to a right earbud attribute; and when the second earbud identifies that the first earbud is worn on a right ear of a second user, the second earbud executes a control event corresponding to a right earbud attribute.

In this way, the first earbud and the second earbud may be worn on right ears of different users at the same time.

In a possible implementation, the first earbud includes a first microphone and a second microphone, and the first microphone and the second microphone are disposed opposite to each other in the first earbud; and that when the first gravity data meets the first condition, the first earbud identifies that the first earbud is worn on the left ear, and executes the control event corresponding to the left earbud attribute specifically includes: when the first gravity data meets the first condition, the first earbud identifies that the first earbud is worn on the left ear, where the first microphone is located above the second microphone, and the first earbud enables the first microphone, and picks up an audio via the first microphone; or that when the first gravity data meets the second condition, the first earbud identifies that the first earbud is worn on the right ear, and executes the control event corresponding to the right earbud attribute specifically includes: when the first gravity data meets the second condition, the first earbud identifies that the first earbud is worn on the right ear, where the first microphone is located below the second microphone, and the first earbud enables the second microphone, and picks up an audio via the second microphone.

For example, the first microphone may be a first feedforward microphone. The second microphone may be a second feedforward microphone.

That the first microphone is located above the second microphone may mean that the first microphone is located at an end away from the ground, and the second microphone is located at an end close to the ground.

That the second microphone is located above the first microphone may mean that the second microphone is located at an end away from the ground, and the first microphone is located at an end close to the ground.

In this way, the first earbud may choose to enable different microphones based on that the first earbud is worn on the left ear or the right ear, so that not only quality of the audio collected by the microphone can be improved, but also power consumption of the first earbud can be reduced.

For details, refer to the descriptions in the embodiments in FIG. 21A to FIG. 21P. Details are not described herein again in the present disclosure.

In a possible implementation, that when the first gravity data meets the first condition, the first earbud identifies that the first earbud is worn on the left ear, and executes the control event corresponding to the left earbud attribute specifically includes: when the first gravity data meets the first condition, the first earbud identifies that the first earbud is worn on the left ear, and plays a left channel audio; or that when the first gravity data meets the second condition, the first earbud identifies that the first earbud is worn on the right ear, and executes the control event corresponding to the right earbud attribute specifically includes: when the first gravity data meets the second condition, the first earbud identifies that the first earbud is worn on the right ear, and plays a right channel audio.

In this way, the first earbud may automatically switch between a left audio channel and a right audio channel based on that the earphone identifies that the first earbud is worn on the left ear or the right ear, to improve audio playing effect.

For details, refer to the descriptions in the embodiments in FIG. 17A and FIG. 17B and FIG. 18A and FIG. 18B. Details are not described herein again in the present disclosure.

In a possible implementation, that when the first gravity data meets the first condition, the first earbud identifies that the first earbud is worn on the left ear, and executes the control event corresponding to the left earbud attribute specifically includes: when the first gravity data meets the first condition, the first earbud identifies that the first earbud is worn on the left ear, and detects and responds to a first operation performed on a first area, to perform first control, where the first area includes an area on the ear on which the first earbud is worn or an area on the first earbud; or that when the first gravity data meets the second condition, the first earbud identifies that the first earbud is worn on the right ear, and executes the control event corresponding to the right earbud attribute specifically includes: when the first gravity data meets the second condition, the first earbud identifies that the first earbud is worn on the right ear, and detects and responds to a first operation performed on a second area, to perform second control, where the second area includes an area on the ear on which the first earbud is worn or an area on the first earbud, where the first control is the same as or different from the second control, and the first control or the second control includes any one of the following: pausing audio playing, continuing audio playing, switching audio playing, adjusting volume, answering a call, and ending a call.

For example, the first area may be any one of the touch-control area 2028, the touch-control area 2029, the touch-control area 2030, and the touch-control area 2031. The second area is similar to the first area.

In this way, the first earbud may automatically adapt to different gesture control based on that the first earbud identifies that the first earbud is worn on the left ear or the right ear, so that intelligence of operating the earbud by the user based on the gesture can be improved.

For details, refer to the descriptions in the embodiments in FIG. 20A to FIG. 20K. Details are not described herein again in the present disclosure.

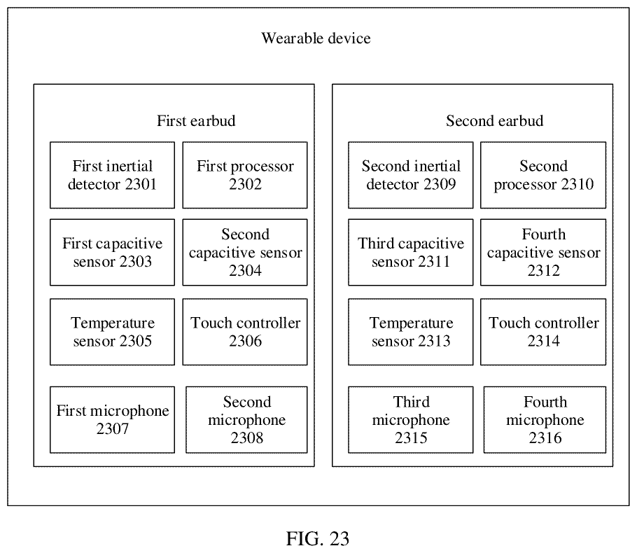

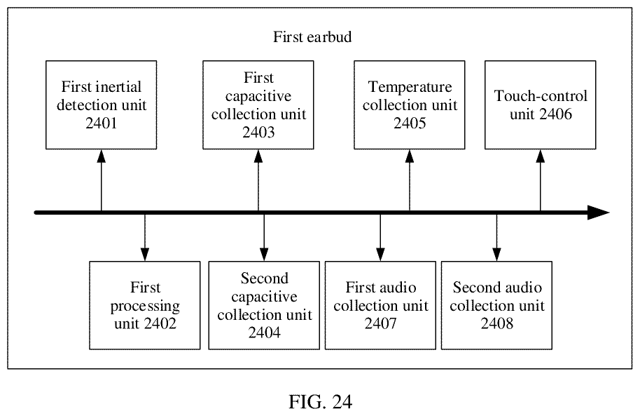

FIG. 23 is a diagram of a structure of the wearable device according to the present disclosure.

As shown in FIG. 23, the wearable device includes a first earbud, and the first earbud includes a first inertial detector 2301 and a first processor 2302; the first inertial detector 2301 is configured to collect first gravity data; the first processor 2302 is configured to obtain the first gravity data collected by the first inertial detector 2301; and the first processor 2302 is further configured to: when the first gravity data meets a first condition, identify that the first earbud is worn on a left ear, and execute a control event corresponding to a left earbud attribute; or when the first gravity data meets a second condition, identify that the first earbud is worn on a right ear, and execute a control event corresponding to a right earbud attribute.

As shown in FIG. 23, the wearable device further includes a second earbud body, and a structure of the second earbud body is similar to that of the first earbud body. For example, the second earbud body includes a third capacitive sensor 2311 and a fourth capacitive sensor 2312. Functions of the third capacitive sensor 2311 and the fourth capacitive sensor 2312 on the second earbud body are similar to those of the first capacitive sensor 2303 and the second capacitive sensor 2304 on the first earbud. Details are not described herein in the present disclosure.

For another example, the second earbud body includes a temperature sensor 2313, and a function of the temperature sensor 2313 on the second earbud body is similar to that of the temperature sensor 2305 on the first earbud. Details are not described herein again in the present disclosure.

For another example, the second earbud body includes a touch controller 2314, and a function of the touch controller 2314 on the second earbud body is similar to that of the touch controller 2306 on the first earbud. Details are not described herein again in the present disclosure.

For another example, the second earbud body includes a third microphone 2315 and a fourth microphone 2316, and functions of the third microphone 2315 and the fourth microphone 2316 on the second earbud body are similar to those of the first microphone 2307 and the second microphone 2308 on the first earbud. Details are not described herein again in the present disclosure.

In a possible implementation, the wearable device includes a second earbud, and the second earbud includes a second inertial detector 2309 and a second processor 2310; the second inertial detector 2309 is configured to collect second gravity data; the second processor 2310 is configured to obtain the second gravity data collected by the second inertial detector; and the second processor 2310 is further configured to: when the second gravity data meets the first condition, identify that the second earbud is worn on a left ear, and execute a control event corresponding to a left earbud attribute; or when the second gravity data meets the second condition, identify that the second earbud is worn on a right ear, and execute a control event corresponding to a right earbud attribute.

In a possible implementation, the second earbud includes a first earbud body, a cantilever arm, and a second earbud body, the cantilever arm is connected between the first earbud body and the second earbud body, and the first earbud body and the second earbud body are disposed opposite to each other and have an initial distance; the cantilever arm is deformable, deformation of the cantilever arm can adjust the initial distance between the first earbud body and the second earbud body to an adjustment distance, a connection line between a geometric center of the second earbud body and a geometric center of the first earbud body is defined as a Z axis, and a direction in which the geometric center of the second earbud body points to the geometric center of the first earbud body is defined as a positive direction of the Z axis; a straight line that passes through a geometric center of an end face on which the cantilever arm is connected to the second earbud body and that is perpendicular to the end face is defined as a Y axis, and a direction in which the geometric center of the end face points to the cantilever arm is defined as a positive direction of the Y axis; and a straight line perpendicular to both the Z axis and the Y axis is defined as an X axis, where when the first earbud is worn on the left ear, a positive direction of the X axis points to the ground; and when a user is standing or sitting, the first condition includes: a gravity component of the gravity data in the positive direction of the X axis is a positive value; or when a user is standing or sitting, the second condition includes: a gravity component of the gravity data in the positive direction of the X axis is a negative value.

In a possible implementation, when the user is left-side lying, the first condition includes: a gravity component of the gravity data in the positive direction of the Y axis is a positive value; or when the user is left-side lying, the second condition includes: a gravity component of the gravity data in the positive direction of the Y axis is a negative value.

In a possible implementation, when the user is right-side lying, the first condition includes: a gravity component of the gravity data in the positive direction of the Y axis is a negative value; or when the user is right-side lying, the second condition includes: a gravity component of the gravity data in the positive direction of the Y axis is a positive value.

In a possible implementation, the first earbud body includes a first capacitive sensor 2303, and the second earbud body includes a second capacitive sensor 2304; and the first processor 2302 is further configured to: obtain a first capacitance value collected by the first capacitive sensor 2303 and a second capacitance value collected by the second capacitive sensor 2304; and when the first capacitance value is greater than a first threshold and the second capacitance value is greater than a second threshold, the first earbud determines that the first earbud is in a worn state.

With reference to the second aspect, in a possible implementation, the first processor 2302 is configured to: when determining that the first earbud is in the worn state, obtain the first gravity data collected by the first inertial detector 2301.

In a possible implementation, the first earbud further includes a temperature sensor 2305, and the temperature sensor 2305 is configured to collect a first ambient temperature; the first processor 2302 is configured to: obtain a first capacitance error value based on the first ambient temperature; obtain a first target capacitance value based on the first capacitance value and the first capacitance error value, and obtain a second target capacitance value based on the second capacitance value and the first capacitance error value; and when the first target capacitance value is greater than the first threshold and the second target capacitance value is greater than the second threshold, determine that the first earbud is in the worn state.

In a possible implementation, the first processor 2302 is configured to: when identifying that the first earbud is worn on a left ear of a first user, execute a control event corresponding to a left earbud attribute; and the second processor is configured to: when identifying that the second earbud is worn on a right ear of the first user, execute a control event corresponding to a right earbud attribute.

In a possible implementation, the first processor 2302 is configured to: when identifying that the first earbud is worn on a left ear of a first user, execute a control event corresponding to a left earbud attribute; and the second processor is configured to: when identifying that the second earbud is worn on a right ear of a second user, execute a control event corresponding to a right earbud attribute.

In a possible implementation, the first processor 2302 is configured to: when identifying that the first earbud is worn on a left ear of a first user, execute a control event corresponding to a left earbud attribute; and the second processor is configured to: when identifying that the second earbud is worn on a left ear of a second user, execute a control event corresponding to a left earbud attribute.

In a possible implementation, the first processor 2302 is configured to: when identifying that the first earbud is worn on a right ear of a first user, execute a control event corresponding to a right earbud attribute; and the second processor is configured to: when identifying that the second earbud is worn on a right ear of a second user, execute a control event corresponding to a right earbud attribute.

In a possible implementation, the first earbud includes a first microphone 2307 and a second microphone 2308, and the first microphone 2307 and the second microphone 2308 are disposed opposite to each other in the first earbud; and the first processor 2302 is configured to: when the first gravity data meets the first condition, identify that the first earbud is worn on the left ear, where the first microphone 2307 is located above the second microphone 2308, enable the first microphone 2307, and pick up an audio via the first microphone 2307; or the first processor 2302 is configured to: when the first gravity data meets the second condition, identify that the first earbud is worn on the right ear, where the first microphone 2307 is located below the second microphone 2308, enable the second microphone 2308, and pick up an audio via the second microphone 2308.

In a possible implementation, the first processor 2302 is configured to: when the first gravity data meets the first condition, identify that the first earbud is worn on the left ear, and play a left channel audio; or the first processor 2302 is configured to: when the first gravity data meets the second condition, identify that the first earbud is worn on the right ear, and play a right channel audio.

In a possible implementation, the first earbud further includes a touch controller 2306, and the touch controller 2306 is configured to: when the first gravity data meets the first condition, identify that the first earbud is worn on the left ear, detect and respond to a first operation performed on a first area, and send a first message to the first processor 2302; and the first processor 2302 is further configured to perform first control in response to the first message, where the first area includes an area on the ear on which the first earbud is worn or an area on the first earbud; or the touch-control unit is configured to: when the first gravity data meets the second condition, identify that the first earbud is worn on the right ear, detect and respond to a first operation performed on a second area, and send a second message to the first processor 2302; and the first processor 2302 is further configured to perform second control in response to the second message, where the second area includes an area on the ear on which the first earbud is worn or an area on the first earbud, where the first control is the same as or different from the second control, and the first control or the second control includes any one of the following: pausing audio playing, continuing audio playing, switching audio playing, adjusting volume, answering a call, and ending a call.

FIG. 24 is an apparatus diagram of a first earbud according to the present disclosure.

As shown in FIG. 24, the present disclosure provides an earphone, being a first earbud, where the first earbud includes a first inertial detection unit 2401 and a first processing unit 2402; the first inertial detection unit 2401 is configured to collect first gravity data; the first processing unit 2402 is configured to obtain the first gravity data collected by the first inertial detection unit; and the first processing unit 2402 is further configured to: when the first gravity data meets a first condition, identify that the first earbud is worn on a left ear, and execute a control event corresponding to a left earbud attribute; or when the first gravity data meets a second condition, identify that the first earbud is worn on a right ear, and execute a control event corresponding to a right earbud attribute. The references to units of FIG. 24 and elsewhere should be understood to include both processor based implementations and circuit based implementations as would be known by a person of average skill in the art.

In a possible implementation, the first earbud further includes a first capacitive collection unit 2403 and a second capacitive collection unit 2404; and the first processing unit 2402 is further configured to: obtain a first capacitance value collected by the first capacitive collection unit 2403 and a second capacitance value collected by the second capacitive collection unit 2404; and when the first capacitance value is greater than a first threshold and the second capacitance value is greater than a second threshold, the first earbud determines that the first earbud is in a worn state.

In a possible implementation, the first processing unit 2402 is configured to: when determining that the first earbud is in the worn state, obtain the first gravity data collected by the first inertial detection unit 2401.

In a possible implementation, the first earbud further includes a temperature collection unit 2405, and the temperature collection unit 2405 is configured to collect a first ambient temperature; the first processing unit 2402 is configured to: obtain a first capacitance error value based on the first ambient temperature; obtain a first target capacitance value based on the first capacitance value and the first capacitance error value, and obtain a second target capacitance value based on the second capacitance value and the first capacitance error value; and when the first target capacitance value is greater than the first threshold and the second target capacitance value is greater than the second threshold, determine that the first earbud is in the worn state.

In a possible implementation, the first earbud further includes a first audio collection unit 2407 and a second audio collection unit 2408, and the first audio collection unit 2407 and the first audio collection unit 2407 are disposed opposite to each other; and the first processing unit 2402 is configured to: when the first gravity data meets the first condition, identify that the first earbud is worn on the left ear, where the first audio collection unit 2407 is located above the second audio collection unit 2408, enable the first audio collection unit 2407, and pick up an audio via the first audio collection unit 2407; or the first processing unit 2402 is configured to: when the first gravity data meets the second condition, identify that the first earbud is worn on the right ear, where the first audio collection unit 2407 is located below the second audio collection unit 2408, enable the second audio collection unit 2408, and pick up an audio via the second audio collection unit 2408.

In a possible implementation, the first processing unit 2402 is configured to: when the first gravity data meets the first condition, identify that the first earbud is worn on the left ear, and play a left channel audio; or the first processing unit 2402 is configured to: when the first gravity data meets the second condition, identify that the first earbud is worn on the right ear, and play a right channel audio.

In a possible implementation, the first earbud further includes a touch-control unit 2406, and the touch-control unit 2406 is configured to: when the first gravity data meets the first condition, identify that the first earbud is worn on the left ear, detect and respond to a first operation performed on a first area, and send a first message to the first processing unit 2402; and the first processing unit 2402 is further configured to perform first control in response to the first message, where the first area includes an area on the ear on which the first earbud is worn or an area on the first earbud; or the touch-control unit 2406 is configured to: when the first gravity data meets the second condition, identify that the first earbud is worn on the right ear, detect and respond to a first operation performed on a second area, and send a second message to the first processing unit 2402; and the first processing unit 2402 is further configured to perform second control in response to the second message, where the second area includes an area on the ear on which the first earbud is worn or an area on the first earbud, where the first control is the same as or different from the second control, and the first control or the second control includes any one of the following: pausing audio playing, continuing audio playing, switching audio playing, adjusting volume, answering a call, and ending a call.

The foregoing descriptions are merely some embodiments and implementations of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

It may be understood that each user interface described in embodiments of the present disclosure is merely an example interface, and constitutes no limitation on the solutions of the present disclosure. In another embodiment, the user interface may use different interface layouts, may include more or fewer controls, and may add or reduce other function options, and provided that the user interface is based on a same inventive idea provided in the present disclosure, all fall within the protection scope of the present disclosure.

It should be noted that, if no contradiction or conflict occurs, any feature or any part of any feature in any embodiment of the present disclosure may be combined, and a combined technical solution also falls within the scope of embodiments of the present disclosure.

In conclusion, the foregoing embodiments are merely intended to describe the technical solutions of the present disclosure, but not to limit the present disclosure. Although the present disclosure is described in detail with reference to the foregoing embodiments, a person of ordinary skill in the art should understand that the technical solutions described in the foregoing embodiments may still be modified, or some technical features in the technical solutions may be equivalently replaced. These modifications or replacements do not make the essence of the corresponding technical solutions fall outside the scope of the technical solutions of the embodiments of the present disclosure.

1. A wearable device, wherein the wearable device comprises a first earbud, and the first earbud comprises a first inertial detector and a first processor;
the first inertial detector is configured to collect first gravity data;
the first processor is configured to obtain the first gravity data collected by the first inertial detector; and
the first processor is further configured to execute computer instructions that cause the device to:
when the first gravity data meets a first condition, identify that the first earbud is worn on a left ear, and execute a control event corresponding to a left earbud attribute; or
when the first gravity data meets a second condition, identify that the first earbud is worn on a right ear, and execute a control event corresponding to a right earbud attribute.

2. The wearable device according to claim 1, wherein the wearable device comprises a second earbud, and the second earbud comprises a second inertial detector and a second processor;
the second inertial detector is configured to collect second gravity data;
the second processor is configured to obtain the second gravity data collected by the second inertial detector; and
the second processor is further configured to:
when the second gravity data meets the first condition, identify that the second earbud is worn on a left ear, and execute a control event corresponding to a left earbud attribute; or
when the second gravity data meets the second condition, identify that the second earbud is worn on a right ear, and execute a control event corresponding to a right earbud attribute.

3. The wearable device according to claim 1, wherein the second earbud comprises a first earbud body, a cantilever arm, and a second earbud body, the cantilever arm is connected between the first earbud body and the second earbud body, and the first earbud body and the second earbud body are disposed opposite to each other and have an initial distance; the cantilever arm is deformable, deformation of the cantilever arm is capable of adjusting the initial distance between the first earbud body and the second earbud body to an adjustment distance, a connection line between a geometric center of the second earbud body and a geometric center of the first earbud body is defined as a Z axis, and a direction in which the geometric center of the second earbud body points to the geometric center of the first earbud body is defined as a positive direction of the Z axis; a straight line that passes through a geometric center of an end face on which the cantilever arm is connected to the second earbud body and that is perpendicular to the end face is defined as a Y axis, and a direction in which the geometric center of the end face points to the cantilever arm is defined as a positive direction of the Y axis; and a straight line perpendicular to both the Z axis and the Y axis is defined as an X axis, wherein when the first earbud is worn on the left ear, a positive direction of the X axis points to the ground; and
when a user is standing or sitting, the first condition comprises: a gravity component of the gravity data in the positive direction of the X axis is a positive value; or
when a user is standing or sitting, the second condition comprises: a gravity component of the gravity data in the positive direction of the X axis is a negative value.

4. The wearable device according to claim 3, wherein when the user is left-side lying, the first condition comprises: a gravity component of the gravity data in the positive direction of the Y axis is a positive value; or
when the user is left-side lying, the second condition comprises: a gravity component of the gravity data in the positive direction of the Y axis is a negative value.

5. The wearable device according to claim 3, wherein when the user is right-side lying, the first condition comprises: a gravity component of the gravity data in the positive direction of the Y axis is a negative value; or
when the user is right-side lying, the second condition comprises: a gravity component of the gravity data in the positive direction of the Y axis is a positive value.

6. The wearable device according to claim 3, wherein the first earbud body comprises a first capacitive sensor, and the second earbud body comprises a second capacitive sensor; and
the first processor is further configured to execute instructions to:
obtain a first capacitance value collected by the first capacitive sensor and a second capacitance value collected by the second capacitive sensor; and
when the first capacitance value is greater than a first threshold and the second capacitance value is greater than a second threshold, determine, by the first earbud, that the first earbud is in a worn state.

7. The wearable device according to claim 6, wherein the first processor is configured to execute instructions to: when determining that the first earbud is in the worn state, obtain the first gravity data collected by the first inertial detector.

8. The wearable device according to claim 6, wherein the first earbud further comprises a temperature sensor, and the temperature sensor is configured to collect a first ambient temperature; and
the first processor is configured to execute instructions to:
obtain a first capacitance error value based on the first ambient temperature;
obtain a first target capacitance value based on the first capacitance value and the first capacitance error value, and obtain a second target capacitance value based on the second capacitance value and the first capacitance error value; and
when the first target capacitance value is greater than the first threshold and the second target capacitance value is greater than the second threshold, determine that the first earbud is in the worn state.

9. The wearable device according to claim 2, wherein the first processor is configured to execute instructions to: when identifying that the first earbud is worn on a left ear of a first user, execute a control event corresponding to a left earbud attribute; and
the second processor is configured to: when identifying that the second earbud is worn on a right ear of the first user, execute a control event corresponding to a right earbud attribute.

10. The wearable device according to claim 2, wherein the first processor is configured to execute instructions to: when identifying that the first earbud is worn on a left ear of a first user, execute a control event corresponding to a left earbud attribute; and
the second processor is configured to execute instructions to: when identifying that the second earbud is worn on a right ear of a second user, execute a control event corresponding to a right earbud attribute.

11. The wearable device according to claim 2, wherein the first processor is configured to execute instructions to: when identifying that the first earbud is worn on a left ear of a first user, execute a control event corresponding to a left earbud attribute; and
the second processor is configured to execute instructions to: when identifying that the second earbud is worn on a left ear of a second user, execute a control event corresponding to a left earbud attribute.

12. The wearable device according to claim 2, wherein the first processor is configured to execute instructions to: when identifying that the first earbud is worn on a right ear of a first user, execute a control event corresponding to a right earbud attribute; and
the second processor is configured to execute instructions to: when identifying that the second earbud is worn on a right ear of a second user, execute a control event corresponding to a right earbud attribute.

13. The wearable device according to claim 1, wherein the first earbud comprises a first microphone and a second microphone, and the first microphone and the second microphone are disposed opposite to each other in the first earbud; and
the first processor is configured to execute instructions to: when the first gravity data meets the first condition, identify that the first earbud is worn on the left ear, wherein the first microphone is located above the second microphone, enable the first microphone, and pick up an audio via the first microphone; or
the first processor is configured to execute instructions to: when the first gravity data meets the second condition, identify that the first earbud is worn on the right ear, wherein the first microphone is located below the second microphone, enable the second microphone, and pick up an audio via the second microphone.

14. The wearable device according to claim 1, wherein the first processor is configured to execute instructions to: when the first gravity data meets the first condition, identify that the first earbud is worn on the left ear, and play a left channel audio; or
the first processor is configured to execute instructions to: when the first gravity data meets the second condition, identify that the first earbud is worn on the right ear, and play a right channel audio.

15. The wearable device according to claim 1, wherein the first earbud further comprises a touch controller, and the touch controller is configured to: when the first gravity data meets the first condition, identify that the first earbud is worn on the left ear, detect and respond to a first operation performed on a first area, and send a first message to the first processor; and
the first processor is further configured to execute instructions to perform first control in response to the first message, wherein the first area comprises an area on the ear on which the first earbud is worn or an area on the first earbud; or
the touch-control unit is configured to: when the first gravity data meets the second condition, identify that the first earbud is worn on the right ear, detect and respond to the first operation performed on a second area, and send a second message to the first processor; and
the first processor is further configured to execute instructions to perform second control in response to the second message, wherein the second area comprises an area on the ear on which the first earbud is worn or an area on the first earbud, wherein
the first control is the same as or different from the second control, and the first control or the second control comprises any one of the following: pausing audio playing, continuing audio playing, switching audio playing, adjusting volume, answering a call, and ending a call.

16. The wearable device according to claim 4, wherein the first earbud body comprises a first capacitive sensor, and the second earbud body comprises a second capacitive sensor; and
the first processor is further configured to:
obtain a first capacitance value collected by the first capacitive sensor and a second capacitance value collected by the second capacitive sensor; and
when the first capacitance value is greater than a first threshold and the second capacitance value is greater than a second threshold, determine, by the first earbud, that the first earbud is in a worn state.

17. The wearable device according to claim 5, wherein the first earbud body comprises a first capacitive sensor, and the second earbud body comprises a second capacitive sensor; and
the first processor is further configured to:
obtain a first capacitance value collected by the first capacitive sensor and a second capacitance value collected by the second capacitive sensor; and
when the first capacitance value is greater than a first threshold and the second capacitance value is greater than a second threshold, determine, by the first earbud, that the first earbud is in a worn state.

18. The wearable device according to claim 7, wherein the first earbud further comprises a temperature sensor, and the temperature sensor is configured to collect a first ambient temperature; and
the first processor is configured to execute instructions to:
obtain a first capacitance error value based on the first ambient temperature;
obtain a first target capacitance value based on the first capacitance value and the first capacitance error value, and obtain a second target capacitance value based on the second capacitance value and the first capacitance error value; and
when the first target capacitance value is greater than the first threshold and the second target capacitance value is greater than the second threshold, determine that the first earbud is in the worn state.

19. The wearable device according to claim 2, wherein the first earbud comprises a first microphone and a second microphone, and the first microphone and the second microphone are disposed opposite to each other in the first earbud; and
the first processor is configured to execute instructions to: when the first gravity data meets the first condition, identify that the first earbud is worn on the left ear, wherein the first microphone is located above the second microphone, enable the first microphone, and pick up an audio via the first microphone; or
the first processor is configured to execute instructions to: when the first gravity data meets the second condition, identify that the first earbud is worn on the right ear, wherein the first microphone is located below the second microphone, enable the second microphone, and pick up an audio via the second microphone.

20. The wearable device according to claim 3, wherein the first earbud comprises a first microphone and a second microphone, and the first microphone and the second microphone are disposed opposite to each other in the first earbud; and
the first processor is configured to execute instructions to: when the first gravity data meets the first condition, identify that the first earbud is worn on the left ear, wherein the first microphone is located above the second microphone, enable the first microphone, and pick up an audio via the first microphone; or
the first processor is configured to execute instructions to: when the first gravity data meets the second condition, identify that the first earbud is worn on the right ear, wherein the first microphone is located below the second microphone, enable the second microphone, and pick up an audio via the second microphone.
